(19) United States
(12) Patent Application Publication
(10) Pub. No.: US 2023/0025123 A1
(43) Pub. Date: Jan. 26, 2023

(54) HEATING DEVICE AND OPERATING METHOD OF THE HEATING DEVICE

(71) Applicant: SAMSUNG ELECTRONICS CO., LTD., Suwon-si (KR)

(72) Inventors: Hyunjoon CHOO, Suwon-si (KR); Dongoh KANG, Suwon-si (KR); Heejun KANG, Suwon-si (KR); Kwangyoun KIM, Suwon-si (KR)

(73) Assignee: SAMSUNG ELECTRONICS CO., LTD., Suwon-si (KR)

(21) Appl. No.: 17/868,327

(22) Filed: Jul. 19, 2022

Related U.S. Application Data
(63) Continuation of application No. PCT/KR2022/010287, filed on Jul. 14, 2022.

(30) Foreign Application Priority Data
Jul. 20, 2021 (KR) 10-2021-0095153

(51) Int. Cl. H05B 6/06; H05B 6/12

(52) U.S. Cl. CPC H05B 6/065; H05B 6/1254; H05B 2213/07; H05B 2213/05

(57) ABSTRACT

A heating device and an operating method of the heating device. The heating device includes: a communication interface configured to obtain identification information of a cooking device located on a top plate; a wireless power transmitter including a working coil arranged to form a magnetic field; and at least one processor, wherein the at least one processor is configured to identify a temperature control mode of the cooking device corresponding to the identification information of the cooking device, when a rotation input of rotating the cooking device is detected, obtain a target heating temperature corresponding to the cooking device based on a rotation displacement according to the rotation input and the temperature control mode of the cooking device, and control power transmission by the wireless power transmitter such that a temperature of a content of the cooking device reaches the target heating temperature.

### CROSS-REFERENCE TO RELATED APPLICATION

This application is a continuation application, under 35 USC § 111(a), of International Application No. PCT/KR2022/010287, filed on Jul. 14, 2022, which claims priority to Korean Patent Application No. 10-2021-0095153 filed on Jul. 20, 2021, the disclosures of which are incorporated herein by reference in their entireties.

### 1. FIELD

Embodiments of the disclosure relate to a heating device for controlling wireless power transmission to a cooking device and an operating method of the heating device.

### 2. DESCRIPTION OF RELATED ART

An electric kettle is a kettle for boiling water by electricity and is also referred to as an electric pot. In general, a plate with a cord connected thereto is located under an electric kettle, and the electric kettle operates when a button thereof is pressed with the electric kettle put on the plate. Generally, the electric kettle is turned off when water therein is boiled. Recently, a warming pot for keeping water warm at a desired temperature for a long time is also launched. The electric kettle may also include a function of brewing tea.

However, in the case of a currently-launched general electric kettle, a user is inconvenienced by having to connect a cord to a power outlet to use the electric kettle and by having to operate a control switch to set a desired water temperature. Thus, there is a demand for a system that allows a user to further easily use an electric kettle.

### SUMMARY

According to an embodiment of the disclosure, a heating device includes: a top plate on which a cooking device is to be placed; a communication interface configured to obtain identification information of the cooking device, while the cooking device is placed on the top plate; a wireless power transmitter including a working coil arranged to form a magnetic field to heat the cooking device while the cooking device is placed on the top plate of the heating device; and at least one processor. The at least one processor may be configured to identify a temperature control mode of the cooking device based on the identification information of the cooking device. The at least one processor may be configured to, when detecting rotation of the cooking device, obtain a target heating temperature based on a rotation displacement of the cooking device on the top plate of the heating device and the temperature control mode of the cooking device. The at least one processor may be configured to control power transmission by the wireless power transmitter such that a content of the cooking device reaches the target heating temperature.

According to another embodiment of the disclosure, an operating method of a heating device including a wireless power transmitter including a working coil arranged to form a magnetic field and a top plate on which a cooking device is to be placed includes: obtaining identification information of the cooking device while the cooking device is placed on the top plate of the heating device; identifying a temperature control mode of the cooking device based on the identification information of the cooking device; when detecting a rotation of the cooking device, obtaining a target heating temperature based on a rotation displacement of the cooking device on the top plate of the heating device and the temperature control mode of the cooking device; and controlling power transmission by the wireless power transmitter such that a content of the cooking device reaches the target heating temperature.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram for describing a cooking system according to an embodiment of the disclosure.

FIG. 2 is a diagram for describing an induction heating (IH) type cooking device according to an embodiment of the disclosure.

FIG. 3 is a diagram for describing a heater type cooking device according to an embodiment of the disclosure.

FIG. 4 is a block diagram for describing a function of a heating device according to an embodiment of the disclosure.

FIG. 5 is a block diagram for describing a function of a heating device according to an embodiment of the disclosure.

FIG. 6 is a flowchart for describing an operating method of a heating device according to an embodiment of the disclosure.

FIG. 7 is a flowchart for describing a method of detecting a cooking device by using a current sensor, according to an embodiment of the disclosure.

FIG. 8 is a flowchart for describing a method of detecting a cooking device by using Near Field Communication (NFC), according to an embodiment of the disclosure.

FIG. 9 is a diagram for describing a temperature control mode according to an embodiment of the disclosure.

FIG. 10 is a diagram for describing an operation of obtaining a rotation displacement according to a rotation input by using a rotation detecting sensor, according to an embodiment of the disclosure.

FIG. 11 is a flowchart for describing a method of determining a rotation displacement according to a rotation input based on an impedance variation of a working coil, according to an embodiment of the disclosure.

FIG. 12 is a flowchart for describing a method of determining a rotation displacement according to a rotation input based on an impedance variation of a receiving coil, according to an embodiment of the disclosure.

FIG. 13 is a diagram for describing an operation of changing a target heating temperature based on a rotation input in a counterclockwise direction, according to an embodiment of the disclosure.

FIG. 14 is a diagram for describing an operation of changing a target heating temperature based on a rotation input in a clockwise direction, according to an embodiment of the disclosure.

FIG. 15 is a diagram for describing an operation of determining a target heating temperature among a plurality of preset temperatures, according to an embodiment of the disclosure.

FIG. 16 is a diagram for describing an operation of determining a target heating temperature based on a speed of a rotation input, according to an embodiment of the disclosure.

FIG. 17 is a diagram for describing an operation of displaying a target heating temperature and identification information of a cooking device, according to an embodiment of the disclosure.

FIG. 18 is a diagram for describing an operation of displaying temperature change situation information of a cooking device, according to an embodiment of the disclosure.

FIG. 19 is a diagram for describing an operation of displaying a target heating temperature by using a light emitting diode (LED) lamp, according to an embodiment of the disclosure.

FIG. 20 is a diagram for describing an operation of displaying a target heating temperature through an output interface of a cooking device, according to an embodiment of the disclosure.

FIG. 21 is a flowchart for describing a method of controlling power transmission by a wireless power transmitter, according to an embodiment of the disclosure.

FIG. 22 is a flowchart for describing a method of adjusting a power level of a wireless power transmitter, according to an embodiment of the disclosure.

FIG. 23 is a flowchart for describing a method of controlling power transmission by a wireless power transmitter in a low-noise mode, according to an embodiment of the disclosure.

FIG. 24 is a flowchart for describing a method in which a cooking device controls power transmission by a heating device, according to an embodiment of the disclosure.

FIG. 25 is a diagram for describing an operation in which a heating device interworks with a server device, according to an embodiment of the disclosure.

FIG. 26A is diagram illustrating a GUI for selecting a cooking device, according to an embodiment of the disclosure.

FIG. 26B is diagram illustrating a setting screen related to a temperature control mode of a cooking device, according to an embodiment of the disclosure.

FIG. 26C is diagram for describing an operation in which a server device provides information about a cooking device through a display device, according to an embodiment of the disclosure.

FIG. 27 is a flowchart for describing a method in which a heating device obtains information about a temperature control mode of a cooking device from a server device, according to an embodiment of the disclosure.

FIG. 28 is a diagram for describing a method in which a server device controls power transmission by a heating device, according to an embodiment of the disclosure.

FIG. 29 is a flowchart for describing a method in which a heating device controls power transmission when a warming function is set in a cooking device, according to an embodiment of the disclosure.

FIG. 30 is a flowchart for describing a method in which a cooking device requests power transmission from a heating device to provide a warming function, according to an embodiment of the disclosure.

FIG. 31 is a diagram for describing an operation of providing a notification related to a warming function when a cooking device is detached from a heating device, according to an embodiment of the disclosure.

FIG. 32 is a diagram for describing an operation in which a heating device interworks with a home appliance, according to an embodiment of the disclosure.

FIG. 33 is a diagram for describing an operation of detecting a rotation input to a cooking device by using at least one camera arranged in a kitchen, according to an embodiment of the disclosure.

### DETAILED DESCRIPTION

Throughout the disclosure, the expression “at least one of a, b or c” indicates only a, only b, only c, both a and b, both a and c, both b and c, all of a, b, and c, or variations thereof.

Terms used herein will be briefly described and then embodiments of the disclosure will be described in detail.

The terms used herein are those general terms currently widely used in the art in consideration of functions in embodiments of the disclosure, but the terms may vary according to the intentions of those of ordinary skill in the art, precedents, or new technology in the art. Also, in some cases, there may be terms that are optionally selected by the applicant, and the meanings thereof will be described in detail in the corresponding portions of embodiments of the disclosure. Thus, the terms used herein should be understood not as simple names but based on the meanings of the terms and the overall description of the disclosure.

Throughout the disclosure, when something is referred to as “including” an element, one or more other elements may be further included unless specified otherwise. Also, as used herein, the terms such as “units” and “modules” may refer to units that perform at least one function or operation, and the units may be implemented as hardware or software or a combination of hardware and software.

Hereinafter, embodiments of the disclosure will be described in detail with reference to the accompanying drawings so that those of ordinary skill in the art may easily implement the embodiments of the disclosure. However, embodiments of the disclosure may be embodied in many different forms and should not be construed as being limited to the embodiments set forth herein. Also, portions irrelevant to the description of the disclosure will be omitted in the drawings for a clear description of embodiments of the disclosure, and like reference numerals will denote like elements throughout the disclosure.

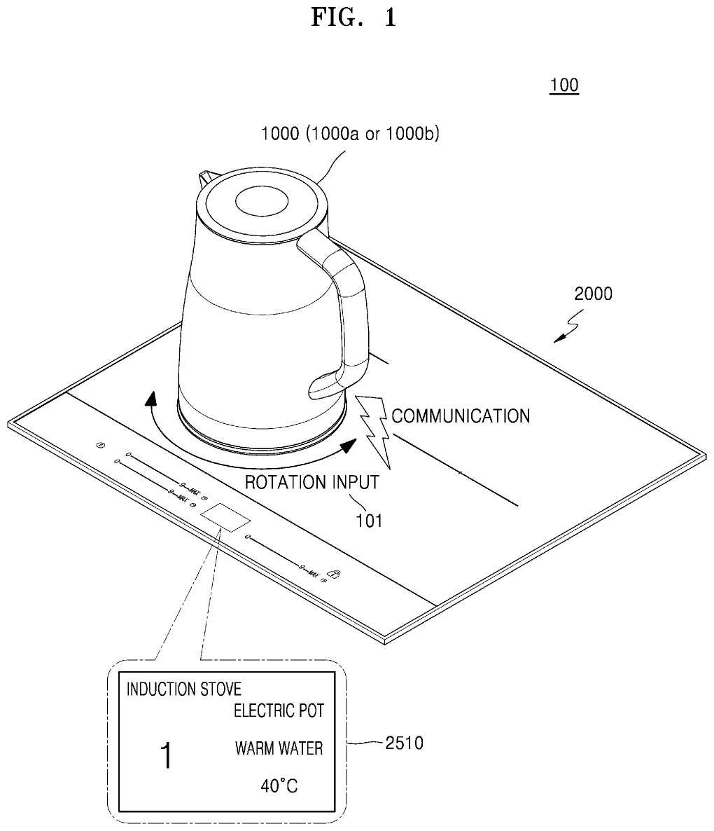

According to an embodiment of the disclosure, provided are a heating device for controlling power transmission to a cooking device such that the temperature of the content of the cooking device may reach a target heating temperature determined based on a rotation input to the cooking device, and an operating method of the heating device. FIG. 1 is a diagram for describing a cooking system according to an embodiment of the disclosure.

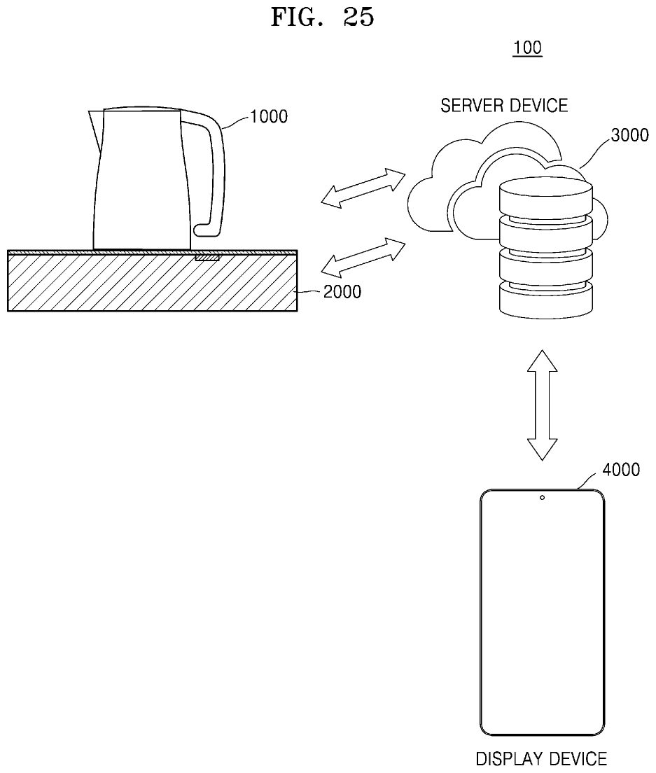

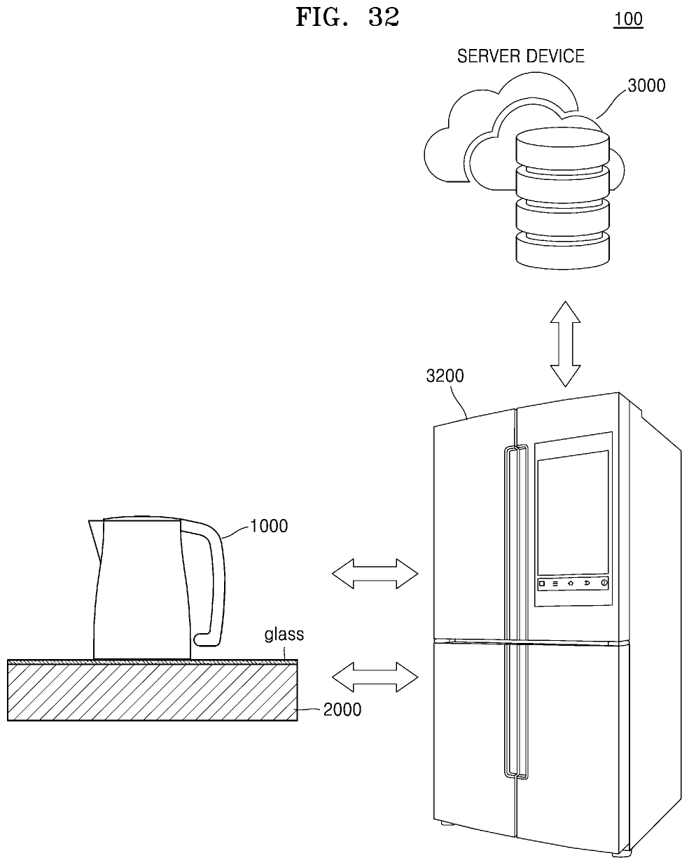

Referring to FIG. 1, a cooking system 100 according to an embodiment of the disclosure may include a cooking device 1000 and a heating device 2000. However, not all of the illustrated elements are essential elements. The cooking system 100 may include more or fewer elements than the illustrated elements. For example, the cooking system 100 may include the cooking device 1000, the heating device 2000, and a server device (not illustrated). Also, the cooking system 100 may include the cooking device 1000, the heating device 2000, a home appliance (not illustrated), and the server device. An embodiment in which the cooking system 100 includes the server device will be described below in detail with reference to FIG. 25. An embodiment in which the cooking system 100 further includes the home appliance will be described below in detail with reference to FIG. 32. Each component of the cooking system 100 will be described.

The cooking device 1000 may be a device for heating the content of the cooking device 1000. For example, the cooking device 1000 may include a kettle, a teapot, a coffee pot, a rice cooker, a pot, a frying pan, or a steamer; however, the disclosure is not limited thereto. The cooking device 1000 may include a cooker device. The cooker device may be a device where a general induction heating (IH) container may be inserted or detached. According to an embodiment of the disclosure, the cooker device may be a device capable of automatically cooking the content thereof according to a recipe. The cooker device may be referred to as a pot, a rice cooker, or a steamer depending on its use. For example, when an inner pot capable of cooking rice is inserted into the cooker device, the cooker device may be referred to as a rice cooker. The cooking device 1000 may be inductively heated by the heating device 2000 and may be various types of containers that have magnetism and may communicate with the heating device 2000. The content of the cooking device 1000 may be liquid such as water, tea, coffee, soup, juice, or wine or may be solid such as butter; however, the disclosure is not limited thereto. Hereinafter, for convenience of description, a case where the cooking device 1000 is a kettle will be described as a main example.

According to an embodiment of the disclosure, the cooking device 1000 may wirelessly receive power from the heating device 2000 by using electromagnetic induction. Thus, the cooking device 1000 according to an embodiment of the disclosure may not include a power line connected to a power outlet.

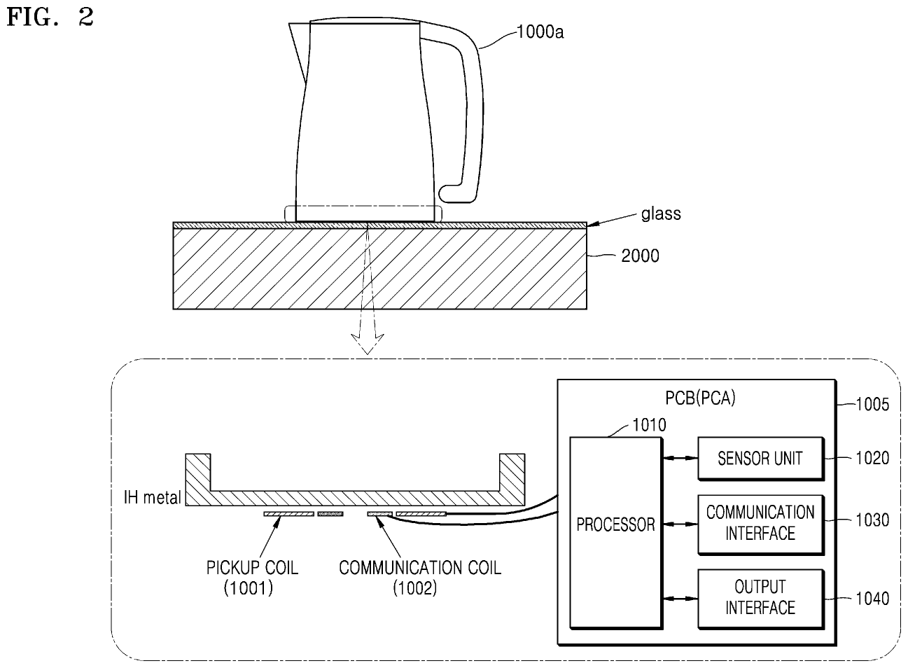

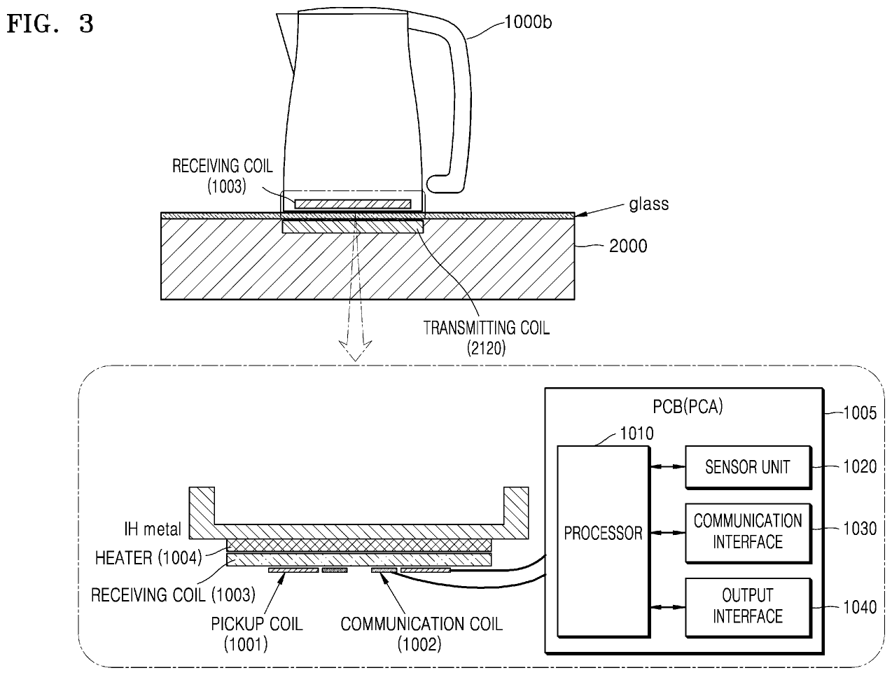

According to an embodiment of the disclosure, the cooking device 1000 may be an induction heating (IH) type cooking device 1000a (see FIG. 2) or a heater type cooking device 1000b (see FIG. 3). Induction heating (IH) may be a method of heating a metal object by using electromagnetic induction. For example, when an AC current is supplied to a working coil of the heating device 2000, a temporally-changing magnetic field may be induced inside the working coil. The magnetic field generated by the working coil may pass through the bottom surface of the cooking device 1000. When a temporally-changing magnetic field passes through a metal (e.g., iron, steel nickel, or various types of alloys) included in the bottom surface of the cooking device 1000, a current rotating around a magnetic field may be generated in the metal. The rotating current may be referred to as an eddy current, and a phenomenon in which a current is induced by a temporally-changing magnetic field may be referred to as an electromagnetic induction phenomenon. When the cooking device 1000 is the induction heating (IH) type cooking device 1000a, heat may be generated at the bottom surface of the cooking device 1000a due to the eddy current and the resistance of the metal (e.g., iron). In this case, the content of the cooking device 1000 may be heated by the generated heat.

When the cooking device 1000 is the heater type cooking device 1000b, the cooking device 1000b may include a heater and a receiving coil for driving the heater. The receiving coil of the cooking device 1000b may wirelessly receive power from the working coil (hereinafter also referred to as a transmitting coil) of the heating device 2000 through a magnetic induction method. The magnetic induction method may be a method of transmitting energy by applying a magnetic field formed by a current flowing through the transmitting coil, to the receiving coil. The type of the cooking device 1000 will be described below in more detail with reference to FIGS. 2 and 3.

The cooking device 1000 according to an embodiment of the disclosure may include a communication interface for communicating with an external device. For example, the cooking device 1000 may communicate with the heating device 2000 or the server device through the communication interface. The communication interface may include a short-range wireless communication interface, a mobile communication interface, and/or the like. The short-range wireless communication interface may include, but is not limited to, a Bluetooth communication interface, a Bluetooth Low Energy (BLE) communication interface, a Near Field Communication (NFC) interface, a WLAN (WiFi) communication interface, a ZigBee communication interface, an Infrared Data Association (IrDA) communication interface, a WiFi Direct (WFD) communication interface, an Ultra-Wideband (UWB) communication interface, and/or an Ant+ communication interface.

The cooking device 1000 according to an embodiment of the disclosure may transmit identification information of the cooking device 1000 to the heating device 2000 through the communication interface. The identification information of the cooking device 1000 may be unique information for identifying the cooking device 1000 and may include, but is not limited to, at least one of a MAC address, a model name, device type information (e.g., IH type ID or heater type ID), manufacturer information (e.g., Manufacture ID), or a serial number. According to an embodiment of the disclosure, the identification information of the cooking device 1000 may be represented by a series of identification numbers or by a combination of numbers and alphabets.

The cooking device 1000 according to an embodiment of the disclosure may monitor the temperature of the content and transmit temperature information of the content to the heating device 2000 through the communication interface. According to an embodiment of the disclosure, the cooking device 1000 may transmit the temperature information of the content to the heating device 2000 at certain periods or may transmit the temperature information of the content to the heating device 2000 when a particular event occurs (e.g., when a request is received from the heating device 2000).

The heating device 2000 according to an embodiment of the disclosure may be a device that wirelessly transmits power to a heating target object (e.g., the cooking device 1000) located on a top plate thereof, by using electromagnetic induction. The heating device 2000 may be referred to as a wireless power transmission device, an induction (induction stove), or an electric range. The heating device 2000 may include a working coil for generating a magnetic field for inductively heating the cooking device 1000. When the cooking device 1000 is the heater type cooking device 1000b including a receiving coil, the working coil may be referred to as a transmitting coil. According to an embodiment of the disclosure, the heating device 2000 may include a plurality of working coils. For example, when the top plate of the heating device 2000 includes a plurality of cooking zones, the heating device 2000 may include a plurality of working coils respectively corresponding to the plurality of cooking zones. Also, the heating device 2000 may include a high-power cooking zone in which a first working coil is arranged on the inner side thereof and a second working coil is arranged on the outer side thereof. The high-power cooking zone may include three or more working coils.

The top plate of the heating device 2000 according to an embodiment of the disclosure may include tempered glass such as ceramic glass so as not to be easily damaged. Also, a guide mark for guiding a cooking zone in which the cooking device 1000 should be located may be formed on the top plate of the heating device 2000.

According to an embodiment of the disclosure, the heating device 2000 may include a communication interface for communicating with an external device. For example, the heating device 2000 may communicate with the cooking device 1000 or the server device through the communication interface. The communication interface may include a short-range wireless communication interface (e.g., an NFC communication interface and/or a Bluetooth communication interface), a mobile communication interface, and/or the like.

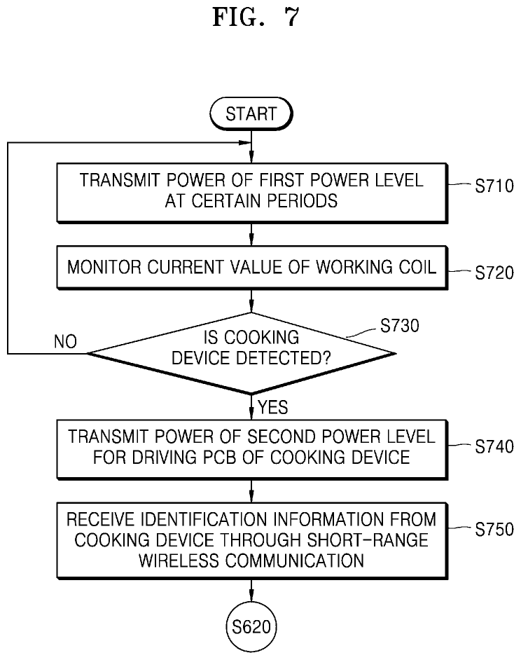

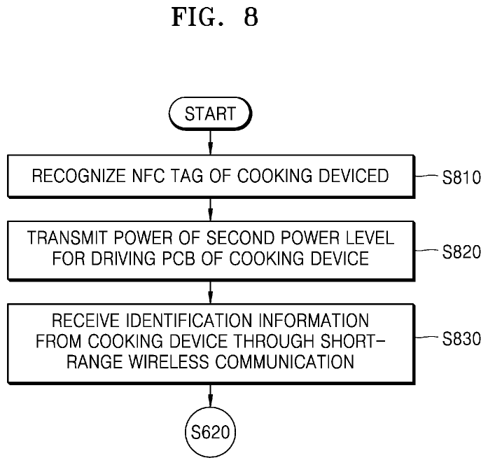

According to an embodiment of the disclosure, the heating device 2000 may detect the cooking device 1000 located on the top plate, through the communication interface. For example, the heating device 2000 may detect the cooking device 1000 located on the top plate, by using NFC communication. Also, the heating device 2000 may receive the identification information of the cooking device 1000 from the cooking device 1000 by using short-range wireless communication (e.g., NFC communication or Bluetooth communication). An operation in which the heating device 2000 receives the identification information of the cooking device 1000 will be described below in detail with reference to FIGS. 7 and 8.

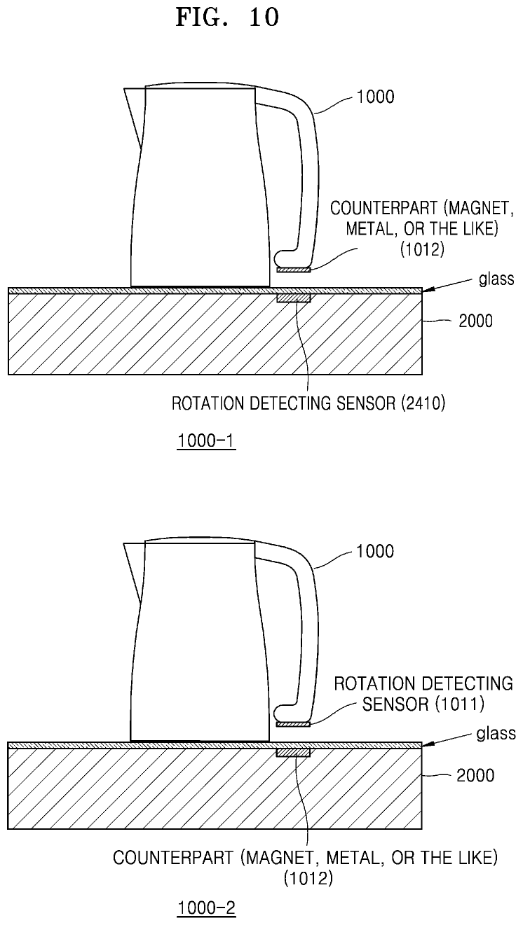

According to an embodiment of the disclosure, the heating device 2000 may detect a rotation input 101 of rotating the cooking device 1000 and determine a target heating temperature of the content of the cooking device 1000 based on a rotation displacement according to the rotation input 101. Here, the rotation displacement according to the rotation input 101 may mean that the position of the cooking device 1000 changes according to the rotation. The rotation displacement according to the rotation input 101 may include at least one of a rotation direction, a rotation angle, or a rotation speed but is not limited thereto. For example, the heating device 2000 may determine the rotation displacement according to the rotation input 101 to the cooking device 1000 by using at least one sensor included in the cooking device 1000 or the heating device 2000. The heating device 2000 may determine the rotation displacement according to the rotation input 101 based on an impedance variation of the receiving coil or an impedance variation of the transmitting coil (working coil). The heating device 2000 may determine the rotation displacement according to the rotation input 101 based on image data obtained from a camera attached to a hood, a wall, a sink, or the like. An operation in which the heating device 2000 determines the rotation displacement according to the rotation input 101 will be described below in detail with reference to FIGS. 10 to 12 and FIG. 33.

The heating device 2000 may wirelessly transmit power to the cooking device 1000 such that the temperature of the content of the cooking device 1000 may reach the target heating temperature. Wirelessly transmitting the power may mean transmitting the power by using a magnetic field induced in the receiving coil or the metal (e.g., iron component) by a magnetic induction method. For example, the heating device 2000 may flow a current through the working coil (transmitting coil) to form a magnetic field such that an eddy current may be generated in the cooking device 1000 or a magnetic field may be induced in the receiving coil.

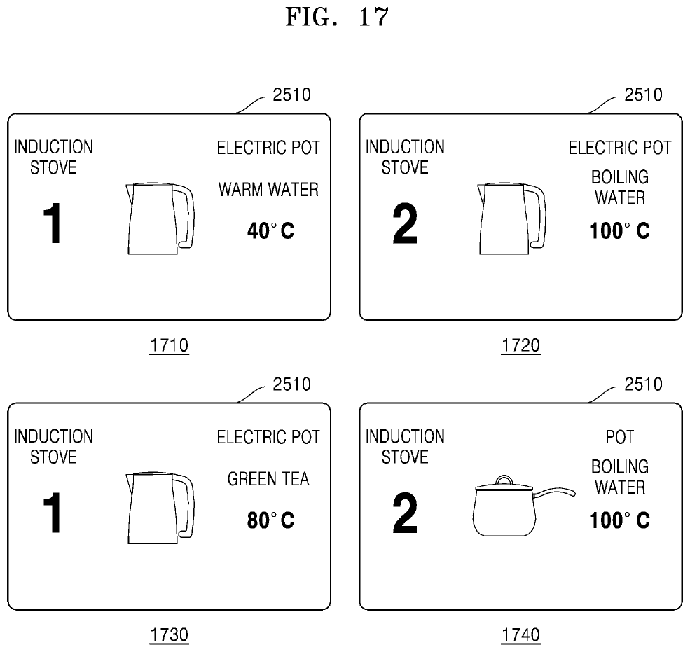

Moreover, according to an embodiment of the disclosure, the heating device 2000 may display information related to the cooking device 1000 through a display unit 2510. For example, when the cooking device 1000 is detected, the heating device 2000 may display the identification information (e.g., electric pot) of the cooking device 1000 on the display unit 2510. Also, the heating device 2000 may display a target heating temperature (e.g., 40° C.) corresponding to the cooking device 1000 on the display unit 2510. According to an embodiment of the disclosure, when the user changes the target heating temperature by rotating the cooking device 1000, the target heating temperature displayed on the display unit 2510 may be changed according to the rotation input 101. An operation in which the heating device 2000 outputs information through the display unit 2510 will be described below in detail with reference to FIGS. 17 to 19.

According to the cooking system 100 according to an embodiment of the disclosure, the user's convenience may be improved because the user may easily set the target heating temperature by a simple operation of rotating the cooking device 1000 with the cooking device 1000 placed on the heating device 2000. Hereinafter, the cooking system 100 and an operation of the cooking system 100 according to an embodiment of the disclosure will be described in more detail.

FIG. 2 is a diagram for describing an induction heating (IH) type cooking device according to an embodiment of the disclosure.

According to an embodiment of the disclosure, induction heating (IH) may be a method of heating a metal object by using electromagnetic induction, and the induction heating (IH) type cooking device 1000a may include an IH metal (e.g., iron). Thus, when a current is supplied to the working coil of the heating device 2000, an eddy current may be generated in the IH metal of the cooking device 1000a and heat may be generated in the cooking device 1000a by the eddy current and the resistance of the IH metal.

Referring to FIG. 2, the IH type cooking device 1000a may include a processor 1010, a sensor unit 1020, a communication interface 1030, and an output interface 1040. In this case, the processor 1010, the sensor unit 1020, the communication interface 1030, and the output interface 1040 may be mounted on a printed circuit board (PCB) 1005. The IH type cooking device 1000a may include a pickup coil 1001 and a communication coil 1002. The pickup coil 1001 may be a coil for generating power for operating the PCB 1005. For example, the pickup coil 1001 may receive wireless power and supply AC power to a switching mode power supply (SMPS) (not illustrated). The SMPS may convert the received AC power into DC power and supply the DC power to the PCB 1005. The communication coil 1002 may be a coil for performing short-range wireless communication (e.g., NFC or Bluetooth) with the heating device 2000. Hereinafter, the above elements will be described in turn.

The processor 1010 may control an overall operation of the cooking device 1000. For example, the processor 1010 may control the sensor unit 1020, the communication interface 1030, and the output interface 1040. The processor 1010 may analyze information obtained through the sensor unit 1020. The processor 1010 may control the communication interface 1030 to transmit or receive data. The processor 1010 may control the output interface 1040 to output information.

The sensor unit 1020 may include at least one of a temperature sensor, a rotation detecting sensor, or an image sensor but is not limited thereto. The rotation detecting sensor may include a Hall sensor, a geomagnetic sensor, a touch sensor, a gyroscope sensor, and/or an inertia sensor. The temperature sensor may be a sensor for measuring the temperature of the content of the cooking device 1000. The rotation detecting sensor may be a sensor for detecting the rotation of the cooking device 1000. The rotation detecting sensor may detect a rotation direction, a rotation speed, a rotation angle, or the like based on a user's rotation input to the cooking device 1000. The image sensor may be a sensor for obtaining image data around the cooking device 1000. When the rotation of the cooking device 1000 is detected through the image sensor, the image sensor may operate as a rotation detecting sensor. According to an embodiment of the disclosure, the cooking device 1000a may not include the sensor unit 1020.

The communication interface 1030 may include one or more elements for enabling communication between the cooking device 1000 and the heating device 2000, between the cooking device 1000 and a server device (not illustrated), between the cooking device 1000 and a mobile terminal (not illustrated), and between the cooking device 1000 and the home appliance. For example, the communication interface 1030 may include a short-range wireless communication interface and/or a long-range communication interface.

The short-range wireless communication interface may include, but is not limited to, a Bluetooth communication interface, a Bluetooth Low Energy (BLE) communication interface, a Near Field Communication (NFC) interface, a WLAN (WiFi) communication interface, a ZigBee communication interface, an Infrared Data Association (IrDA) communication interface, a WiFi Direct (WFD) communication interface, an Ultra-Wideband (UWB) communication interface, and/or an Ant+ communication interface. When the cooking device 1000 is remotely controlled by a server device (not illustrated) in an Internet of Things (IoT) environment, the long-range communication interface may be used to communicate with the server device. The long-range communication interface may include the Internet, a computer network (e.g., LAN or WAN), and/or a mobile communication interface. The mobile communication interface may include a 3G module, a 4G module, a 5G module, an LTE module, an NB-IoT module, and/or an LTE-M module but is not limited thereto.

The output interface 1040 may be for outputting a video signal or an audio signal. The output interface 1040 may include a display unit, an audio output unit, and/or a vibration motor.

When a display unit and a touch pad are configured as a touch screen by forming a layer structure, the display unit may also be used as an input interface in addition to an output interface. The display unit may include at least one of a liquid crystal display (LCD), a thin film transistor-liquid crystal display (TFT-LCD), an organic light emitting diode (OLED) display, a flexible display, a three-dimensional (3D) display, or an electrophoretic display. Also, depending on the type of the cooking device 1000, the cooking device 1000 may include two or more display units.

The audio output unit may output audio data received through the communication interface 1030 or stored in a memory (not illustrated). For example, the audio output unit may output an audio signal related to a function performed by the cooking device 1000 (e.g., a notification sound, a guide voice, audio data about the target heating temperature, audio data about the current temperature of the content). According to an embodiment of the disclosure, the cooking device 1000 may not include the audio output unit.

The output interface 1040 may further include an illumination device (e.g., an LED). For example, by using an LED lamp, the output interface 1040 may display the target heating temperature or output a color corresponding to the target heating temperature. Also, the output interface 1040 may display a temperature change situation of the content by using an LED bar. The output interface 1040 may display the current temperature of the content by using a 7-segment display device implemented by LEDs. The 7-segment display device may be implemented by a cathode discharge tube, a vacuum tube, a liquid crystal display (LCD), a mechanical display, or the like in addition to a light emitting diode (LED).

Moreover, not all of the elements illustrated in FIG. 2 are essential elements. The cooking device 1000a may include more or less elements than the illustrated elements. For example, the cooking device 1000a may include the processor 1010, the sensor unit 1020, and the communication interface 1030. Also, the cooking device 1000a may further include a user interface, a memory, and/or a battery in addition to the processor 1010, the sensor unit 1020, the communication interface 1030, and the output interface 1040. Here, the user interface may be an input interface for receiving a user's input.

According to an embodiment of the disclosure, when the cooking device 1000a includes a user interface, the user may set or change a temperature control mode of the cooking device 1000a through the user interface. For example, the cooking device 1000a may receive an input of changing a default temperature (e.g., changing from 40° C. to 50° C.).

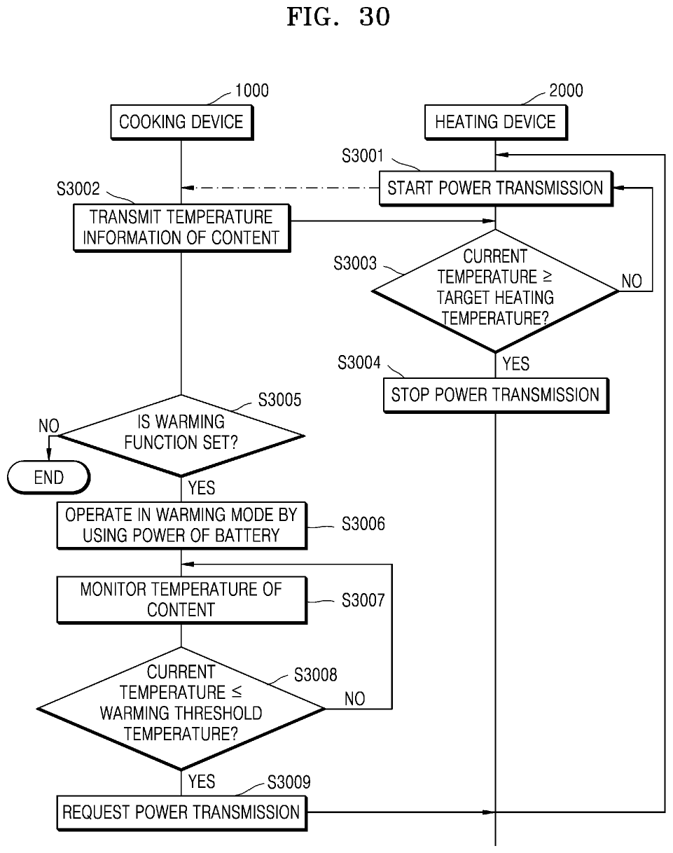

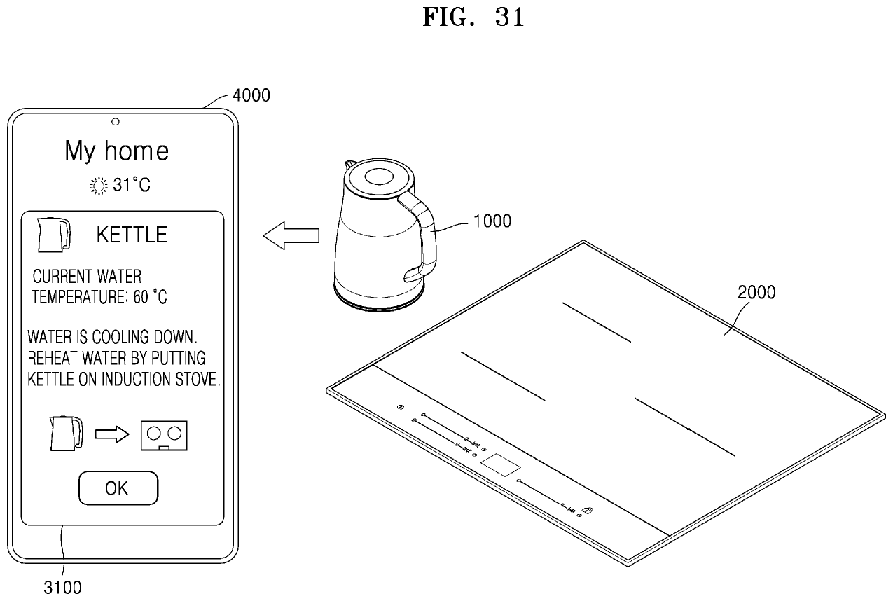

According to an embodiment of the disclosure, when the cooking device 1000a includes a battery, the battery may be used as auxiliary power. For example, when the cooking device 1000a provides a warming function, the cooking device 1000a may monitor the temperature of the content by using the power of the battery even when power transmission from the heating device 2000 is stopped. When the temperature of the content decreases below a threshold temperature, the cooking device 1000a may transmit a notification to the mobile terminal or request power transmission from the heating device 2000 by using the power of the battery. An operation in which the cooking device 1000a monitors the temperature of the content will be described below in detail with reference to FIGS. 30 to 31.

According to an embodiment of the disclosure, when the cooking device 1000a includes a memory, the memory may store a program for processing and controlling by the processor 1010 and may store input/output data (e.g., information about the temperature control mode, information about the default temperature, temperature information of the content, and/or identification information of the cooking device 1000a).

The memory may include at least one type of storage medium from among flash memory type, hard disk type, multimedia card micro type, card type memory (e.g., SD and XD memories), random access memory (RAM), static random access memory (SRAM), read only memory (ROM), electronically erasable programmable read only memory (EEPROM), programmable read only memory (PROM), magnetic memory, magnetic disk, and optical disk. The programs stored in the memory may be classified into a plurality of modules according to the functions thereof. At least one artificial intelligence model may be stored in the memory.

FIG. 3 is a diagram for describing a heater type cooking device according to an embodiment of the disclosure.

The heater type cooking device 1000b may further include a receiving coil 1003 and a heater 1004 than the IH type cooking device 1000a. Because the components (the pickup coil 1001, the communication coil 1002, the processor 1010, the sensor unit 1020, the communication interface 1030, and the output interface 1040) of the heater type cooking device 1000b correspond to the components of the IH type cooking device 1000a illustrated in FIG. 2, only the heater 1004 and the receiving coil 1003 further included in the heater type cooking device 1000b will be described in FIG. 3.

The receiving coil 1003 may be a coil for driving the heater 1004 by receiving wireless power transmitted from the heating device 2000. For example, as a magnetic field generated from a current flowing through a transmitting coil (working coil) 2120 of the heating device 2000 passes through the receiving coil 1003, an induced current may flow through the receiving coil 1003 to supply energy to the heater 1004. Hereinafter, the induced current flowing through the receiving coil 1003 due to the magnetic field generated in the transmitting coil (working coil) 2120 may be represented as the receiving coil 1003 receiving the wireless power from the transmitting coil (working coil) 2120. According to an embodiment of the disclosure, the receiving coil 1003 may have a concentric circle shape or an elliptical shape; however, the disclosure is not limited thereto. According to an embodiment of the disclosure, the receiving coil 1003 may include a plurality of receiving coils. For example, the cooking device 1000b may include a receiving coil for a warming heater and a receiving coil for a heating heater. In this case, the receiving coil for the heating heater may drive the heating heater, and the receiving coil for the heating heater may drive the warming heater.

The heater 1004 may be for heating the content of the cooking device 1000b. The shape of the heater 1004 may vary, and the material of an outer cover may also vary (e.g., iron, stainless, copper, aluminum, Incoloy, or Inconel). According to an embodiment of the disclosure, the cooking device 1000b may include a plurality of heaters 1004. For example, the cooking device 1000b may include a warming heater and a heating heater. The warming heater and the heating heater may output different levels of heating power. For example, the heating level of the warming heater may be lower than the heating level of the heating heater.

According to an embodiment of the disclosure, the cooking device 1000b may further include a resonance capacitor (not illustrated) between the receiving coil 1003 and the heater 1004. In this case, the resonance value may be set differently according to the amount of power required by the heater 1004. Also, according to an embodiment of the disclosure, the cooking device 1000b may further include a switch unit (e.g., a relay switch or a semiconductor switch) (not illustrated) for turning on/off the heater 1004.

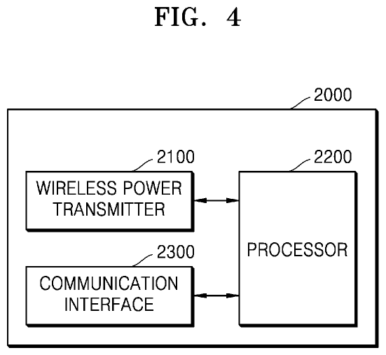

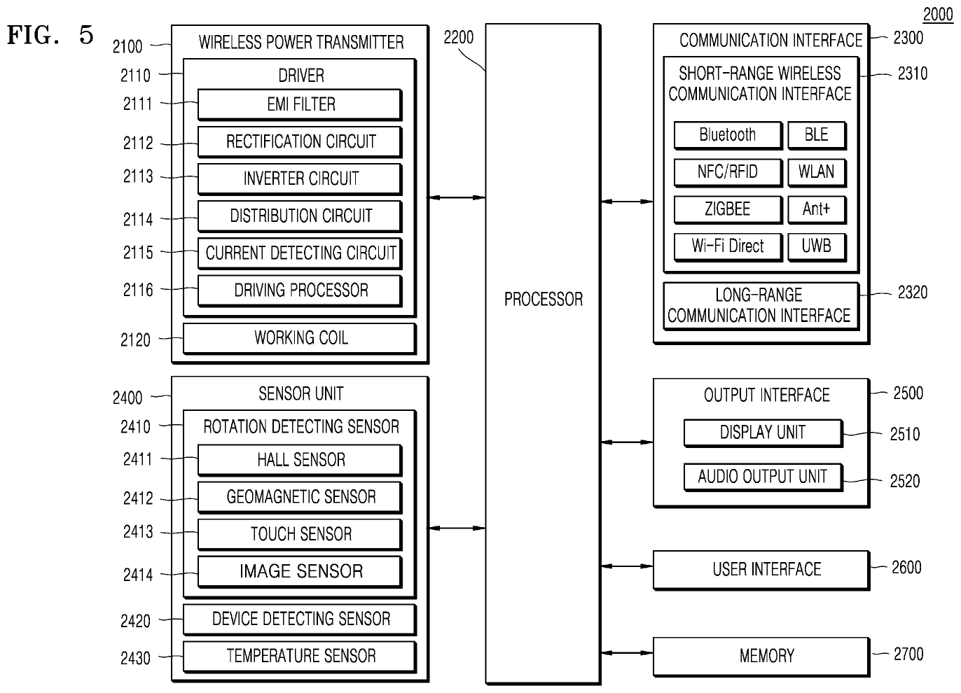

Hereinafter, the heating device 2000 transmitting power to the cooking devices 1000a and 1000b will be described in detail with reference to FIGS. 4 and 5.

FIG. 4 is a block diagram for describing a function of a heating device according to an embodiment of the disclosure. FIG. 5 is a block diagram for describing a function of a heating device according to an embodiment of the disclosure.

As illustrated in FIG. 4, the heating device 2000 according to an embodiment of the disclosure may include a wireless power transmitter 2100, a processor 2200, and a communication interface 2300. However, not all of the illustrated elements are essential elements. The heating device 2000 may include more or less elements than the illustrated elements. As illustrated in FIG. 5, the heating device 2000 according to an embodiment of the disclosure may include a wireless power transmitter 2100, a processor 2200, a communication interface 2300, a sensor unit 2400, an output interface 2500, a user interface 2600, and a memory 2700.

Hereinafter, the above elements will be described in turn.

The wireless power transmitter 2100 may include a driver 2110 and a working coil 2120 but is not limited thereto. The driver 2110 may receive power from an external power supply and supply a current to the working coil 2120 according to a driving control signal of the processor 2200. The driver 2110 may include an electromagnetic interference (EMI) filter 2111, a rectification circuit 2112, an inverter circuit 2113, a distribution circuit 2114, a current detecting circuit 2115, and a driving processor 2116 but is not limited thereto.

The EMI filter 2111 may block a high-frequency noise included in AC power supplied from an external power supply (external source) and pass an AC voltage and an AC current of a predetermined frequency (e.g., 50 Hz or 60 Hz). A fuse and a relay for blocking an overcurrent may be arranged between the EMI filter 2111 and the external power supply. The AC power obtained when the high-frequency noise is blocked by the EMI filter 2111 may be supplied to the rectification circuit 2112.

The rectification circuit 2112 may convert AC power into DC power. For example, the rectification circuit 2112 may convert an AC voltage (positive voltage or negative voltage) whose magnitude and polarity change with time into a DC voltage whose magnitude and polarity are constant and may convert an AC current (positive current or negative current) whose magnitude and direction change with time into a DC current whose magnitude is constant. The rectification circuit 2112 may include a bridge diode. For example, the rectification circuit 2112 may include four diodes. The bridge diode may convert an AC voltage whose polarity changes with time into a positive voltage whose polarity is constant and may convert an AC current whose direction changes with time into a positive current whose direction is constant. The rectification circuit 2112 may include a DC link capacitor. The DC link capacitor may convert a positive voltage whose magnitude changes with time into a DC voltage with a constant magnitude.

The inverter circuit 2113 may include a switching circuit for supplying or blocking a driving current to the working coil 2120 and a resonance circuit for generating a resonance together with the working coil 2120. The switching circuit may include a first switch and a second switch. The first switch and the second switch may be connected in series between a plus line and a minus line output from the rectification circuit 2112. The first switch and the second switch may be turned on or off according to a driving control signal of the driving processor 2116.

The inverter circuit 2113 may control a current supplied to the working coil 2120. For example, the magnitude and direction of a current flowing through the working coil 2120 may change according to the turn-on/off of the first switch and the second switch included in the inverter circuit 2113. In this case, an AC current may be supplied to the working coil 2120. An AC current in the form of a sine wave may be supplied to the working coil 2120 according to the switching operation of the first switch and the second switch. Also, as the switching period of the first switch and the second switch increases (e.g., as the switching frequency of the first switch and the second switch decreases), the current supplied to the working coil 2120 may increase and the strength of the magnetic field output by the working coil 2120 (the output of the heating device 2000) may increase.

When the heating device 2000 includes a plurality of working coils 2120, the driver 2110 may include a distribution circuit 2114. The distribution circuit 2114 may include a plurality of switches for passing or blocking a current supplied to the plurality of working coils 2120, and the plurality of switches may be turned on or off according to a distribution control signal of the driving processor 2116.

The current detecting circuit 2115 may include a current sensor for measuring a current output from the inverter circuit 2113. The current sensor may transmit an electrical signal corresponding to the measured current value to the driving processor 2116.

The driving processor 2116 may determine a switching frequency (turn-on/off frequency) of the switching circuit included in the inverter circuit 2113, based on the output strength (power level) of the heating device 2000. The driving processor 2116 may generate a driving control signal for turning on/off the switching circuit according to the determined switching frequency.

The working coil 2120 may generate a magnetic field for heating the cooking device 1000. For example, when a driving current is supplied to the working coil 2120, a magnetic field may be induced around the working coil 2120. When a current whose magnitude and direction change with time, that is, an AC current, is supplied to the working coil 2120, a magnetic field whose magnitude and direction change with time may be induced around the working coil 2120. The magnetic field around the working coil 2120 may pass through the top plate including tempered glass and may reach the cooking device 1000 placed on the top plate. An eddy current rotating around a magnetic field may be generated in the cooking device 1000 due to the magnetic field whose amplitude and direction change with time, and electrical resistance heat may be generated in the cooking device 1000 due to the eddy current. The electrical resistance heat may be heat generated in a resistor when a current flows through the resistor, and may also be referred to as Joule heat. By the electrical resistance heat, the cooking device 1000 may be heated and the content of the cooking device 1000 may be heated.

According to an embodiment of the disclosure, as the magnetic field generated in the working coil 2120 passes through the receiving coil 1003, an induced current may flow through the receiving coil 1003 of the cooking device 1000. In this case, the cooking device 1000 may heat the content by driving the heater 1004 by using the power generated by the receiving coil 1003.

The processor 2200 may control an overall operation of the heating device 2000. By executing the programs stored in the memory 2700, the processor 2200 may control the wireless power transmitter 2100, the communication interface 2300, the sensor unit 2400, the output interface 2500, the user interface 2600, and the memory 2700.

According to an embodiment of the disclosure, the heating device 2000 may be equipped with an artificial intelligence (AI) processor. The AI processor may be manufactured in the form of a dedicated hardware chip for AI and may be manufactured as a portion of a general-purpose processor (e.g., CPU or application processor) or a dedicated graphics processor (e.g., GPU) and then mounted on the heating device 2000.

According to an embodiment of the disclosure, the processor 2200 may identify a temperature control mode of the cooking device 1000 corresponding to the identification information of the cooking device 1000. The temperature control mode may include information about at least one of the default temperature or the control mode. Information about the temperature control mode of the cooking device 1000 may be stored in the memory 2700 of the heating device 2000 or may be obtained from the cooking device 1000 or the server device.

The processor 2200 may detect a rotation input of rotating the cooking device 1000. For example, the processor 2200 may obtain a rotation displacement according to the rotation input by using the rotation detecting sensor 2410 included in the heating device 2000 or the cooking device 1000. Also, the processor 2200 may obtain the rotation displacement based on at least one of an impedance variation of the working coil 2120 or an impedance variation of the receiving coil 1003.

The processor 2200 may obtain a target heating temperature corresponding to the cooking device 1000 based on the rotation displacement and the temperature control mode of the cooking device 1000. For example, the processor 2200 may identify a default temperature of the cooking device 1000 based on the temperature control mode of the cooking device 1000, may determine a temperature higher than the default temperature as the target heating temperature when the rotation input is a first rotation input in a first direction (e.g., a counterclockwise or clockwise direction), and may determine a temperature lower than the default temperature as the target heating temperature when the rotation input is a second rotation input in a second direction (e.g., a clockwise or counterclockwise direction). Also, the processor 2200 may increase the target heating temperature from the default temperature at preset temperature intervals as a rotation displacement according to the first rotation input in the first direction (e.g., the counterclockwise or clockwise direction) increases and may decrease the target heating temperature from the default temperature at preset temperature intervals as a rotation displacement according to the second rotation input in the second direction (e.g., the clockwise or counterclockwise direction) increases. Hereinafter, for convenience of description, a case where the first direction is the counterclockwise direction and the second direction is the clockwise direction will be described as an example.

The processor 2200 may control power transmission by the wireless power transmitter 2100 such that the temperature of the content of the cooking device 1000 may reach the target heating temperature. For example, the processor 2200 may determine whether the temperature of the content of the cooking device 1000 has reached the target heating temperature, based on receiving the temperature information of the content of the cooking device 1000 from the cooking device 1000 through the communication interface 2300. When the temperature of the content of the cooking device 1000 reaches the target heating temperature (or the target heating temperature or more), the processor 2200 may stop the power transmission by the wireless power transmitter 2100. For example, the processor 2200 may control the inverter circuit 2113 to stop the supply of the driving current to the working coil 2120.

The communication interface 2300 may include a short-range wireless communication interface 2310 and a long-range communication interface 2320. The short-range wireless communication interface 2310 may include, but is not limited to, a Bluetooth communication interface, a Bluetooth Low Energy (BLE) communication interface, a Near Field Communication (NFC) interface, a WLAN (WiFi) communication interface, a ZigBee communication interface, an Infrared Data Association (IrDA) communication interface, a WiFi Direct (WFD) communication interface, an Ultra-Wideband (UWB) communication interface, and/or an Ant+ communication interface. The long-range communication interface 2320 may be for communicating with a device (e.g., a server device) connected to an external network and may include the Internet, a computer network, and/or a mobile communication interface. The mobile communication interface may transmit/receive wireless signals to/from at least one of a base station, an external terminal, or a server on a mobile communication network. Here, the wireless signals may include voice call signals, video call signals, or various types of data according to transmission/reception of text/multimedia messages. The mobile communication interface may include a 3G module, a 4G module, a 5G module, an LTE module, an NB-IoT module, and/or an LTE-M module but is not limited thereto.

According to an embodiment of the disclosure, the communication interface 2300 may receive the identification information of the cooking device 1000 (e.g., the type, MAC address, and/or model name of the cooking device 1000) located on the top plate, from the cooking device 1000. The communication interface 2300 may receive the temperature information of the content measured by the cooking device 1000, from the cooking device 1000.

The sensor unit 2400 may include a rotation detecting sensor 2410, a device detecting sensor 2420, and a temperature sensor 2430 but is not limited thereto.

The rotation detecting sensor 2410 may be a sensor for detecting the rotation of the cooking device 1000 placed on the top plate. For example, based on a rotation input of rotating the cooking device 1000, the rotation detecting sensor 2410 may obtain a rotation displacement according to the rotation input (e.g., whether the cooking device 1000 is rotated, a rotation direction, a rotation angle, and/or a rotation speed).

The rotation detecting sensor 2410 may include various sensors. For example, the rotation detecting sensor 2410 may include at least one of a Hall sensor 2411, a geomagnetic sensor 2412, a touch sensor 2413, or an image sensor 2414. Because the function of each of the sensors may be intuitively inferred from its name by those of ordinary skill in the art, redundant descriptions thereof will be omitted for conciseness.

According to an embodiment of the disclosure, a plurality of rotation detecting sensors 2410 may be arranged at the heating device 2000. For example, when the rotation detecting sensor 2410 is implemented by the Hall sensor 2411, a plurality of Hall sensors 2411 may be arranged at the heating device 2000. In this case, the heating device 2000 may more precisely detect a magnetic field change according to the movement (rotation) of the cooking device 1000 by using the plurality of rotation detecting sensors 2410. Also, the heating device 2000 may detect the rotation direction of the cooking device 1000 based on the output of the plurality of rotation detecting sensors 2410.

According to an embodiment of the disclosure, an insulation layer may be arranged between the rotation detecting sensor 2410 and the top plate (glass plate). The insulation layer may prevent the heat of the inductively-heated heating cooking device 1000 from being conducted to the rotation detecting sensor 2410 such that the rotation detecting sensor 2410 may perform a normal operation even at a high temperature. An operation in which the heating device 2000 detects a rotation input to the cooking device 1000 by using the rotation detecting sensor 2410 will be described below in detail with reference to FIG. 10.

The device detecting sensor 2420 may be a sensor for detecting that the cooking device 1000 is placed on the top plate. For example, the device detecting sensor 2420 may include a current sensor; however, the disclosure is not limited thereto. The device detecting sensor 2420 may include at least one of a proximity sensor, a touch sensor, a weight sensor, a temperature sensor, an illuminance sensor, or a magnetic sensor. An operation in which the device detecting sensor 2420 including a current sensor recognizes the cooking device 1000 will be described below in detail with reference to FIG. 7.

The temperature sensor 2430 may detect the temperature of the cooking device 1000 placed on the top plate or the temperature of the top plate. The cooking device 1000 may be inductively heated by the working coil 2120 and may be overheated depending on the material thereof. Thus, the heating device 2000 may detect the temperature of the top plate or the cooking device 1000 placed on the top plate and may block the operation of the working coil 2120 when the cooking device 1000 is overheated. The temperature sensor 2430 may be installed near the working coil 2120. For example, the temperature sensor 2430 may be located at the center of the working coil 2120.

According to an embodiment of the disclosure, the temperature sensor 2430 may include a thermistor whose electrical resistance value changes according to temperature. For example, the temperature sensor 230 may include a negative temperature coefficient (NTC) temperature sensor; however, the disclosure is not limited thereto. The temperature sensor 230 may include a positive temperature coefficient (PTC) temperature sensor.

The output interface 2500 may be for outputting an audio signal or a video signal and may include a display unit 2510 and/or an audio output unit 2520.

When the display unit 2510 and a touch pad are configured as a touch screen by forming a layer structure, the display unit 2510 may also be used as an input device in addition to the output interface 2500. The display unit 2510 may include at least one of a liquid crystal display (LCD), a thin film transistor-liquid crystal display (TFT-LCD), a light emitting diode (LED) display, an organic light emitting diode (OLED) display, a flexible display, a three-dimensional (3D) display, or an electrophoretic display. Also, depending on the type of the heating device 2000, the heating device 2000 may include two or more display units 2510.

The audio output unit 2520 may output audio data received from the communication interface 2300 or stored in the memory 2700. Also, the audio output unit 2520 may output an audio signal related to a function performed by the heating device 2000. The audio output unit 2000 may include a speaker and/or a buzzer.

According to an embodiment of the disclosure, the output interface 2500 may display at least one of a target heating temperature, a current temperature of the content of the cooking device 1000, or information representing a temperature change situation of the content of the cooking device 1000, through the display unit 2510. According to another embodiment of the disclosure, the output interface 2500 may output the target heating temperature and the current temperature of the content of the cooking device 1000 by voice.

According to an embodiment of the disclosure, the output interface 2500 may display the identification information of the cooking device 1000. For example, the output interface 2500 may display, on the display unit 2510, at least one of the type of the cooking device 1000, the model name of the cooking device 1000, or an icon representing the cooking device 1000.

According to an embodiment of the disclosure, the output interface 2500 may display a current power level, an operation mode (e.g., a low-noise mode, a normal mode, or a high-power mode), and/or the like.

The user interface 2600 may be an input interface for receiving an input from the user. The user interface 2600 may include, but is not limited to, at least one of a key pad, a dome switch, a touch pad (e.g., a capacitive overlay type, a resistive overlay type, an infrared beam type, a surface acoustic wave type, an integral strain gauge type, or a piezoelectric type), a jog wheel, or a jog switch.

The user interface 2600 may include a speech recognition module. For example, the heating device 2000 may receive a voice signal, which is an analog signal, through a microphone and convert a voice portion into computer-readable text by using an automatic speech recognition (ASR) model. By using a natural language understanding (NLU) model, the heating device 2000 may interpret the resulting text to obtain the user's utterance intention. Here, the ASR model or the NLU model may be an AI model. The AI model may be processed by a dedicated AI processor designed in a hardware structure specialized for processing the AI model. The AI model may be generated through training. Here, being generated through training may mean that a basic AI model is trained by a learning algorithm by using a plurality of training data and accordingly a predefined operation rule or AI model set to perform a desired feature (or purpose) is generated. The AI model may include a plurality of neural network layers. Each of the plurality of neural network layers may have a plurality of weight values and may perform a neural network operation through an operation between the plurality of weights and the operation result of a previous layer.

Linguistic understanding may be a technology for recognizing and applying/processing human languages/characters and may include natural language processing, machine translation, dialog system, question answering, speech recognition/synthesis, and the like.

The memory 2700 may store a program for processing and controlling by the processor 2200 and may store input/output data (e.g., identification information of the cooking device 1000 or information about the temperature control mode of the cooking device 1000). The memory 2700 may store an AI model.

The memory 2700 may include at least one type of storage medium from among flash memory type, hard disk type, multimedia card micro type, card type memory (e.g., SD or XD memory), random access memory (RAM), static random access memory (SRAM), read only memory (ROM), electronically erasable programmable read only memory (EEPROM), programmable read only memory (PROM), magnetic memory, magnetic disk, and optical disk. Also, the heating device 2000 may operate a cloud server or a web storage for performing a storage function on the Internet.

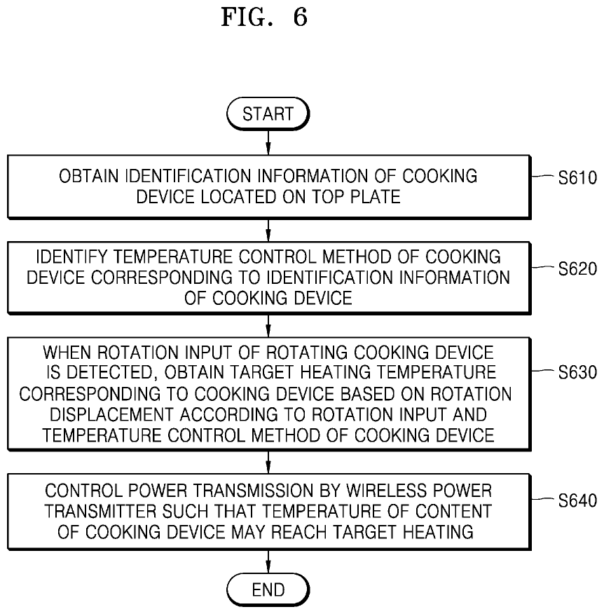

Hereinafter, an operation in which the heating device 2000 determines a target heating temperature based on a rotation input to the cooking device 1000 and controls output (power transmission) such that the temperature of the content of the cooking device 1000 reaches the target heating temperature will be described in detail with reference to FIG. 6.

FIG. 6 is a flowchart for describing an operating method of a heating device according to an embodiment of the disclosure.

In operation S610, the heating device 2000 according to an embodiment of the disclosure may obtain the identification information of the cooking device 1000 located on the top plate.

According to an embodiment of the disclosure, the heating device 2000 may receive the identification information of the cooking device 1000 from the cooking device 1000 through short-range wireless communication. For example, the heating device 2000 may receive the identification information of the cooking device 1000 through at least one of NFC communication or Bluetooth communication; however, the disclosure is not limited thereto. The heating device 2000 may receive the identification information of the cooking device 1000 through at least one of WiFi Direct, UWB, or ZigBee.

The identification information of the cooking device 1000 may be unique information for identifying the cooking device 1000 and may include, but is not limited to, at least one of a MAC address, a model name, device type information (e.g., IH type ID or heater type ID), manufacturer information (e.g., Manufacture ID), or a serial number.

According to an embodiment of the disclosure, when detecting that the cooking device 1000 is placed on the top plate, the heating device 2000 may request the identification information of the cooking device 1000 from the cooking device 1000 through short-range wireless communication. Also, the heating device 2000 may receive the identification information of the cooking device 1000 from the cooking device 1000 through short-range wireless communication. For example, by using a current sensor located adjacent to the working coil 2120, the heating device 2000 may detect that the cooking device 1000 is placed on the top plate and request the identification information of the cooking device 1000 from the cooking device 1000 through short-range wireless communication. Also, by recognizing an NFC tag included in the cooking device 1000, the heating device 2000 may detect that the cooking device 1000 is placed on the top plate and request the identification information of the cooking device 1000 from the cooking device 1000 through short-range wireless communication. An operation in which the heating device 2000 detects the cooking device 1000 will be described below in more detail with reference to FIGS. 7 and 8.

In operation S620, the heating device 2000 according to an embodiment of the disclosure may identify the temperature control mode of the cooking device 1000 corresponding to the identification information of the cooking device 1000.

The temperature control mode according to an embodiment of the disclosure may relate to a method of setting the target heating temperature. A method in which the user sets the target heating temperature may be various. For example, the method in which the user to set the target heating temperature may include a method of selecting a target heating temperature by operating a touch panel with a finger, a method of inputting a target heating temperature by voice, and a method of inputting a target heating temperature through a rotation input of rotating the cooking device 1000. However, the temperature control mode according to an embodiment of the disclosure may be related to a rotation input of rotating the cooking device 1000. For example, the temperature control mode may include a default temperature and a control mode related to the rotation input. The control mode may include, but is not limited to, at least one of increasing/decreasing the target heating temperature according to the rotation direction, increasing/decreasing the target heating temperature according to the rotation speed, intervals of temperature increasing/decreasing according to the rotation direction or the rotation speed, or operating at the default temperature.

According to an embodiment of the disclosure, the temperature control mode of the cooking device 1000 may be set differently for each device. For example, in a first temperature control mode of a first cooking device, the default temperature may be 40° C., the target heating temperature may increase by 10° C. with respect to a counterclockwise rotation input, and the target heating temperature may increase by 10° C. with respect to a clockwise rotation input. In a second temperature control mode of a second cooking device, the default temperature may be 50° C., and the target heating temperature is set to 100° C. when the rotation speed is greater than a threshold value.

According to an embodiment of the disclosure, the temperature control mode of the cooking device 1000 may be predefined when the cooking device 1000 is manufactured or may be defined by the user when the cooking device 1000 is purchased. Also, according to an embodiment of the disclosure, the temperature control mode of the cooking device 1000 may be changed later by a user input. For example, the user may change the temperature control mode through the user interface of the cooking device 1000, may change the temperature control mode through the user interface 2600 of the heating device 2000, or may change the temperature control mode through a particular application provided by the server device.

According to an embodiment of the disclosure, information about the temperature control mode of the cooking device 1000 may be stored in the memory 2700 of the heating device 2000. For example, a temperature control mode database (DB) including information about mapping at least one temperature control mode and identification information of at least one cooking device may be stored in the memory 2700. In this case, the heating device 2000 may retrieve (identify) the temperature control mode of the cooking device 1000 in the temperature control mode DB based on the identification information of the cooking device 1000.

According to another embodiment of the disclosure, when information about the temperature control mode of the cooking device 1000 is stored in the cooking device 1000, the heating device 2000 may receive the information about the temperature control mode of the cooking device 1000 from the cooking device 1000. The heating device 2000 may receive the information about the temperature control mode of the cooking device 1000 through short-range wireless communication (e.g., NFC, Bluetooth, or WiFi direct). The heating device 2000 may identify the temperature control mode of the cooking device 1000 from the received temperature control mode information.

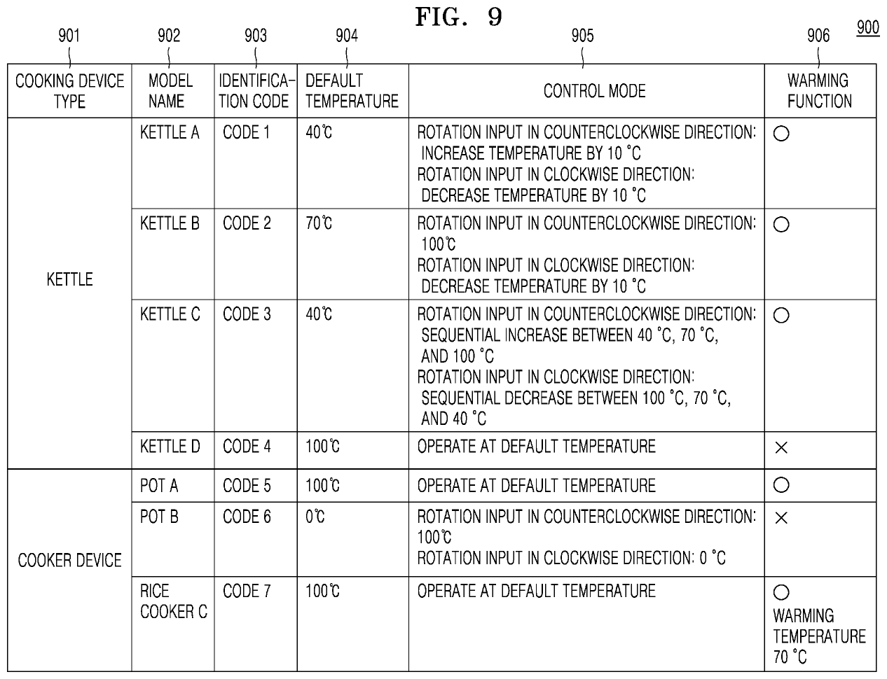

According to another embodiment of the disclosure, the heating device 2000 may receive information about the temperature control mode of the cooking device 1000 from the server device. For example, the heating device 2000 may request the information about the temperature control mode of the cooking device 1000 while transmitting the identification information of the cooking device 1000 to the server device. The heating device 2000 may receive the information about the temperature control mode of the cooking device 1000 from the server device as a response to the request. The temperature control mode of the cooking device 1000 will be described below in more detail with reference to FIG. 9.

In operation S630, when a rotation input of rotating the cooking device 1000 is detected, the heating device 2000 according to an embodiment of the disclosure may obtain a target heating temperature corresponding to the cooking device 1000 based on the rotation displacement according to the rotation input and the temperature control mode of the cooking device 1000.

According to an embodiment of the disclosure, when a rotation input of rotating the cooking device 1000 by the user occurs in the cooking device 1000 placed on the top plate, the heating device 2000 may obtain a rotation displacement according to the rotation input by using the rotation detecting sensor 2410. The rotation displacement according to the rotation input may mean that the position of the cooking device 1000 changes according to the rotation. The rotation displacement according to the rotation input may include at least one of whether a rotation has occurred, a rotation direction, a rotation speed, or a rotation angle. The rotation detecting sensor 2410 may include at least one of a Hall sensor, a geomagnetic sensor, a touch sensor, a gyroscope sensor, or an image sensor. The rotation detecting sensor 2410 may be arranged at the heating device 2000 or may be arranged at the cooking device 1000. When the rotation detecting sensor 2410 is arranged at the cooking device 1000, the heating device 2000 may receive information about the rotation displacement according to the rotation input from the cooking device 1000 through short-range wireless communication. An operation in which the heating device 2000 detects a rotation displacement according to the rotation input by using the rotation detecting sensor 2410 will be described below in detail with reference to FIG. 10.

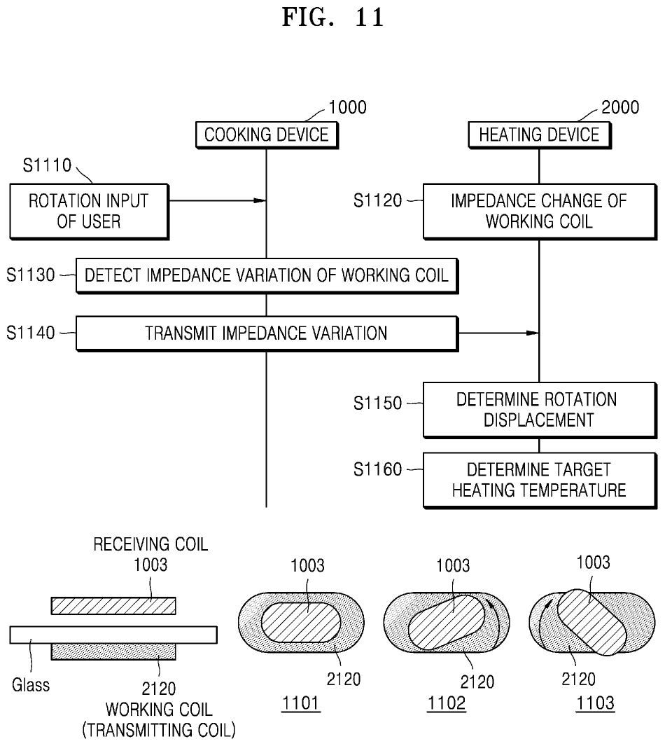

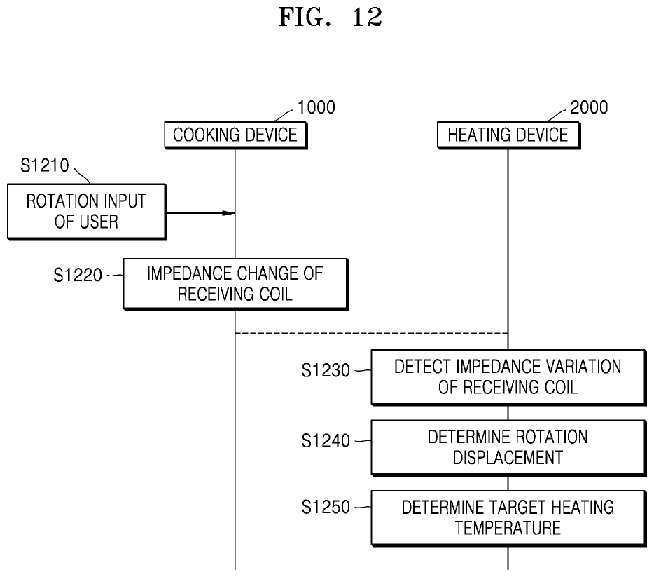

According to an embodiment of the disclosure, when the cooking device 1000 is the heater type cooking device 1000b, the heating device 2000 may obtain a rotation displacement according to the rotation input based on at least one of an impedance variation of the working coil 2120 or an impedance variation of the receiving coil 1003. An operation in which the heating device 2000 obtains a rotation displacement according to the rotation input based on the impedance variation of the working coil 2120 or the receiving coil 1003 will be described below in detail with reference to FIGS. 11 and 12.

According to an embodiment of the disclosure, the heating device 2000 may identify a default temperature of the cooking device 1000 based on the temperature control mode of the cooking device 1000. The temperature control mode of the cooking device 1000 may be associated with the identification information of the cooking device 1000. For example, when the default temperature is defined as 40° C. in the temperature control mode of the first cooking device, the heating device 2000 may identify the default temperature of the first cooking device as 40° C.

According to an embodiment of the disclosure, the heating device 2000 may determine a target heating temperature of the cooking device 1000 based on the rotation direction of a rotation input to the cooking device 1000. For example, the heating device 2000 may determine a temperature higher than the default temperature as the target heating temperature when the rotation input is the first rotation input in the first direction and may determine a temperature lower than the default temperature as the target heating temperature when the rotation input is the second rotation in the second direction. In this case, the first direction may be the counterclockwise direction (the right direction) and the second direction may be the clockwise direction (the left direction); however, the disclosure is not limited thereto and the reverse thereof may be true.

For example, when the default temperature of the first cooking device is 40° C. and the user rotates the first cooking device in the counterclockwise direction, the heating device 2000 may determine the target heating temperature of the first cooking device as 50° C. that is a temperature higher than 40° C. Also, when the default temperature of the second cooking device is 80° C. and the user rotates the second cooking device in the clockwise direction, the heating device 2000 may determine the target heating temperature of the second cooking device as 60° C. that is a temperature lower than 80° C.

According to an embodiment of the disclosure, the heating device 2000 may gradually increase or decrease the target heating temperature based on the rotation direction and the rotation displacement (e.g., the rotation angle) according to the rotation input. For example, the heating device 2000 may increase the target heating temperature from the default temperature at preset temperature intervals as the rotation angle of the first rotation input in the counterclockwise direction (the right direction) increases. Also, the heating device 2000 may decrease the target heating temperature from the default temperature at preset temperature intervals as the rotation angle of the second rotation input in the counterclockwise direction (the left direction) increases. The preset temperature interval may be defined in the temperature control mode of the cooking device 1000. The preset temperature interval may be changed by a user input.

For example, it is assumed that the default temperature is defined as 40° C. and the preset temperature interval is defined as 10° C. in the temperature control mode of the first cooking device. In this case, when the user continues to rotate the first cooking device in the counterclockwise direction (the right direction), the heating device 2000 may gradually increase the target heating temperature of the first cooking device from 40° C. to 50° C., 60° C., 70° C., and 80° C. as the rotation angle in the counterclockwise direction increases. Also, in the temperature control mode of the second cooking device, the default temperature may be defined as 80° C. and the preset temperature interval may be defined as 5° C. In this case, when the user continues to rotate the second cooking device in the clockwise direction (the left direction), the heating device 2000 may gradually decrease the target heating temperature of the second cooking device from 80° C. to 75° C. 70° C., 65° C., and 60° C. as the rotation angle in the clockwise direction increases.

Moreover, according to an embodiment of the disclosure, the heating device 2000 may adjust the target heating temperature corresponding to the cooking device 1000 at a certain temperature interval (e.g., 5° C. or 10° C.) whenever the rotation angle is changed by the preset angle (e.g., 20°).

According to an embodiment of the disclosure, when the user rotates the cooking device 1000 in the counterclockwise direction (the right direction) and then rotates the same in the clockwise direction (the left direction) at a first time, the heating device 2000 may increase the target heating temperature (e.g., 40° C.->50° C.->60° C.) and then decrease the target heating temperature (e.g., 60° C.->50° C.->40° C.) from the first time.

According to an embodiment of the disclosure, the heating device 2000 may determine a target heating temperature among a plurality of preset temperatures. For example, when the plurality of temperatures are defined as 40° C., 70° C., 80° C., and 100° C. in the temperature control mode of a third cooking device, the heating device 2000 may determine the target heating temperature of the third cooking device among 40° C., 70° C., 80° C., and 100° C. For example, when the user rotates the third cooking device in the counterclockwise direction, the heating device 2000 may sequentially increase the target heating temperature among 40° C., 70° C., 80° C., and 100° C., and when the user rotates the third cooking device in the clockwise direction, the heating device 2000 may sequentially decrease the target heating temperature among 40° C., 70° C., 80° C., and 100° C.

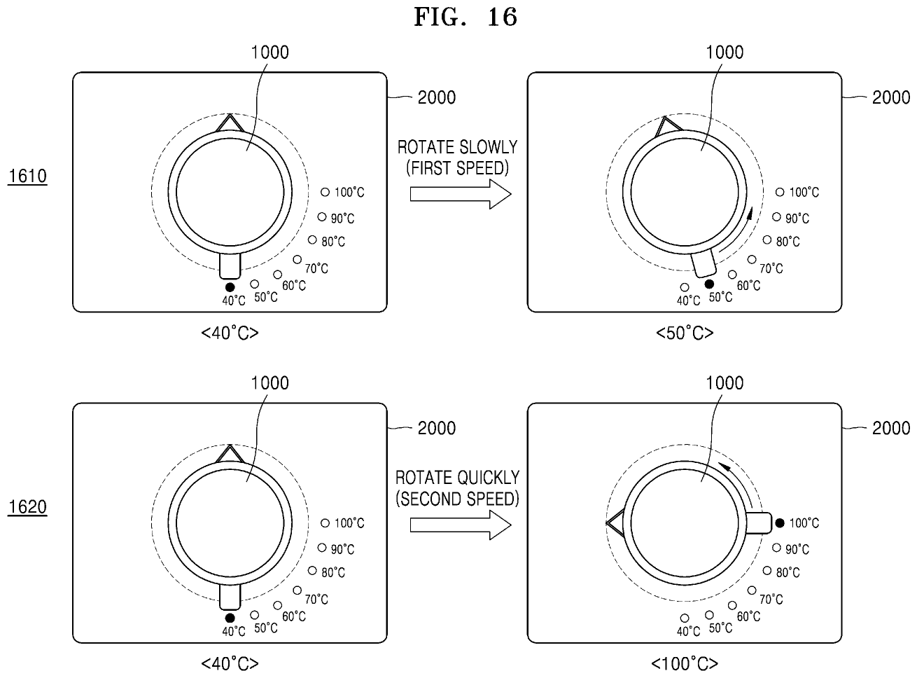

According to an embodiment of the disclosure, the heating device 2000 may determine the target heating temperature of the cooking device 1000 based on the rotation speed and rotation direction of the rotation input. For example, the heating device 2000 may determine the target heating temperature as the highest temperature (e.g., 100° C.) when the rotation speed of the first rotation input in the counterclockwise direction is greater than a threshold value and may gradually increase the target heating temperature at preset temperature intervals (e.g., 10° C.) when the rotation speed of the first rotation input is less than or equal to the threshold value. Also, the heating device 2000 may determine the target heating temperature as the lowest temperature (e.g., 40° C. or 10° C.) when the rotation speed of the second rotation input in the clockwise direction is greater than a threshold value and may gradually decrease the target heating temperature at preset temperature intervals (e.g., 10° C.) when the rotation speed of the second rotation input is less than or equal to the threshold value. An operation in which the heating device 2000 determines the target heating temperature of the cooking device 1000 based on the rotation speed will be described below a little more with reference to FIG. 16.

In operation S640, the heating device 2000 according to an embodiment of the disclosure may control power transmission by the wireless power transmitter 2100 such that the temperature of the content of the cooking device 1000 may reach the target heating temperature.

According to an embodiment of the disclosure, when the target heating temperature of the cooking device 1000 is determined according to a rotation input of rotating the cooking device 1000 by the user, the heating device 2000 may start the power transmission by the wireless power transmitter 2100 in order to heat the content of the cooking device 1000. For example, the heating device 2000 may control the inverter circuit 2113 to apply an AC current to the working coil 2120. In this case, a magnetic field (magnetic force line) may be generated at the working coil 2120, and an eddy current or an induced current may be formed at the cooking device 1000 as the magnetic field (magnetic force line) passes through the bottom of the cooking device 1000 or the receiving coil 1003 of the cooking device 1000. In this case, the content of the cooking device 1000 may start to be heated.

According to an embodiment of the disclosure, the heating device 2000 may receive the temperature information of the content from the cooking device 1000 through short-range wireless communication (e.g., NFC, Bluetooth, or WiFi direct). The temperature information of the content may include information about the current temperature of the content detected by the temperature sensor of the cooking device 1000.

According to an embodiment of the disclosure, the heating device 2000 may determine whether the temperature of the content of the cooking device 1000 has reached the target heating temperature or is higher than or equal to the target heating temperature, based on the temperature information received from the cooking device 1000. The heating device 2000 may stop the power transmission by the wireless power transmitter 2100 when the temperature of the content of the cooking device 1000 is identified as being higher than or equal to the target heating temperature. For example, the heating device 2000 may control the inverter circuit 2113 to stop the supply of the driving current to the working coil 2120.

According to an embodiment of the disclosure, the heating device 2000 may apply the power level differently depending on the temperature value of the target heating temperature of the cooking device 1000. For example, the heating device 2000 may transmit power at a maximum power level (e.g., MAX) when the target heating temperature is 100° C., may transmit power at a medium power level (e.g., level 6 to level 8) when the target heating temperature is 70° C., and may transmit power at a low power level (e.g., level 3 to level 5) when the target heating temperature is 40° C.; however, the disclosure is not limited thereto.

Also, according to an embodiment of the disclosure, the heating device 2000 may initially transmit power at the maximum power level and then decrease the power level as the temperature of the content of the cooking device 1000 approaches the target heating temperature. Also, the heating device 2000 may stop the power transmission when the temperature of the content of the cooking device 1000 reaches the target heating temperature. For example, the heating device 2000 may adjust the power level from the maximum power level to a first power level when the temperature of the content reaches a first temperature lower than the target heating temperature by a first reference value and may adjust the power level from the first power level to a second power level when the temperature of the content reaches a second temperature lower than the target heating temperature by a second reference value. In this case, the first temperature may be lower than the second temperature, and the first level may be higher than the second level. For example, when the target heating temperature is 100° C., the heating device 2000 may initially transmit power at the maximum power level. Also, when the temperature of the content of the cooking device 1000 becomes the first temperature (e.g., 70° C.), the heating device 2000 may decrease the power level by two levels, when the temperature of the content of the cooking device 1000 becomes the second temperature (e.g., 90° C.), the heating device 2000 may further decrease the power level by three levels, and when the temperature of the content of the cooking device 1000 becomes 100° C., the heating device 2000 may stop the power transmission.

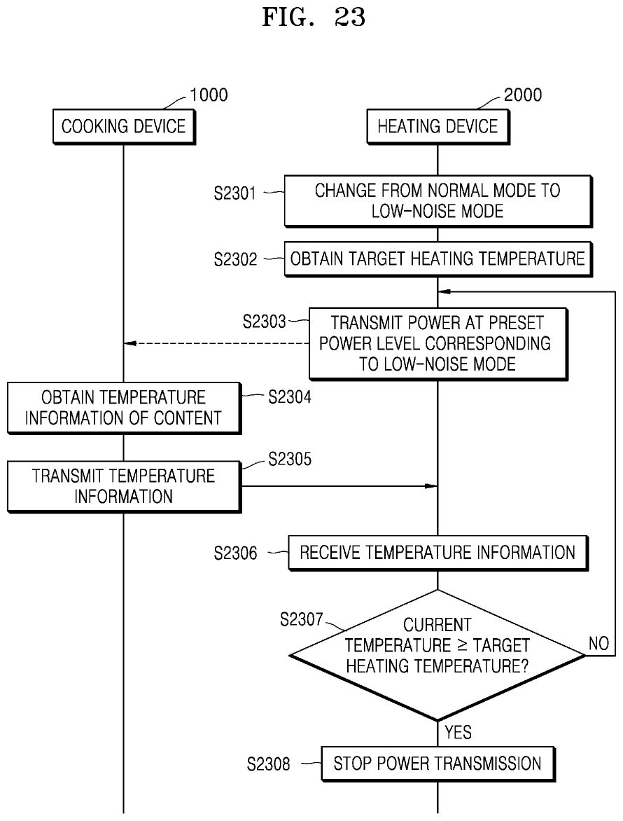

Moreover, according to an embodiment of the disclosure, the heating device 2000 may apply the power level differently depending on the operation mode thereof. For example, the heating device 2000 may transmit power at the maximum power level when the operation mode is the normal mode and may transmit power at a preset power level corresponding to the low-noise mode (e.g., level 3) when the operation mode is the low-noise mode. A case where the operation mode of the heating device 2000 is the low-noise mode will be described below in detail with reference to FIG. 23.

According to an embodiment of the disclosure, the user's convenience may be improved because the user may easily set the target heating temperature by simply rotating the cooking device 1000 the cooking device 1000 without an operation of touching the touch panel of the heating device 2000 or turning the dial thereof after putting the cooking device 1000 on the heating device 2000.

Hereinafter, a method in which the heating device 2000 detects the cooking device 1000 when the user puts the cooking device 1000 on the heating device 2000 will be described in detail with reference to FIGS. 7 and 8.

FIG. 7 is a flowchart for describing a method of detecting a cooking device by using a current sensor, according to an embodiment of the disclosure. In FIG. 7, a case where the current sensor operates as the device detecting sensor 2420 will be described as an example.

In operation S710, the heating device 2000 according to an embodiment of the disclosure may wirelessly transmit power of the first power level at certain periods in order to detect that the cooking device 1000 is placed on the top plate. In this case, the power transmission period may change according to system settings.

According to an embodiment of the disclosure, the power of the first power level may be fine power less than a threshold value (e.g., 100 W). When the cooking device 1000 approaches the heating device 2000, a current value (inductance) of the working coil 2120 may change. Thus, in order detect whether the current value (inductance) of the working coil 2120 changes, the heating device 2000 may control the inverter circuit 2113 such that the power of the first power level for detecting the cooking device 1000 may be output through the working coil 2120 at every predetermined time. For example, the heating device 2000 may control the inverter circuit 2113 such that an AC current corresponding to the power of the first power level may be supplied to the working coil 2120.

In operations S720 and S730, the heating device 2000 according to an embodiment of the disclosure may monitor a current value of the working coil 2120 to detect the cooking device 1000.

According to an embodiment of the disclosure, the heating device 2000 may detect that the cooking device 1000 is located on the top plate of the heating device 2000, based on a change in the current value (inductance) of the working coil 2120 due to the approach of the cooking device 1000.

The inductance of the working coil 2120 when the cooking device 1000 is located on the top plate of the heating device 2000 may be different from the inductance of the working coil 2120 when the cooking device 1000 is not located on the top plate of the heating device 2000. For example, a first inductance when the cooking device 1000 is located on the top plate is greater than a second inductance when the cooking device 1000 is not located on the top plate. The inductance of the working coil 2120 may be proportional to the permeability of a surrounding medium (particularly the center of the coil) because the permeability of the cooking device 1000 is generally greater than the permeability of air.

Also, a first AC current flowing through the working coil 2120 when the cooking device 1000 is located on the top plate is less than an AC current flowing through the working coil 2120 when the cooking device 1000 is not located on the top plate. Thus, by measuring the magnitude of an AC current flowing through the working coil 2120 by using the current sensor and comparing the measured magnitude of the AC current with a reference current magnitude, the heating device 2000 may detect that the cooking device 1000 is located on the top plate of the heating device 2000. For example, when the measured current value is less than a reference current value, the heating device 2000 may determine that the cooking device 1000 is located on the top plate of the heating device 2000.

Moreover, according to another embodiment of the disclosure, the heating device 2000 may detect the cooking device 1000 by measuring the frequency, phase, or the like of the AC current flowing through the working coil 2120.

In operation S740, when detecting that the cooking device 1000 is located on the top plate of the heating device 2000, the heating device 2000 according to an embodiment of the disclosure may wirelessly transmit power of a second power level for driving the PCB 1005 of the cooking device 1000. For example, the heating device 2000 may control the inverter circuit 2113 such that a current corresponding to the power of the second power level may flow through the working coil 2120.

According to an embodiment of the disclosure, the power of the second power level may be greater than the power of the first power level. For example, the power of the second power level may be about 200 W to about 300 W; however, the disclosure is not limited thereto. The power of the first power level and the power of the second power level may be fine power such that a metal object (e.g., a ring worn on a finger) may not be inductively heated even when mistakenly placed on the top plate of the heating device 2000.

According to an embodiment of the disclosure, the cooking device 1000 may receive the power of the second power level from the heating device 2000 through the pickup coil 1001 and supply power to the PCB 1005. In this case, the processor 1010, the communication interface 1030, or the like mounted on the PCB 1005 may be driven.

In operation S750, the heating device 2000 according to an embodiment of the disclosure may receive the identification information of the cooking device 1000 from the cooking device 1000 through short-range wireless communication.

According to an embodiment of the disclosure, the heating device 2000 may receive the identification information broadcast from the cooking device 1000 by using short-range wireless communication (e.g., BLE communication). According to another embodiment of the disclosure, the heating device 2000 may establish a short-range wireless communication channel (e.g., an NFC communication channel, a Bluetooth communication channel, or a WiFi communication channel) with the cooking device 1000 and request the identification information of the cooking device 1000 from the cooking device 1000 through the short-range wireless communication channel. Also, the heating device 2000 may receive the identification information of the cooking device 1000 from the cooking device 1000 as a response to the request.

According to an embodiment of the disclosure, the identification information of the cooking device 1000 may include, but is not limited to, at least one of a MAC address, a model name, device type information (e.g., IH type ID or heater type ID), manufacturer information (e.g., Manufacture ID), or a serial number.

According to an embodiment of the disclosure, when receiving the identification information of the cooking device 1000 from the cooking device 1000, the heating device 2000 may determine, based on the identification information of the cooking device 1000, whether the cooking device 1000 may change the target heating temperature based on the rotation input. For example, based on the device type information included in the identification information of the cooking device 1000, the heating device 2000 may determine whether the cooking device 1000 may change the target heating temperature based on the rotation input.

According to an embodiment of the disclosure, the heating device 2000 may perform operations S620 to S640 of FIG. 6 when receiving the identification information of the cooking device 1000. For example, the heating device 2000 may identify the temperature control mode of the cooking device 1000 corresponding to the identification information of the cooking device 1000. When a rotation input of rotating the cooking device 1000 is detected, the heating device 2000 may obtain the target heating temperature corresponding to the cooking device 1000 based on the rotation displacement according to the rotation input and the temperature control mode of the cooking device 1000. The heating device 2000 may transmit power of a third power level such that the temperature of the content of the cooking device 1000 may reach the target heating temperature. For example, the heating device 2000 may control the inverter circuit 2113 to apply an AC current corresponding to the power of the third power level to the working coil 2120. The third power level may be a certain power level such that the content of the cooking device 1000 may be heated. For example, the power of the third power level may be greater than 800 W; however, the disclosure is not limited thereto.

FIG. 8 is a flowchart for describing a method of detecting a cooking device by using near field communication (NFC), according to an embodiment of the disclosure.

In operation S810, the heating device 2000 according to an embodiment of the disclosure may recognize the NFC tag of the cooking device 1000. NFC may be a contactless wireless communication technology for exchanging data within a short distance of about 10 cm or less by using a frequency of 13.56 MHz band. Thus, when the heating device 2000 recognizes the NFC tag of the cooking device 1000, the heating device 2000 may determine that the cooking device 1000 is located on the top plate of the heating device 2000.

According to an embodiment of the disclosure, previously-negotiated simple information may be stored in the NFC tag of the cooking device 1000 such that the heating device 2000 may recognize the cooking device 1000. For example, the NFC tag may store a serial number indicating that the cooking device 1000 is a product capable of changing the target heating temperature based on the rotation input.

In operation S820, the heating device 2000 according to an embodiment of the disclosure may transmit power of the second power level for driving the PCB 1005 of the cooking device 1000. When detecting that the cooking device 1000 is located on the top plate of the heating device 2000, the heating device 2000 may wirelessly transmit power of the second power level for driving the PCB 1005 of the cooking device 1000, to the pickup coil 1001. For example, the heating device 2000 may control the inverter circuit 2113 such that a current corresponding to the power of the second power level may flow through the working coil 2120.

According to an embodiment of the disclosure, the cooking device 1000 may receive the power of the second power level from the heating device 2000 through the pickup coil 1001 and supply power to the PCB 1005. For example, the pickup coil 1001 may receive wireless power and supply AC power to the SMPS. The SMPS may convert the received AC power into DC power and supply the DC power to the PCB 1005. In this case, the processor 1010, the communication interface 1030, or the like mounted on the PCB 1005 may be driven.

In operation S830, the heating device 2000 according to an embodiment of the disclosure may receive the identification information from the cooking device 1000 through short-range wireless communication.

According to an embodiment of the disclosure, the heating device 2000 may receive the identification information broadcast from the cooking device 1000 by using short-range wireless communication (e.g., BLE communication). According to another embodiment of the disclosure, the heating device 2000 may establish a short-range wireless communication channel (e.g., an NFC communication channel, a Bluetooth communication channel, or a WiFi communication channel) with the cooking device 1000 and request the identification information of the cooking device 1000 from the cooking device 1000 through the short-range wireless communication channel. Also, the heating device 2000 may receive the identification information of the cooking device 1000 from the cooking device 1000 as a response to the request.

Moreover, according to another embodiment of the disclosure, the identification information of the cooking device 1000 may be stored in the NFC tag of the cooking device 1000. In this case, because the heating device 2000 may receive the identification information of the cooking device 1000 by recognizing the NFC tag of the cooking device 1000, operations S820 and S830 may be omitted.

In FIG. 8, a case where the heating device 2000 detects the cooking device 1000 by using the NFC tag has been described as an example; however, the disclosure is not limited thereto. For example, the cooking device 1000 may include a BLE tag or a UWB tag in addition to the NFC tag. In this case, the heating device 2000 may detect the cooking device 1000 by using a BLE communication mode or a UWB communication mode.

According to an embodiment of the disclosure, when the heating device 2000 receives the identification information of the cooking device 1000, the heating device 2000 may identify the temperature control mode corresponding to the identification information of the cooking device 1000. Hereinafter, the temperature control mode will be described in detail with reference to FIG. 9.

FIG. 9 is a diagram for describing a temperature control mode according to an embodiment of the disclosure.

The temperature control mode may be information defining a control mode for setting the target heating temperature of the cooking device 1000. The temperature control mode may be various. For example, the temperature control mode may be defined differently for each cooking device 1000.

According to an embodiment of the disclosure, the temperature control mode may be defined in the memory of each cooking device 1000 when the cooking device 1000 is manufactured. According to another embodiment of the disclosure, a temperature control mode DB including information about mapping at least one cooking device and at least one temperature control mode may be constructed in the server device or the memory 2700 of the heating device 2000. For example, the heating device 2000 or the server device may store a table 900 defining a plurality of temperature control modes.

According to an embodiment of the disclosure, the table 900 may include identification information of a plurality of cooking devices (e.g., a cooking device type 901, a model name 902, and an identification code 903) and Information about a plurality of temperature control modes corresponding to the plurality of cooking devices (e.g., a default temperature 904 and a control mode 905). Also, the information about the plurality of temperature control modes may further include information 906 about whether the plurality of cooking devices provide a warming function; however, the disclosure is not limited thereto. According to an embodiment of the disclosure, a warming temperature may correspond to the target heating temperature, but the warming temperature and the target heating temperature may be set differently. For example, the target heating temperature may be set to 100° C., and the warming temperature may be set to 70° C.

Referring to FIG. 9, a first temperature control mode of a kettle A (identification code: code 1) may include a first default temperature (e.g., 40° C.) and a first control mode (e.g., the target heating temperature increases by 10° C. in the case of a rotation input in the counterclockwise direction, and the target heating temperature decreases by 10° C. in the case of a rotation input in the clockwise direction). In this case, when the user puts the kettle A on the top plate of the heating device 2000, the target heating temperature of the kettle A may be displayed as 40° C. that is a default temperature. Thereafter, the user may adjust the target heating temperature of the kettle A by 10° C. by rotating the kettle A in the counterclockwise or clockwise direction.

A second temperature control mode of a kettle B (identification code: code 2) may include a second default temperature (e.g., 70° C.) and a second control mode (e.g., the target heating temperature is set to 100° C. in the case of a rotation input in the counterclockwise direction, and the target heating temperature decreases by 10° C. in the case of a rotation input in the clockwise direction). In this case, when the user puts the kettle B on the top plate of the heating device 2000, the target heating temperature of the kettle B may be displayed as 70° C. that is a default temperature. Thereafter, when the user rotates the kettle B in the counterclockwise direction, the target heating temperature of the kettle B may change from 70° C. to 100° C., and when the user rotates the kettle B in the clockwise direction, the target heating temperature of the kettle B may gradually decrease to 100° C., 90° C., 80° C. . . . .

A third temperature control mode of a kettle C (identification code: code 3) may include a third default temperature (e.g., 40° C.) and a third control mode (e.g., the target heating temperature sequentially increases among 40° C., 70° C., and 100° C. in the case of a rotation input in the counterclockwise direction, and the target heating temperature sequentially decreases among 100° C., 70° C., and 40° C. in the case of a rotation input in the clockwise direction). In this case, when the user puts the kettle C on the top plate of the heating device 2000, the target heating temperature of the kettle C may be displayed as 40° C. that is a default temperature. Thereafter, the user may set the target heating temperature of the kettle C among 40° C., 70° C., and 100° C. by rotating the kettle C in the counterclockwise or clockwise direction.

A fourth temperature control mode of a kettle D (identification code: code 4) may include a fourth default temperature (e.g., 100° C.) and a fourth control mode (e.g., operating at a default temperature). In this case, when the user puts the kettle D on the top plate of the heating device 2000, the target heating temperature of the kettle D may be displayed as 100° C. that is a default temperature and the heating of the kettle D may be immediately started.

A fifth temperature control mode of a pot A (identification code: code 5) among the cooker devices may include a fifth default temperature (e.g., 100° C.) and a fifth control mode (e.g., operating at a default temperature). In this case, when the user puts the pot A on the top plate of the heating device 2000, the target heating temperature of the pot A may be displayed as 100° C. that is a default temperature and the heating of the pot A may be immediately started.

A sixth temperature control mode of a pot B (identification code: code 6) among the cooker devices may include a sixth default temperature (e.g., 0° C.) and a sixth control mode (e.g., the target heating temperature is set to 100° C. in the case of a rotation input in the counterclockwise direction, and the target heating temperature is set to 0° C. in the case of a rotation input in the clockwise direction). In this case, when the user rotates the pot B in the counterclockwise direction after putting the pot B on the top plate of the heating device 2000, the target heating temperature of the pot B may be set to 100° C., and the power transmission by the heating device 2000 may be immediately started in order to heat the pot B. When the user rotates the pot B in the clockwise direction after the pot B is heated, the target heating temperature of the pot B may change to 0° C., and the power transmission by the heating device 2000 may be immediately stopped because the current temperature of the content of the pot B is higher than the target heating temperature (0° C.). Thus, according to the sixth temperature control mode, the user may simply turn on/off the power of the heating device 2000 by rotating the pot B in the counterclockwise or clockwise direction.

A seventh temperature control mode of a rice cooker C (identification code: code 7) among the cooker devices may include a seventh default temperature (e.g., 100° C.) and a seventh control mode (e.g., operating at a default temperature). In this case, when the user puts the rice cooker C on the top plate of the heating device 2000, the target heating temperature of the rice cooker C may be displayed as 100° C. that is a default temperature and the heating of the rice cooker C may be immediately started. Also, the seventh temperature control mode of the rice cooker C (identification code: code 7) may include information related to a warming function (a warming temperature: 70° C.). In this case, the rice cooker C may be controlled such that the temperature of the rice after cooking may be maintained at 70° C.

According to an embodiment of the disclosure, when the heating device 2000 identifies the temperature control mode of the cooking device 1000, the heating device 2000 may detect a rotation input defined in the temperature control mode of the cooking device 1000 and determine the target heating temperature of the cooking device 1000 according to a rotation displacement according to the rotation input. Hereinafter, an operation in which the heating device 2000 obtains a rotation displacement according to the rotation input will be described in detail with reference to FIGS. 10 to 12.

FIG. 10 is a diagram for describing an operation of obtaining a rotation displacement according to a rotation input by using a rotation detecting sensor, according to an embodiment of the disclosure.

Referring to 1000-1 of FIG. 10, the heating device 2000 may include a rotation detecting sensor 2410, and the cooking device 1000 may include a counterpart 1012 functioning as a sensing reference. The counterpart 1012 may be arranged at a particular position of the cooking device 1000. For example, the counterpart 1012 may be attached to the handle or main body of the cooking device 1000 (e.g., a position adjacent to the bottom surface of the main body).

The rotation detecting sensor 2410 may include various sensors. For example, the rotation detecting sensor 2410 may include at least one of a Hall sensor 2411, a geomagnetic sensor 2412, a touch sensor 2413, or an image sensor 2414; however, the disclosure is not limited thereto. Also, an insulation layer may be arranged between the rotation detecting sensor 2410 and the top plate including tempered glass. The insulation layer may prevent the heat of the inductively-heated cooking device 1000 from being conducted to the rotation detecting sensor 2410.

According to an embodiment of the disclosure, the rotation detecting sensor 2410 of the heating device 2000 may obtain a rotation displacement according to a rotation input to the cooking device 1000 by detecting a change in the counterpart 1012 according to the rotation. For example, a case where the rotation detecting sensor 2410 includes the Hall sensor 2411 or the geomagnetic sensor 2412 and the counterpart 1012 is a magnet will be described. In this case, the rotation detecting sensor 2410 may detect the rotation direction, rotation angle, and rotation speed of the cooking device 1000 based on a change in the magnetic field according to the movement of the magnet. The rotation direction of the cooking device 1000 may be detected based on a phase difference between the outputs of a plurality of rotation detecting sensors 2410. The rotation detecting sensor 2410 may be shielded from the magnetic field generated by the working coil 2120 in order to accurately detect the magnetic field caused by the magnetism of the cooking device 1000.

According to an embodiment of the disclosure, when the rotation detecting sensor 2410 includes the touch sensor 2413, the counterpart 1012 may be an object having a capacitance. In this case, the touch sensor 2413 may be a non-contact touch sensor (e.g., a capacitive proximity sensor). The rotation detecting sensor 2410 including the touch sensor 2413 may detect the rotation direction, rotation angle, and rotation speed of the cooking device 1000 by measuring a change in the capacitance according to the rotation of the cooking device 1000.

According to an embodiment of the disclosure, when the rotation detecting sensor 2410 includes the image sensor 2414, the counterpart 1012 may include an image marker. The rotation detecting sensor 2410 including the image sensor 2414 may detect the rotation direction, rotation angle, and rotation speed of the cooking device 1000 by tracking the image marker included in the counterpart 1012. For example, the heating device 2000 may detect the rotation direction, rotation angle, and rotation speed of the cooking device 1000 by obtaining a plurality of image frames including the image marker through the image sensor 2414 and performing image processing on the plurality of image frames.

Referring to 1000-2 of FIG. 10, the cooking device 1000 may include a rotation detecting sensor 1011, and the heating device 2000 may include a counterpart 1012 functioning as a sensing reference. In this case, the counterpart 1012 may be arranged at a particular position of the heating device 2000. For example, the counterpart 1012 may be attached to a position adjacent to the top plate of the heating device 2000.

Also, the rotation detecting sensor 1011 may be attached to the handle or main body of the cooking device 1000 (e.g., a position adjacent to the bottom surface of the main body). The rotation detecting sensor 1011 may correspond to the rotation detecting sensor 2410 of 1000-1. The rotation detecting sensor 1011 may include various sensors. For example, the rotation detecting sensor 1011 may include a sensor corresponding to at least one of a Hall sensor, a geomagnetic sensor, a touch sensor, or an image sensor; however, the disclosure is not limited thereto. For example, the rotation detecting sensor 1011 may include a gyroscope sensor or an inertia sensor.

When the cooking device 1000 includes the rotation detecting sensor 1011, the cooking device 1000 may transmit, to the heating device 2000, information about a rotation displacement according to the rotation input obtained through the rotation detecting sensor 1011. The heating device 2000 may identify a rotation displacement according to a rotation input to the cooking device 1000 based on the information about the rotation displacement received from the cooking device 1000.

FIG. 11 is a flowchart for describing a method of determining a rotation displacement according to a rotation input based on an impedance variation of a working coil, according to an embodiment of the disclosure. In FIG. 11, a case where the cooking device 1000 is the heater type cooking device 1000b including the receiving coil 1003 will be described as an example.

In operation S1110, the cooking device 1000 according to an embodiment of the disclosure may receive a rotation input from the user. For example, the user may hold the handle of the cooking device 1000 and rotate the cooking device 1000 in the counterclockwise or clockwise direction in order to set the target heating temperature. In this case, the impedance of the working coil (transmitting coil) 2120 of the heating device 2000 may change in operation S1120. For example, when the user places the cooking device 1000 on the top plate of the heating device 2000, the relative position (or the overlapping area or volume) of the working coil (transmitting coil) 2120 and the receiving coil 1003 may be the same as a first image 1101. In this case, when the user rotates the cooking device 1000 in the counterclockwise direction, the relative position (or the overlapping area or volume) of the working coil (transmitting coil) 2120 and the receiving coil 1003 may change as in a second image 1102, and when the user rotates the cooking device 1000 in the clockwise direction, the relative position (or the overlapping area or volume) of the working coil (transmitting coil) 2120 and the receiving coil 1003 may change as in a third image 1103. That is, because the relative position (or the overlapping area or volume) of the receiving coil 1003 and the working coil (transmitting coil) 2120 changes according to the rotation of the cooking device 1000, the impedance of the working coil (transmitting coil) 2120 may change.

According to an embodiment of the disclosure, the receiving coil 1003 and the working coil 2120 may have a concentric circle shape, an elliptical shape, or a polygonal shape; however, the disclosure is not limited thereto. The impedance change according to the rotation may be greater in the case where the receiving coil 1003 and the working coil 2120 are designed in an elliptical shape or a polygonal shape than in the case where they are designed in a concentric circle shape.

In operation S1130, the cooking device 1000 according to an embodiment of the disclosure may detect an impedance variation of the working coil 2120. In operation S1140, the cooking device 1000 according to an embodiment of the disclosure may transmit information about the impedance variation of the working coil 2120 to the heating device 2000. According to an embodiment of the disclosure, the cooking device 1000 may transmit the information about the impedance variation to the heating device 2000 by using short-range wireless communication (e.g., Bluetooth).

In operation S1150, the heating device 2000 according to an embodiment of the disclosure may determine a rotation displacement according to the rotation input based on the information about the impedance variation received from the cooking device 1000. For example, the heating device 2000 may determine at least one of whether a rotation input occurs, a rotation direction, a rotation speed, or a rotation angle.

In operation S1160, the heating device 2000 according to an embodiment of the disclosure may determine the target heating temperature of the cooking device 1000 based on the rotation displacement according to the rotation input and the temperature control mode of the cooking device 1000. Because operation S1160 corresponds to operation S630 of FIG. 6, redundant descriptions thereof will be omitted.

FIG. 12 is a flowchart for describing a method of determining a rotation displacement according to a rotation input based on an impedance variation of a receiving coil, according to an embodiment of the disclosure. In FIG. 12, a case where the cooking device 1000 is the heater type cooking device 1000b including the receiving coil 1003 will be described as an example.

In operation S1210, the cooking device 1000 according to an embodiment of the disclosure may receive a rotation input from the user. For example, the user may hold the handle of the cooking device 1000 and rotate the cooking device 1000 in the counterclockwise or clockwise direction in order to set the target heating temperature. In this case, the impedance of the receiving coil 1003 of the heating device 1000 may change in operation S1220. For example, when the cooking device 1000 rotates, because the relative position (or the overlapping area or volume) of the receiving coil 1003 and the working coil 2120 changes, the impedance of the receiving coil 1003 may change.

In operation S1230, the heating device 2000 according to an embodiment of the disclosure may detect an impedance variation of the receiving coil 1003. In operation S1240, the heating device 2000 according to an embodiment of the disclosure may determine a rotation displacement according to the rotation input based on the impedance variation of the receiving coil 1003. For example, the heating device 2000 may determine at least one of whether a rotation input occurs, a rotation direction, a rotation speed, or a rotation angle.

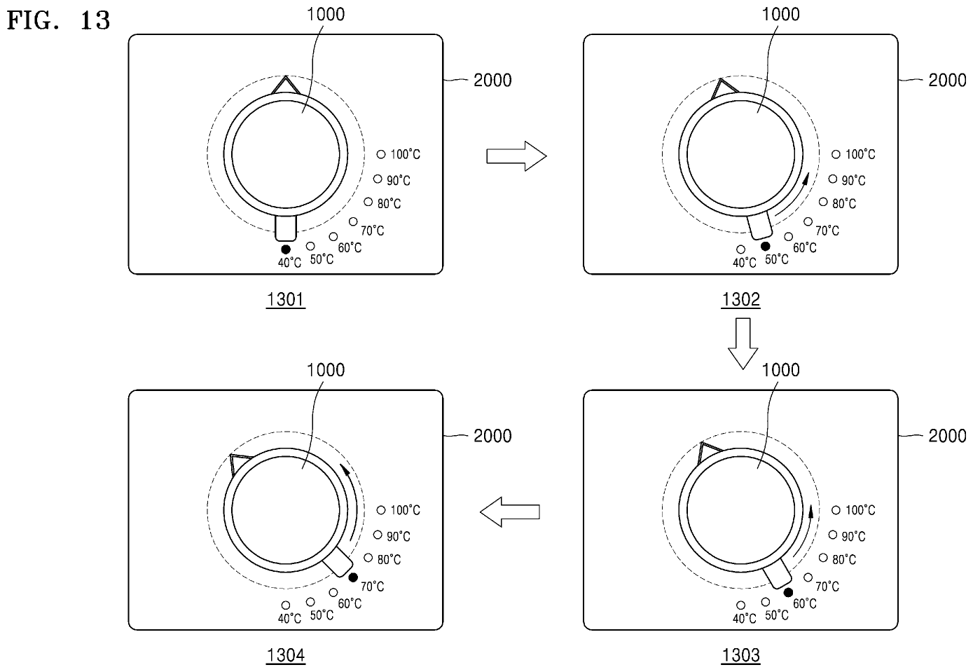

In operation S1250, the heating device 2000 according to an embodiment of the disclosure may determine the target heating temperature of the cooking device 1000 based on the rotation displacement according to the rotation input and the temperature control mode of the cooking device 1000. Because operation S1250 corresponds to operation S630 of FIG. 6, redundant descriptions thereof will be omitted. Hereinafter, an operation in which the heating device 2000 changes the target heating temperature of the cooking device 1000 according to the user's rotation input will be described in detail with reference to FIGS. 13 to 16.

FIG. 13 is a diagram for describing an operation of changing a target heating temperature based on a rotation input in a counterclockwise direction, according to an embodiment of the disclosure.

In FIG. 13, a case where the default temperature of the cooking device 1000 is defined as “40° C.” and the control mode of the cooking device 1000 is defined as “the target heating temperature increases by 10° C. in the case of a rotation input in the counterclockwise direction and the target heating temperature decreases by 10° C. in the case of a rotation input in the clockwise direction” will be described as an example.

According to an embodiment of the disclosure, a certain rotation angle (e.g., 15°) may be defined in the control mode of the cooking device 1000. In this case, the target heating temperature may change when it changes by the certain rotation angle. According to an embodiment of the disclosure, when a certain rotation angle is not defined in the control mode of the cooking device 1000, the target heating temperature may change by the number of rotations.

Referring to 1301 of FIG. 13, the user may place the cooking device 1000 on the top plate of the heating device 2000 such that the handle of the cooking device 1000 may face in the 6 o'clock direction. In this case, the target heating temperature at the position where the handle of the cooking device 1000 faces in the 6 o'clock direction may be determined as 40° C. that is a default temperature. Thus, when the user puts the cooking device 1000 on the heating device 2000 and does not rotate the cooking device 1000 for a certain time or presses a power button attached to the heating device 2000 or the cooking device 1000, the heating device 2000 may control the wireless power transmitter 2100 to transmit power to the cooking device 1000 until the temperature of the content of the cooking device 1000 reaches 40° C. that is the target heating temperature.

Referring to 1302 of FIG. 13, when the user rotates the cooking device 1000 in the counterclockwise direction (e.g., rotated by a certain rotation angle of 15°) after placing the cooking device 1000 on the top plate of the heating device 2000, the heating device 2000 may determine 50° C., which is higher by 10° C. than the default temperature (40° C.), as a target heating temperature. In this case, the handle of the cooking device 1000 may be located in the 5:30 direction.

Referring to 1303 of FIG. 13, when the user rotates the cooking device 1000 a little further in the counterclockwise direction (e.g., further rotated by a certain rotation angle of 15°), the heating device 2000 may determine 60° C., which is higher by 10° C. than 50° C., as a target heating temperature. In this case, the handle of the cooking device 1000 may be located in the 5 o'clock direction.

Referring to 1304 of FIG. 13, when the user rotates the cooking device 1000 a little further in the counterclockwise direction (e.g., further rotated by a certain rotation angle of 15°), the heating device 2000 may determine 70° C., which is higher by 10° C. than 60° C., as a target heating temperature. In this case, the handle of the cooking device 1000 may be located in the 4:30 direction.

When the user does not rotate the cooking device 1000 any more for a certain time or presses the power button attached to the heating device 2000 or the cooking device 1000 after setting the target heating temperature to 70° C., the heating device 2000 may transmit power to the cooking device 1000 until the temperature of the content of the 1000 reaches the target heating temperature of 70° C.

Moreover, although not illustrated in FIG. 13, according to an embodiment of the disclosure, when the user rotates the cooking device 1000 a little further in the counterclockwise direction (e.g., further rotated by a certain rotation angle of 15°) while the heating device 2000 transmits power to the cooking device 1000, the heating device 2000 may change the target heating temperature to 80° C. that is higher by 10° C. than 70° C. Also, according to an embodiment of the disclosure, when the user rotates the cooking device 1000 in the clockwise direction after setting the target heating temperature to 80° C., the heating device 2000 may determine the target heating temperature to 70° C. that is lower by 10° C. than 80° C.

Thus, according to an embodiment of the disclosure, the user may easily increase or decrease the target heating temperature by rotating the cooking device 100 in the counterclockwise or clockwise direction with the cooking device 1000 put on the top plate of the heating device 2000.

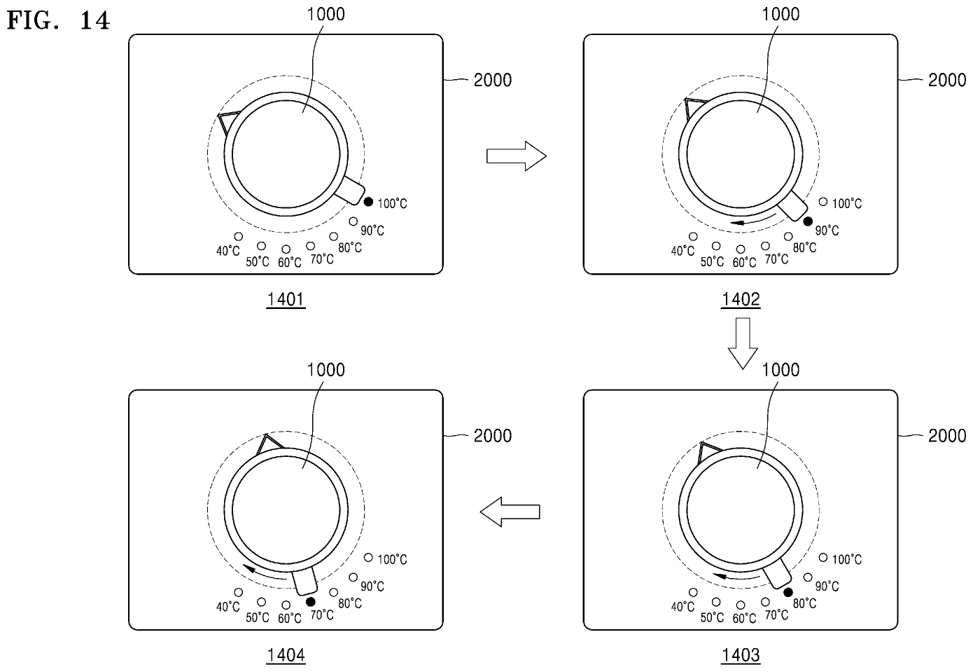

FIG. 14 is a diagram for describing an operation of changing a target heating temperature based on a rotation input in a clockwise direction, according to an embodiment of the disclosure.

In FIG. 14, a case where the default temperature of the cooking device 1000 is defined as “100° C.” and the control mode of the cooking device 1000 is defined as “the target heating temperature decreases by 10° C. in the case of a rotation input in the clockwise direction and the target heating temperature increases by 10° C. in the case of a rotation input in the counterclockwise direction” will be described as an example.

According to an embodiment of the disclosure, a certain rotation angle (e.g., 15°) may be defined in the control mode of the cooking device 1000. In this case, the target heating temperature may change when it changes by the certain rotation angle. According to an embodiment of the disclosure, when a certain rotation angle is not defined in the control mode of the cooking device 1000, the target heating temperature may change by the number of rotations.

Referring to 1401 of FIG. 14, the user may place the cooking device 1000 on the top plate of the heating device 2000 such that the handle of the cooking device 1000 may face in the 4 o'clock direction. In this case, the target heating temperature at the position where the handle of the cooking device 1000 faces in the 4 o'clock direction may be determined as 100° C. that is a default temperature. Thus, when the user puts the cooking device 1000 on the heating device 2000 and does not rotate the cooking device 1000 for a certain time or presses a power button attached to the heating device 2000 or the cooking device 1000, the heating device 2000 may control the wireless power transmitter 2100 to transmit power to the cooking device 1000 until the temperature of the content of the cooking device 1000 reaches 100° C. that is the target heating temperature. Referring to 1402 of FIG. 14, when the user rotates the cooking device 1000 in the clockwise direction (e.g., rotated by a certain rotation angle of 15°) after placing the cooking device 1000 on the top plate of the heating device 2000, the heating device 2000 may determine 90° C., which is lower by 10° C. than the default temperature (100° C.), as a target heating temperature. In this case, the handle of the cooking device 1000 may be located in the 4:30 direction.

Referring to 1403 of FIG. 14, when the user rotates the cooking device 1000 a little further in the clockwise direction (e.g., further rotated by a certain rotation angle of 15°), the heating device 2000 may determine 80° C., which is lower by 10° C. than 90° C., as a target heating temperature. In this case, the handle of the cooking device 1000 may be located in the 5 o'clock direction.

Referring to 1404 of FIG. 14, when the user rotates the cooking device 1000 a little further in the clockwise direction (e.g., further rotated by a certain rotation angle of 15°), the heating device 2000 may determine 70° C., which is lower by 10° C. than 80° C., as a target heating temperature. In this case, the handle of the cooking device 1000 may be located in the 5:30 direction.

When the user does not rotate the cooking device 1000 any more for a certain time or presses the power button attached to the heating device 2000 or the cooking device 1000 after setting the target heating temperature to 70° C., the heating device 2000 may transmit power to the cooking device 1000 until the temperature of the content of the 1000 reaches the target heating temperature of 70° C.

Moreover, although not illustrated in FIG. 14, according to an embodiment of the disclosure, when the user rotates the cooking device 1000 a little further in the clockwise direction (e.g., further rotated by a certain rotation angle of 15°) while the heating device 2000 transmits power to the cooking device 1000, the heating device 2000 may change the target heating temperature to 60° C. that is lower by 10° C. than 70° C. Also, according to an embodiment of the disclosure, when the user rotates the cooking device 1000 in the counterclockwise direction after setting the target heating temperature to 60° C., the heating device 2000 may determine the target heating temperature to 70° C. that is higher by 10° C. than 60° C.

Thus, according to an embodiment of the disclosure, the user may easily decrease or increase the target heating temperature by rotating the cooking device 100 with the cooking device 1000 put on the top plate of the heating device 2000.

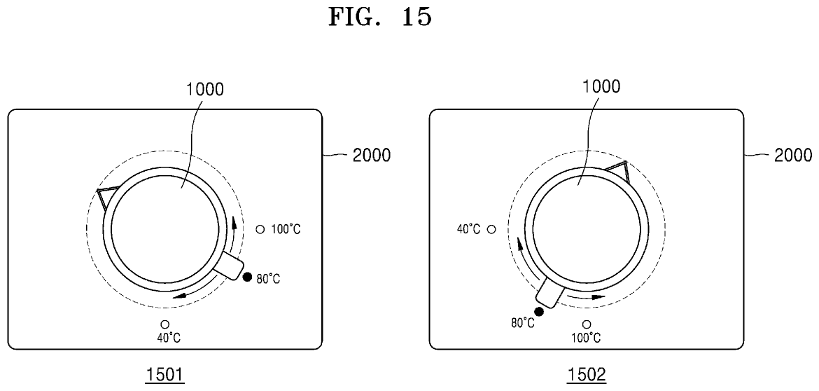

FIG. 15 is a diagram for describing an operation of determining a target heating temperature among a plurality of preset temperatures, according to an embodiment of the disclosure.

In FIG. 15, a case where the default temperature of the cooking device 1000 is defined as “80° C.” and the control mode of the cooking device 1000 is defined as “the target heating temperature sequentially increases among 40° C., 80° C., and 100° C. in the case of a rotation input in the counterclockwise direction and the target heating temperature sequentially decreases among 100° C., 80° C., and 40° C. in the case of a rotation input in the clockwise direction” will be described as an example.

Referring to 1501 of FIG. 15, the user may hold the handle of the cooking device 1000 with his right hand and put the cooking device 1000 on the top plate of the heating device 2000 such that the handle of the cooking device 1000 may face in the 4 o'clock direction. In this case, the target heating temperature at the position where the handle of the cooking device 1000 faces in the 4 o'clock direction may be determined as 80° C. that is a default temperature.

Referring to 1502 of FIG. 15, the user may hold the handle of the cooking device 1000 with his left hand and put the cooking device 1000 on the top plate of the heating device 2000 such that the handle of the cooking device 1000 may face in the 7 o'clock direction. In this case, the target heating temperature at the position where the handle of the cooking device 1000 faces in the 7 o'clock direction may be determined as 80° C. that is a default temperature.

Thus, according to an embodiment of the disclosure, the initial position of the cooking device 1000 placed on the top plate of the heating device 2000 may be a reference position, and the target heating temperature at the reference position may be a default temperature.

According to an embodiment of the disclosure, when the user puts the cooking device 1000 on the heating device 2000 and does not rotate the cooking device 1000 for a certain time or presses the power button attached to the heating device 2000 or the cooking device 1000, the heating device 2000 may control the wireless power transmitter 2100 to transmit power to the cooking device 1000 until the temperature of the content of the cooking device 1000 reaches 80° C. that is the target heating temperature.

Moreover, when the user rotates the cooking device 1000 in the clockwise direction after placing the cooking device 1000 on the top plate of the heating device 2000, the heating device 2000 may change the target heating temperature from 80° C. to 40° C. When the user rotates the cooking device 1000 in the counterclockwise direction after placing the cooking device 1000 on the top plate of the heating device 2000, the heating device 2000 may change the target heating temperature from 80° C. to 100° C.

Thus, according to an embodiment of the disclosure, the user may select a target heating temperature among frequently-used temperatures by predefining the frequently used temperatures and rotating the cooking device 1000.

FIG. 16 is a diagram for describing an operation of determining a target heating temperature based on a speed of a rotation input, according to an embodiment of the disclosure.

In FIG. 16, a case where the default temperature of the cooking device 1000 is defined as “40° C.” and the control mode of the cooking device 1000 is defined as “the target heating temperature is set to 100° C. when a rotation input in the counterclockwise direction is faster than a threshold speed and the target heating temperature increases by 10° C. when a rotation input in the counterclockwise direction is slower than a threshold speed” will be described as an example.

Referring to 1610 of FIG. 16, when the user puts the cooking device 1000 on the heating device 2000 and slowly rotates the cooking device 1000 at a first speed lower than a threshold speed, the heating device 2000 may gradually increase the target heating temperature by 10° C. from the default temperature of 40° C.

Referring to 1620 of FIG. 16, when the user puts the cooking device 1000 on the heating device 2000 and fast rotates the cooking device 1000 at a second speed higher than a threshold speed, the heating device 2000 may determine the target heating temperature as 100° C.

Thus, according to an embodiment of the disclosure, the user may quickly set the target heating temperature by adjusting the rotation speed of the cooking device 1000. Moreover, the heating device 2000 may output the target heating temperature determined based on the user's rotation input to the cooking device 1000, through the display unit 2510. An operation in which the heating device 2000 outputs the target heating temperature will be described with reference to FIGS. 17 to 19.

FIG. 17 is a diagram for describing an operation of displaying a target heating temperature and identification information of a cooking device, according to an embodiment of the disclosure.

According to an embodiment of the disclosure, when the user places the cooking device 1000 on the heating device 2000, the heating device 2000 may display identification information of a cooking zone in which the cooking device 1000 is located, the identification information of the cooking device 1000, the target heating temperature corresponding to the cooking device 1000, or the like may be displayed on the display unit 2510; however, the disclosure is not limited thereto. For example, the heating device 2000 may display the current temperature of the content, the temperature change situation of the content, or the like on the display unit 2510.

Referring to 1710 of FIG. 17, when the user puts the kettle A on the heating device 2000, the heating device 2000 may receive identification information of the kettle A (e.g., an identification code of the kettle A) from the kettle A and display the identification information of the kettle A (e.g., a model name or an identification image matched to the identification code) on the display unit 2510. For example, the heating device 2000 may display a kettle image and an electric pot, which is the model name, on the display unit 2510. Also, when the kettle A is placed in a first zone among the cooking zones of the heating device 2000, the heating device 2000 may display the position of the cooking zone (e.g., Induction stove 1) on the display unit 2510. Moreover, the heating device 2000 may display, on the display unit 2510, the target heating temperature (e.g., 40° C., warm water) determined based on the rotation input to the kettle A.

Referring to 1720 of FIG. 17, when the user places the kettle B on the heating device 2000, the heating device 2000 may display, on the display unit 2510, the position of the cooking zone at which the kettle B is placed (e.g., Induction stove 2), the identification image of the kettle B (e.g., kettle icon), the model name of the kettle B (e.g., electric pot), and the default temperature of the kettle B (e.g., 100° C., boiling water). When the user rotates the kettle B in the clockwise direction to adjust the target heating temperature to 80° C., the display unit 2510 may display the target heating temperature (e.g., 80° C.) instead of the default temperature (e.g., 100° C.).

Referring to 1730 of FIG. 17, when the user places the kettle C on the heating device 2000, the heating device 2000 may display, on the display unit 2510, the position of the cooking zone at which the kettle C is placed (e.g., Induction stove 1), the identification image of the kettle C (e.g., kettle icon), the model name of the kettle C (e.g., electric pot), and the default temperature of the kettle C (e.g., 80° C., green tea). When the user rotates the kettle C in the counterclockwise direction to adjust the target heating temperature to 100° C., the display unit 2510 may display the target heating temperature (e.g., 100° C.) of the kettle C instead of the default temperature (e.g., 80° C.).

Referring to 1740 of FIG. 17, when the user places a pot D on the heating device 2000, the heating device 2000 may display, on the display unit 2510, the position of the cooking zone at which the pot D is placed (e.g., Induction stove 2), the identification image of the pot D (e.g., pot icon), the model name of the pot D (e.g., pot), and the default temperature of the pot D (e.g., 100° C., boiling water). When the user rotates the pot D in the clockwise direction to adjust the target heating temperature to 70° C., the display unit 2510 may display the target heating temperature (e.g., 70° C.) instead of the default temperature (e.g., 100° C.).

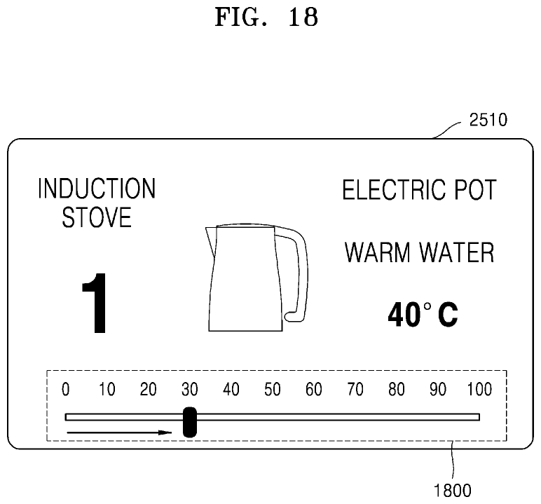

FIG. 18 is a diagram for describing an operation of displaying temperature change situation information of a cooking device, according to an embodiment of the disclosure.

According to an embodiment of the disclosure, when the heating device 2000 receives the temperature information of the content from the cooking device 1000, the heating device 2000 may output the temperature change situation of the content on the display unit 2510.

For example, the heating device 2000 may display the temperature change situation of the content of the cooking device 1000 by displaying the current temperature of the content on a slide bar 1800. When the heating device 2000 performs power transmission, because the current temperature of the content of the cooking device 1000 continues to increase, a marker representing the current temperature on a slide bar may move to the right. In FIG. 18, an example in which the heating device 2000 displays the temperature change situation of the content by using the slide bar 1800 has been described; however, the disclosure is not limited thereto. The heating device 2000 may display the temperature change situation by using an LED bar or may display the temperature change situation by changing color.

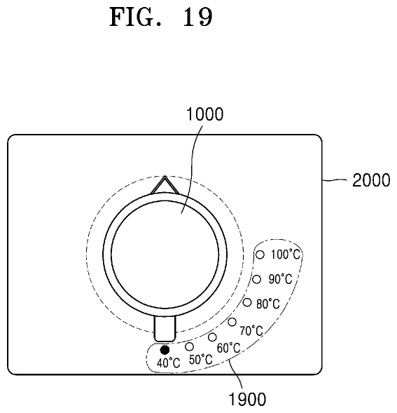

FIG. 19 is a diagram for describing an operation of displaying a target heating temperature by using a light emitting diode (LED) lamp, according to an embodiment of the disclosure.

According to an embodiment of the disclosure, a plurality of LED lamps 1900 may be arranged at the top plate of the heating device 2000. The plurality of LED lamps 1900 may be arranged outside the cooking zone so as not to be covered by the cooking device 1000. Also, a plurality of temperatures may be printed on a region adjacent to the plurality of LED lamps 1900. In this case, the heating device 2000 may display the target heating temperature by using the plurality of LED lamps 1900.

For example, when the user puts the cooking device 1000 on the top plate of the heating device 2000, the heating device 2000 may flicker a first LED lamp corresponding to the default temperature (40° C.). When the user rotates the cooking device 1000 in the counterclockwise direction to change the target heating temperature from 40° C. to 70° C., the heating device 2000 may flicker a fourth LED lamp corresponding to 70° C., and when the user rotates the cooking device 1000 a little further in the counterclockwise direction to change the target heating temperature to 100° C., the heating device 2000 may flicker a seventh LED lamp corresponding to 100° C.

According to another embodiment of the disclosure, the heating device 2000 may flicker LED lamps of different colors depending on different target heating temperatures. For example, the heating device 2000 may flicker a green LED lamp when the target heating temperature is 40° C., flicker an orange LED lamp when the target heating temperature is 70° C., and flicker a red LED lamp when the target heating temperature is 100° C.

Moreover, according to an embodiment of the disclosure, when the target heating temperature is changed based on the rotation input, the heating device 2000 may output the changed target heating temperature by voice.

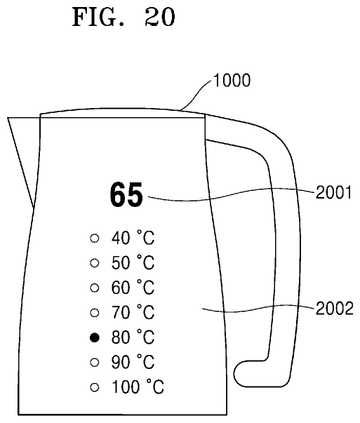

FIG. 20 is a diagram for describing an operation of displaying a target heating temperature through an output interface of a cooking device, according to an embodiment of the disclosure.

According to an embodiment of the disclosure, the cooking device 1000 may output at least one of the target heating temperature or the current temperature of the content through the output interface 1040; however, the disclosure is not limited thereto.

Referring to FIG. 20, the cooking device 1000 may display the current temperature of the content by using an LED. For example, the cooking device 1000 may monitor the current temperature of the content by using a temperature sensor and display the current temperature (e.g., 65° C.) of the content by using a 7-segment display device 2001.

Also, the cooking device 1000 may display the target heating temperature by using a plurality of LED lamps. A plurality of LED lamps 2002 may be arranged at an outer surface of the cooking device 1000. A plurality of temperatures may be printed on a region adjacent to the plurality of LED lamps 2002. In this case, the cooking device 1000 may display the target heating temperature by using the plurality of LED lamps 2002. For example, when the user puts the cooking device 1000 on the top plate of the heating device 2000, the cooking device 1000 may flicker a fifth LED lamp corresponding to the default temperature (80° C.). When the user rotates the cooking device 1000 in the counterclockwise direction to change the target heating temperature from 80° C. to 100° C., the cooking device 1000 may flicker a seventh LED lamp corresponding to 100° C.

Moreover, when the cooking device 1000 includes a display unit including an LCD, the cooking device 1000 may display at least one of the target heating temperature or the current temperature of the content on the display unit.

According to an embodiment of the disclosure, when the rotation detecting sensor 1011 (see 1000-2 of FIG. 10) is included in the cooking device 1000, the cooking device 1000 may determine a rotation displacement according to the rotation input by using the rotation detecting sensor 1011 and determine a target heating temperature according to the rotation displacement. Also, the cooking device 1000 may display the determined target heating temperature through the output interface 1040. On the other hand, when the rotation detecting sensor 2410 (see 1000-1 of FIG. 10) is included in the heating device 2000, the cooking device 1000 may receive information about the target heating temperature from the heating device 2000 and display the same.

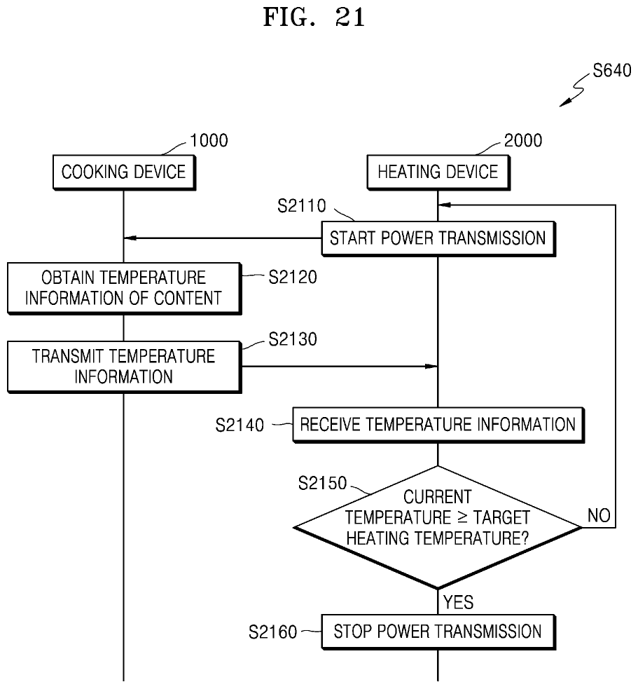

Hereinafter, an operation in which the heating device 2000 controls power transmission (magnetic field generation) by the wireless power transmitter 2100 such that the temperature of the content of the cooking device 1000 may reach the target heating temperature when the target heating temperature of the cooking device 1000 is set will be described in detail with reference to FIGS. 21 to 23.

FIG. 21 is a flowchart for describing a method of controlling power transmission by a wireless power transmitter, according to an embodiment of the disclosure.

In operation S2110, when the target heating temperature corresponding to the cooking device 1000 is set, the heating device 2000 according to an embodiment of the disclosure may start power transmission. For example, when the user determines the target heating temperature by rotating the cooking device 1000, the heating device 2000 may start power transmission to the cooking device 1000 such that the temperature of the content of the cooking device 1000 may reach the target heating temperature. That is, the heating device 2000 may control the inverter circuit 2113 to apply an AC current to the working coil 2120. In this case, a magnetic field (magnetic force line) may be generated at the working coil 2120, and an eddy current or an induced current may be formed at the cooking device 1000 as the magnetic field (magnetic force line) passes through the bottom of the cooking device 1000 or the receiving coil 1003 of the cooking device 1000.

In operation S2120, the cooking device 1000 according to an embodiment of the disclosure may obtain temperature information of the content by monitoring the temperature of the content by using the temperature sensor. For example, when heating is started (when power is received from the heating device 2000), the cooking device 1000 may monitor the temperature of the content. According to an embodiment of the disclosure, the cooking device 1000 may monitor the temperature of the content at certain periods. When the content is heated by receiving power from the heating device 2000, the temperature of the content may gradually increase.

In operation S2130, the cooking device 1000 according to an embodiment of the disclosure may transmit the temperature information of the content to the heating device 2000. For example, the cooking device 1000 may transmit the temperature information of the content of the cooking device 1000 to the heating device 2000 by using short-range wireless communication (e.g., Bluetooth, NFC, or WiFi Direct). According to an embodiment of the disclosure, the cooking device 1000 may monitor the temperature information of the content at certain periods.

In operation S2140, the heating device 2000 may receive the temperature information of the content from the cooking device 1000.

In operation S2150, based on the temperature information of the content received from the cooking device 1000, the heating device 2000 may determine whether the current temperature of the content has reached the target heating temperature or is higher than or equal to the target heating temperature. When the current temperature of the content does not reach the target heating temperature, the heating device 2000 may maintain the power transmission (magnetic field generation) by the wireless power transmitter 2100 and continue to monitor the current temperature of the content.

In operation S2160, the heating device 2000 may stop the power transmission by the wireless power transmitter 2100 when the temperature of the content of the cooking device 1000 is identified as being higher than or equal to the target heating temperature. For example, the heating device 2000 may control the inverter circuit 2113 to stop the supply of the driving current to the working coil 2120.

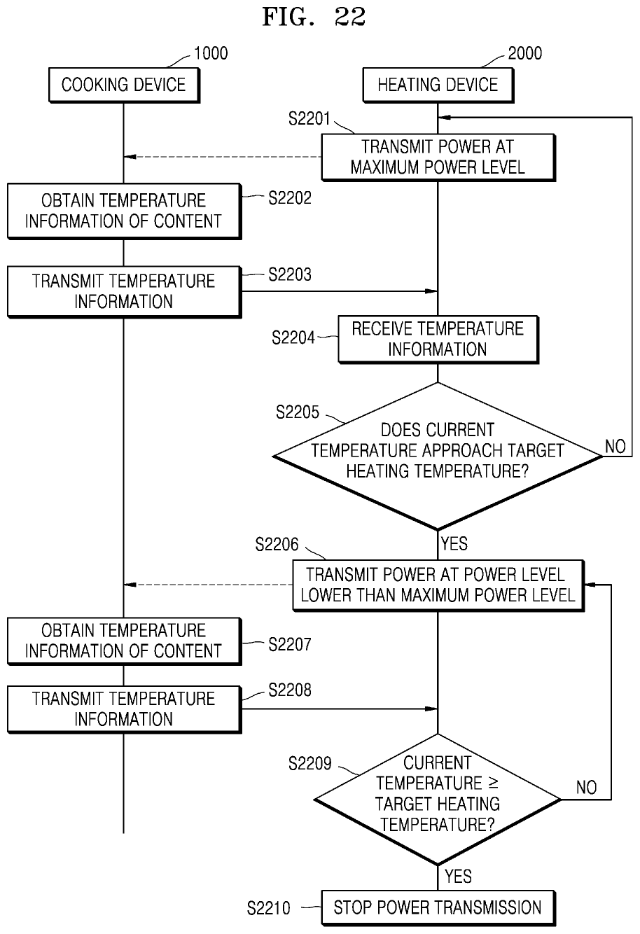

Moreover, according to an embodiment of the disclosure, the heating device 2000 may initially transmit power at the maximum power level and then decrease the power level as the temperature of the content of the cooking device 1000 approaches the target heating temperature. An operation in which the heating device 2000 adjusts the power level will be described in detail with reference to FIG. 22.

FIG. 22 is a flowchart for describing a method of adjusting a power level of a wireless power transmitter, according to an embodiment of the disclosure.

In operation S2201, when the target heating temperature corresponding to the cooking device 1000 is set, the heating device 2000 according to an embodiment of the disclosure may start power transmission at the maximum power level. For example, when the user determines the target heating temperature by rotating the cooking device 1000, the heating device 2000 may start power transmission to the cooking device 1000 such that the temperature of the content of the cooking device 1000 may reach the target heating temperature. In this case, the heating device 2000 may control the inverter circuit 2113 such that an AC current of a level corresponding to the maximum power level may be applied to the working coil 2120.

The power level may be defined by discretely dividing the strength of a magnetic field generated by the working coil 2120. Because the strength of the magnetic field corresponds to the strength of the current applied to the working coil 2120, the power level may be defined by discretely dividing the strength of the current applied to the working coil 2120. The power level may be divided into a plurality of levels. For example, the power level may be divided into levels 1 to 7 or levels 1 to 9; however, the disclosure is not limited thereto. Moreover, the maximum power level may be the highest level among the power levels. As the power level increases, the working coil 2120 may generate a relatively greater magnetic field, and the cooking device 1000 may be more rapidly heated.

In operation S2202, the cooking device 1000 according to an embodiment of the disclosure may obtain temperature information of the content by monitoring the temperature of the content by using the temperature sensor. For example, when heating is started (when power is received from the heating device 2000), the cooking device 1000 may monitor the temperature of the content. According to an embodiment of the disclosure, the cooking device 1000 may monitor the temperature of the content at certain periods. When the content is heated by receiving power from the heating device 2000, the temperature of the content may gradually increase.

In operation S2203, the cooking device 1000 according to an embodiment of the disclosure may transmit the temperature information of the content to the heating device 2000. For example, the cooking device 1000 may transmit the temperature information of the content of the cooking device 1000 to the heating device 2000 by using short-range wireless communication (e.g., Bluetooth, NFC, or WiFi Direct). According to an embodiment of the disclosure, the cooking device 1000 may monitor the temperature information of the content at certain periods.

In operation S2204, the heating device 2000 may receive the temperature information of the content from the cooking device 1000. In operation S2205, based on the temperature information of the content received from the cooking device 1000, the heating device 2000 may determine whether the current temperature of the content has reached the target heating temperature. For example, the heating device 2000 may determine whether the difference between the current temperature of the content and the target heating temperature is within a threshold temperature (e.g., 5° C.). When the current temperature of the content does not approach the target heating temperature, the heating device 2000 may maintain the maximum power level and continue to monitor the current temperature of the content.

In operation S2206, the heating device 2000 according to an embodiment of the disclosure may change the power level of the heating device 2000 to a power level lower than the maximum power level when the current temperature of the content approaches the target heating temperature. For example, the heating device 2000 may change from the maximum power level to a medium power level (e.g., levels 6 to 8) or a low power level (e.g., levels 3 to 5). In this case, the heating device 2000 may control the inverter circuit 2113 such that an AC current of a level corresponding to the changed power level may be supplied to the working coil 2120.

In operation S2207, the cooking device 1000 may obtain temperature information of the content by using the temperature sensor while power of the changed power level is supplied. The temperature increase rate of the content may be lower when power of the changed power level is supplied than when power of the maximum power level is supplied.

In operation S2208, the cooking device 1000 may transmit the temperature information to the heating device 2000 by using short-range wireless communication (e.g., Bluetooth, NFC, or WiFi Direct).

In operation S2209, based on the temperature information of the content received from the cooking device 1000, the heating device 2000 may determine whether the current temperature of the content has reached the target heating temperature (or is higher than or equal to the target heating temperature). When the current temperature of the content does not reach the target heating temperature, the heating device 2000 may maintain the power transmission (magnetic field generation) at the changed power level and continue to monitor the current temperature of the content.

In operation S2210, the heating device 2000 may stop the power transmission by the wireless power transmitter 2100 when the temperature of the content of the cooking device 1000 is identified as being higher than or equal to the target heating temperature. For example, the heating device 2000 may control the inverter circuit 2113 to stop the supply of a current to the working coil 2120.

Moreover, according to an embodiment of the disclosure, the heating device 2000 may decrease the temperature increase rate of the content of the cooking device 1000 by gradually decreasing the power level as the temperature of the content approaches the target heating temperature while power is transmitted (output) at the maximum power level. In this case, the heating device 2000 may adjust the power level several times before the temperature of the content reaches the target heating temperature.

FIG. 23 is a flowchart for describing a method of controlling power transmission by a wireless power transmitter in a low-noise mode, according to an embodiment of the disclosure.

In operation S2301, the heating device 2000 according to an embodiment of the disclosure may change the operation mode from the normal mode to the low-noise mode. The low-noise mode may be a mode for reducing the level of a noise caused by the heating device 2000 and may be a mode for operating at a preset power level lower than the maximum power level.

According to an embodiment of the disclosure, the heating device 2000 may change the operation mode to the low-noise mode based on the user input. For example, the user may set the low-noise mode by using the user interface 2600 of the heating device 2000. According to another embodiment of the disclosure, the heating device 2000 may operate in the operation mode corresponding to the identification information of the cooking device 1000 stored in the memory 2700. For example, when the operation mode corresponding to the identification information of the cooking device 1000 placed on the top plate of the heating device 2000 is preset to the low-noise mode, the heating device 2000 may change the operation mode to the low-noise mode.

In operation S2302, the heating device 2000 according to an embodiment of the disclosure may obtain the target heating temperature of the cooking device 1000 based on the temperature control mode of the cooking device 1000 and the rotation displacement according to the rotation input to the cooking device 1000. Because operation S2302 corresponds to operation S630 of FIG. 6, redundant descriptions thereof will be omitted.

In operation S2303, when the target heating temperature of the cooking device 1000 is obtained, the heating device 2000 according to an embodiment of the disclosure may perform power transmission at a preset power level corresponding to the low-noise mode. For example, when the preset power level corresponding to the low-noise mode is level 5, the heating device 2000 may control the wireless power transmitter 2100 to transmit power at the power level of level 5. For example, the heating device 2000 may control the inverter circuit 2113 such that an AC current of a level corresponding to the power level of level 5 may be supplied to the working coil 2120.

In operation S2304, the cooking device 1000 according to an embodiment of the disclosure may obtain temperature information of the content. For example, when heating is started (when power is received from the heating device 2000), the cooking device 1000 may monitor the temperature of the content. According to an embodiment of the disclosure, the cooking device 1000 may obtain the temperature information of the content by monitoring the temperature of the content at certain periods. When the content is heated by receiving power from the heating device 2000, the temperature of the content may gradually increase.

In operation S2305, the cooking device 1000 according to an embodiment of the disclosure may transmit the temperature information of the content to the heating device 2000. For example, the cooking device 1000 may transmit the temperature information of the content of the cooking device 1000 to the heating device 2000 by using short-range wireless communication (e.g., Bluetooth, NFC, or WiFi Direct). According to an embodiment of the disclosure, the cooking device 1000 may transmit the temperature information of the content to the heating device 2000 at certain periods.

In operation S2306, the heating device 2000 may receive the temperature information of the content transmitted from the cooking device 1000. In operation S2307, based on the temperature information of the content received from the cooking device 1000, the heating device 2000 may determine whether the current temperature of the content is higher than or equal to the target heating temperature. When the current temperature of the content does not reach the target heating temperature, the heating device 2000 may maintain the power transmission (magnetic field generation) by the wireless power transmitter 2100 and continue to monitor the current temperature of the content.

In operation S2308, based on the temperature information of the content, the heating device 2000 may stop the power transmission by the wireless power transmitter 2100 when the temperature of the content of the cooking device 1000 is identified as being higher than or equal to the target heating temperature. For example, the heating device 2000 may control the inverter circuit 2113 to stop the supply of a current to the working coil 2120.

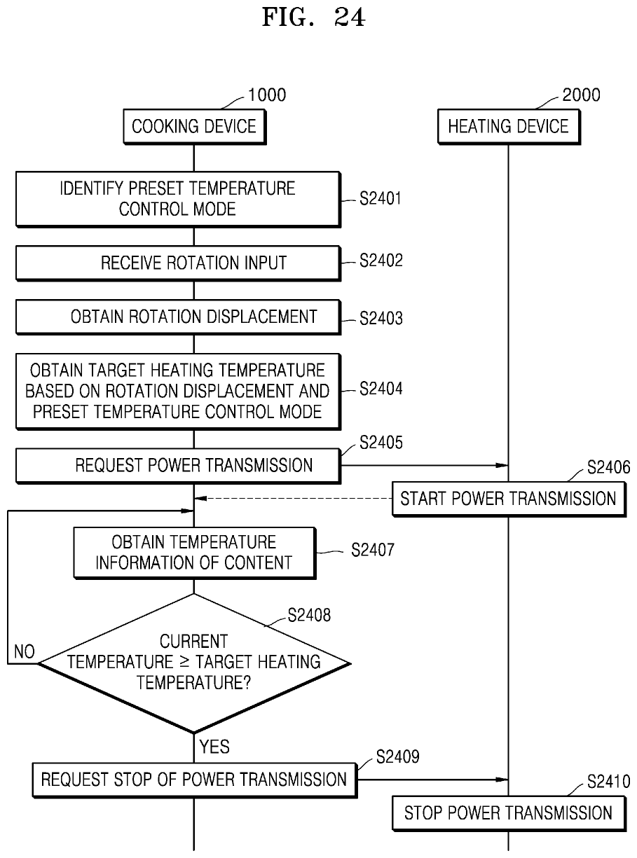

Moreover, according to another embodiment of the disclosure, the cooking device 1000 may determine the target heating temperature according to the user's rotation input and control the power transmission by the heating device 2000. Hereinafter, a method in which the cooking device 10000 controls the power transmission by the heating device 2000 will be described in detail with reference to FIG. 24.

FIG. 24 is a flowchart for describing a method in which a cooking device controls power transmission by a heating device, according to an embodiment of the disclosure.

In operation S2401, the cooking device 1000 may identify a preset temperature control mode. The preset temperature control mode may be stored in the memory of the cooking device 1000.

According to an embodiment of the disclosure, the cooking device 1000 may identify the preset temperature control mode based on detecting that the cooking device 1000 is placed on the top plate of the heating device 2000. For example, when the cooking device 1000 is placed on the top plate of the heating device 2000, the cooking device 1000 may detect power transmitted by the heating device 2000 to detect the cooking device 1000. Also, the cooking device 1000 may receive power for driving the pickup coil 1001 from the heating device 2000. In this case, the cooking device 1000 may detect that the cooking device 1000 is placed on the heating device 2000, by measuring a change in the current flowing through the pickup coil 1001 by using the current sensor.

Moreover, when an NFC tag is installed in the heating device 2000, the cooking device 1000 may detect that the cooking device 1000 is placed on the heating device 2000, by recognizing the NFC tag of the heating device 2000.

In operation S2402, the cooking device 1000 may receive a rotation input from the user. For example, the user may rotate the cooking device 1000 in the counterclockwise or clockwise direction in order to set the target heating temperature.

In operation S2403, the cooking device 1000 may obtain a rotation displacement according to the rotation input. For example, the cooking device 1000 may obtain a rotation displacement according to the rotation input to the cooking device 1000 by using the rotation detecting sensor 1011 (see 1000-2 of FIG. 10) included in the cooking device 1000. The rotation displacement may mean that the position of the cooking device 1000 changes according to the rotation. The rotation displacement may include at least one of whether a rotation has occurred, a rotation direction, a rotation speed, or a rotation angle. Moreover, when the rotation detecting sensor 2410 (see 1000-1 of FIG. 10) is arranged in the heating device 2000, the cooking device 1000 may receive information about the rotation displacement according to the rotation input from the heating device 2000.

According to an embodiment of the disclosure, when the cooking device 1000 is the heater type cooking device 1000b, the cooking device 1000 may obtain a rotation displacement according to the rotation input based on at least one of a capacitance variation of the working coil 2120 or a capacitance variation of the receiving coil 1003.

In operation S2404, the cooking device 1000 according to an embodiment of the disclosure may obtain a target heating temperature of the cooking device 1000 based on the preset temperature control mode and the rotation displacement according to the rotation input.

According to an embodiment of the disclosure, the cooking device 1000 may identify a default temperature of the cooking device 1000 based on the preset temperature control mode. For example, when the default temperature is defined as 40° C. in the temperature control mode of the first cooking device, the first cooking device may identify the default temperature as 40° C.

According to an embodiment of the disclosure, the cooking device 1000 may determine the target heating temperature based on the rotation direction of the rotation input. For example, the cooking device 1000 may determine a temperature higher than the default temperature as the target heating temperature when the rotation input is the first rotation input in the counterclockwise direction (the right direction) and may determine a temperature lower than the default temperature as the target heating temperature when the rotation input is the second rotation in the clockwise direction (the left direction).

According to an embodiment of the disclosure, the cooking device 1000 may gradually increase or decrease the target heating temperature based on the rotation direction and the rotation displacement (e.g., the rotation angle) of the rotation input. For example, the cooking device 1000 may increase the target heating temperature from the default temperature at preset temperature intervals as the rotation angle of the first rotation input in the first direction (e.g., the counterclockwise direction, the right direction)) increases. For example, the cooking device 1000 may decrease the target heating temperature from the default temperature at preset temperature intervals as the rotation angle of the second rotation input in the second direction (e.g., the clockwise direction, the left direction)) increases. The preset temperature interval may be defined in the temperature control mode of the cooking device 1000. The preset temperature interval may be changed by a user input.

According to an embodiment of the disclosure, when the user rotates the cooking device 1000 in the counterclockwise direction (the right direction) and then rotates the same in the clockwise direction (the left direction) at a first time, the heating device 1000 may increase the target heating temperature (e.g., 40° C.->50° C.->60° C.) and then decrease the target heating temperature (e.g., 60° C.->50° C.->40° C.) from the first time.

According to an embodiment of the disclosure, the cooking device 1000 may determine a target heating temperature among a plurality of preset temperatures. For example, when the plurality of temperatures are defined as 40° C., 70° C., 80° C., and 100° C. in the temperature control mode of the third cooking device, the third cooking device may determine the target heating temperature of the third cooking device among 40° C., 70° C., 80° C., and 100° C. For example, when the user rotates the third cooking device in the counterclockwise direction, the third cooking device may sequentially increase the target heating temperature among 40° C., 70° C., 80° C., and 100° C., and when the user rotates the third cooking device in the clockwise direction, the third cooking device may sequentially decrease the target heating temperature among 40° C., 70° C., 80° C., and 100° C.

According to an embodiment of the disclosure, the cooking device 1000 may determine the target heating temperature based on the rotation direction and the rotation speed of the rotation input. For example, when the rotation speed of the first rotation input in the first direction (e.g., the counterclockwise direction) is greater than a threshold value, the cooking device 1000 may determine the target heating temperature as the highest temperature (e.g., 100° C.), and when the rotation speed of the first rotation input is less than or equal to the threshold value, the cooking device 1000 may gradually increase the target heating temperature at preset temperature intervals (e.g., 10° C.). For example, when the rotation speed of the second rotation input in the second direction (e.g., the clockwise direction) is greater than a threshold value, the cooking device 1000 may determine the target heating temperature as the lowest temperature (e.g., 40° C. or 0° C.), and when the rotation speed of the second rotation input is less than or equal to the threshold value, the cooking device 1000 may gradually decrease the target heating temperature at preset temperature intervals (e.g., 10° C.).

In operation S2405, when the target heating temperature is determined, the cooking device 1000 may request power transmission from the heating device 2000 in order to heat the content. For example, the cooking device 1000 may request power transmission from the heating device 2000 by using short-range wireless communication (e.g., NFC, Bluetooth, or Wi-Fi Direct). According to an embodiment of the disclosure, the cooking device 1000 may also transmit information about the power level.

In operation S2406, the heating device 2000 may control the wireless power transmitter 2100 to start power transmission (magnetic field generation) in response to the power transmission request of the cooking device 1000.

For example, the heating device 2000 may control the inverter circuit 2113 such that an AC current may be applied to the working coil 2120. In this case, a magnetic field (magnetic force line) may be generated at the working coil 2120, and an eddy current or an induced current may be formed at the cooking device 1000 as the magnetic field (magnetic force line) passes through the bottom of the cooking device 1000 or the receiving coil 1003 of the cooking device 1000. In this case, the content of the cooking device 1000 may start to be heated.

For example, when the cooking device 1000 is the IH type cooking device 1000a, an eddy current may be generated at the bottom of the cooking device 1000a and heat may be generated at the bottom of the cooking device 1000a by the eddy current and the resistance of a metal (e.g., iron). In this case, the content of the cooking device 1000a may be heated by the generated heat. When the cooking device 1000 is the heater type cooking device 1000b, an induced current may be generated in the receiving coil 1003 and power may be supplied to the heater 1004 to heat the content of the cooking device 1000b.

Moreover, when the power transmission request of the cooking device 1000 includes information about the power level, the heating device 2000 may transmit power of the power level designated by the cooking device 1000.

In operation S2407, the cooking device 1000 may obtain temperature information of the content by using the temperature sensor. The cooking device 1000 may obtain the temperature information of the content by monitoring the temperature of the content at certain periods. When the content is heated by receiving power from the heating device 2000, the temperature of the content may gradually increase.

In operation S2408, based on the temperature information of the content, the cooking device 1000 may determine whether the current temperature of the content is higher than or equal to the target heating temperature. When the current temperature of the content does not reach the target heating temperature, the cooking device 1000 may continue to monitor the temperature of the content while heating the content based on the power supplied from the heating device 2000.

According to an embodiment of the disclosure, the cooking device 1000 may adjust the heating level when the current temperature of the content approaches the target heating temperature. For example, when the cooking device 1000 includes a plurality of receiving coils connected to a plurality of heaters corresponding to a plurality of heating levels, the cooking device 1000 may initially drive a first heater corresponding to a first heating level by receiving power by using a first receiving coil. Thereafter, when the temperature of the content approaches the target heating temperature (e.g., reaches a first temperature lower than the target heating temperature by a first reference value), the cooking device 1000 may drive a second heater corresponding to a second heating level by receiving power by using a second receiving coil. In this case, the first heating level may be a heating level higher than the second heating level.

In operation S2409, when the current temperature of the content is higher than or equal to the target heating temperature, the cooking device 1000 may request the heating device 2000 to stop the power transmission. For example, the cooking device 1000 may request the heating device 2000 to stop the power transmission, by using short-range wireless communication (e.g., NFC, Bluetooth, or WiFi Direct).

In operation S2410, the heating device 2000 may stop the power transmission in response to the power transmission stop request received from the cooking device 1000. For example, the heating device 2000 may control the inverter circuit 2113 to stop the supply of the driving current to the working coil 2120.

Moreover, according to an embodiment of the disclosure, the cooking device 1000 and the heating device 2000 may interwork with the server device to perform a heating operation. A method in which the cooking device 1000 and the heating device 2000 interwork with the server device will be described in detail with reference to FIGS. 25 to 28.

FIG. 25 is a diagram for describing an operation in which a heating device interworks with a server device, according to an embodiment of the disclosure.

Referring to FIG. 25, the cooking system 100 according to an embodiment of the disclosure may further include a server device 3000 and a display device 4000 in addition to the cooking device 1000 and the heating device 2000. Because the cooking system 100 including the cooking device 1000 and the heating device 2000 has been described above with reference to FIG. 1, the server device 3000 and the display device 4000 will be described here.

According to an embodiment of the disclosure, the server device 3000 may include a communication interface for communicating with an external device. The server device 3000 may communicate with the cooking device 1000, the heating device 2000, or the display device 4000 through the communication interface. According to an embodiment of the disclosure, the cooking device 1000 may access the server device 3000 by transmitting the identification information of the cooking device 1000 or the user's identification information (login information or account information) to the server device 3000 and receiving the authentication of the identification information of the cooking device 1000 or the user's identification information (login information or account information) from the server device 3000. Also, the heating device 2000 may access the server device 3000 by transmitting the identification information of the heating device 2000 or the user's identification information (login information or account information) to the server device 3000 and receiving the authentication of the identification information of the heating device 2000 or the user's identification information (login information or account information) from the server device 3000.

According to an embodiment of the disclosure, the server device 3000 may include an AI processor. The AI processor may train an artificial neural network to generate an AI model for recommending a temperature control mode. “Training” the artificial neural network may mean generating a mathematical model for allowing the neurons of the artificial neural network to make an optimal prediction (inference) while suitably changing weights based on data.

The display device 4000 according to an embodiment of the disclosure may be connected to the server device 3000 to display information provided by the server device 3000. According to an embodiment of the disclosure, the display device 4000 may transmit/receive information to/from the server device 3000 through a particular application (e.g., a home appliance management application) installed in the display device 4000.

According to an embodiment of the disclosure, the display device 4000 may be a device connected with the same account information as the cooking device 1000 and the heating device 2000. The display device 4000 may be directly connected to the cooking device 1000 and the heating device 2000 through a short-range wireless communication channel or may be indirectly connected to the cooking device 1000 and the heating device 2000 through the server device 3000.

The display device 4000 according to an embodiment of the disclosure may be implemented in various forms. For example, the display device 4000 described in the disclosure may include a mobile terminal, a refrigerator including a display, a TV, a computer, or an oven including a display; however, the disclosure is not limited thereto. Also, the mobile terminal may include a smart phone, a notebook computer (laptop computer), a tablet PC, a digital camera, an e-book terminal, a digital broadcasting terminal, a personal digital assistant (PDA), a portable multimedia player (PMP), a navigation device, or an MP3 player; however, the disclosure is not limited thereto. For example, the mobile terminal may be a wearable device that may be worn by the user. Hereinafter, for convenience of description, a case where the display device 4000 is a smart phone will be described as an example.

According to an embodiment of the disclosure, the display device 400 or the heating device 2000 may receive a voice signal, which is an analog signal, through a microphone and convert a voice portion into computer-readable text by using an automatic speech recognition (ASR) model. By using a natural language understanding (NLU) model, the display device 400 or the heating device 2000 may interpret the resulting text to obtain the intention of the user's utterance. Here, the ASR model or the NLU model may be an AI model. The AI model may be processed by a dedicated AI processor designed in a hardware structure specialized for processing the AI model. The AI model may be generated through training. The training may be performed in a device itself (e.g., the display device 4000 or the heating device 2000) in which the AI model according to the disclosure is stored, or may be performed through a separate server device 3000 and/or a system. Examples of the training algorithm may include, but are not limited to, supervised learning, unsupervised learning, semi-supervised learning, or reinforcement learning.

The AI model may include a plurality of neural network layers. Each of the plurality of neural network layers may have a plurality of weight values and may perform a neural network operation through an operation between the plurality of weights and the operation result of a previous layer. The plurality of weights of the plurality of neural network layers may be optimized by the training results of the AI model. For example, the plurality of weights may be refined such that a loss value or a cost value obtained by the AI model during the learning process may be reduced or minimized. The artificial neural network may include Deep Neural Network (DNN) and may include, for example, Convolutional Neural Network (CNN), Deep Neural Network (DNN), Recurrent Neural Network (RNN), Restricted Boltzmann Machine (RBM), Deep Belief Network (DBN), Bidirectional Recurrent deep Neural Network (BRDNN), or Deep Q-Networks, but is not limited to the examples described above.

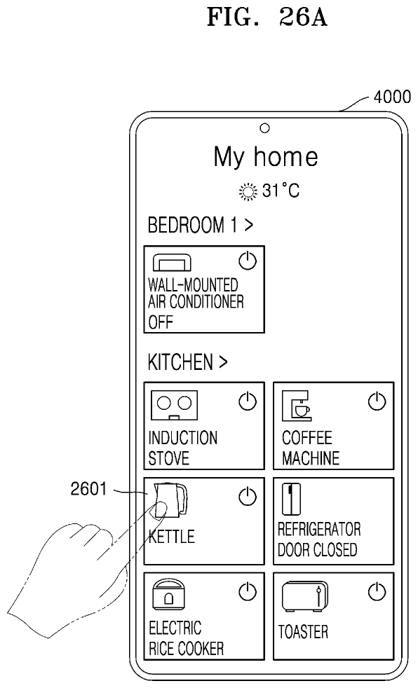

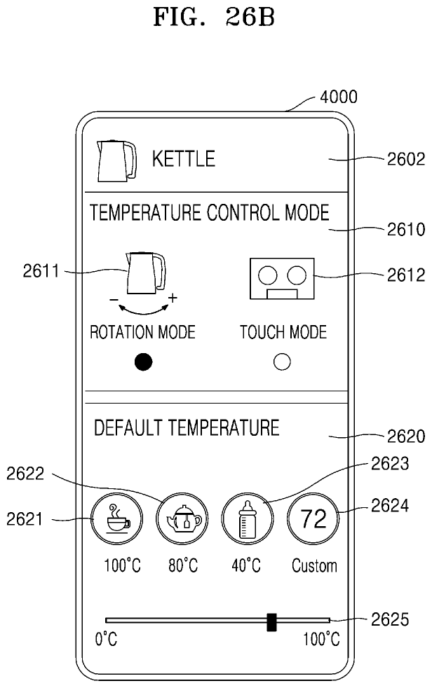

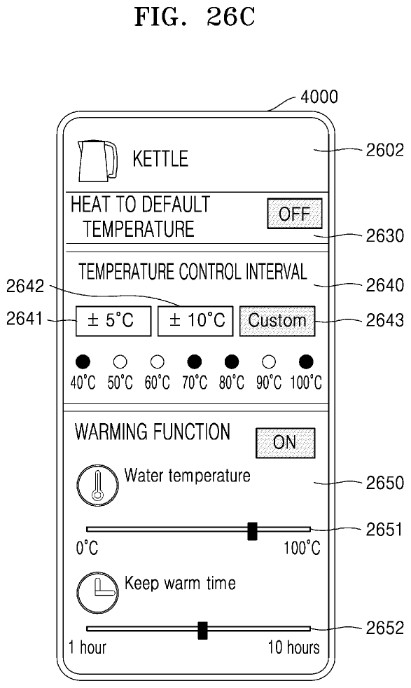

According to an embodiment of the disclosure, based on the user input, the display device 4000 may execute a particular application (e.g., a home appliance management application) provided by the server device 3000. In this case, the user may set the temperature control mode of the cooking device 1000 through an execution window of the application. Hereinafter, an operation in which the user sets the temperature control mode of the cooking device 1000 by using a particular application (e.g., s home appliance management application) provided by the server device 3000 will be described a little more with reference to FIGS. 26A to 26C.

FIG. 26A is diagram illustrating a GUI for selecting a cooking device, according to an embodiment of the disclosure. FIG. 26B is diagram illustrating a setting screen related to a temperature control mode of a cooking device, according to an embodiment of the disclosure. FIG. 26C is diagram for describing an operation in which a server device provides information about a cooking device through a display device, according to an embodiment of the disclosure.

Referring to FIG. 26A, when the user executes an application for managing the user's home appliances in the display device 4000, the display device 4000 may receive information from the server device 3000 and display a list of home appliances in an application execution window. The user's home appliances may be registered with the same account in the server device 3000. The home appliances may include the cooking device 1000 and the heating device 2000.

For example, the display device 4000 may display, in the application execution window, a list of icons representing an air conditioner, the heating device (induction stove) 2000, a coffee machine, a kettle, a refrigerator, an electric rice cooker, a toaster, and the like, and in this case, the display device 4000 may receive a user input for selecting an icon 2601 representing the cooking device 1000.

Referring to FIG. 26B, in response to the user input for selecting the icon 2601, the display device 4000 may display a setting screen 2602 related to the temperature control mode of the cooking device 1000 in the application execution window.

For example, the display device 4000 may display a first field 2610 for selecting the temperature control mode and a second field 2620 for selecting the default temperature on the setting screen 2602. The first field 2610 may include a first object 2611 representing a rotation mode and a second object 2612 representing a touch mode but is not limited thereto. The rotation mode may be a mode for setting the target heating temperature by rotating the cooking device 1000, and the touch mode may be a mode for setting the target heating temperature by using the touch panel of the heating device 2000. According to an embodiment of the disclosure, the display device 4000 may receive a user input for selecting the first object 2611 representing the rotation mode in the first field 2610.

According to an embodiment of the disclosure, icons 2621, 2622, and 2623 representing a plurality of temperatures (e.g., 100° C., 80° C., and 40° C.) may be displayed in the second field 2620, and the user may designate the default temperature of the cooking device 1000 by selecting one of the icons 2621, 2622, and 2623. For example, when the user selects the icon 2622 representing 80° C., the default temperature of the cooking device 1000 may be set to 80° C.

According to an embodiment of the disclosure, the user may directly input the default temperature. For example, when the user selects a custom icon 2624, a slide bar 2625 included in the second field 2620 may be activated. In this case, the user may designate the default temperature by moving a control button on the slide bar 2625 left or right. For example, when the user locates the control button at a point corresponding to 72° C., 72° C. may be set as the default temperature of the cooking device 1000.

Referring to FIG. 26C, the setting screen 2602 related to the temperature control mode of the cooking device 1000 may further include a third field 2630 for selecting an option for operating at the default temperature, a fourth field 2640 for selecting the temperature control interval, and a fifth field 2650 for setting the warming function.

According to an embodiment of the disclosure, when the user activates the option for operating at the default temperature in the third field 2630, the target heating temperature of the cooking device 1000 placed on the top plate of the heating device 2000 may be determined as the default temperature and the cooking device 1000 may be heated until the temperature of the content of the cooking device 1000 reaches the default temperature.

According to an embodiment of the disclosure, icons 2641 and 2642 representing temperature intervals may be displayed in the fourth field 2640. By selecting one of the icons 2641 and 2642 displayed in the fourth field 2604, the user may designate a temperature interval increasing/decreasing according to rotation. For example, the user may select the icon 2642 representing ±10° C. in the fourth field 2640. In this case, as the user rotates the cooking device 1000 in the counterclockwise direction, the target heating temperature may increase by 10° C., and as the user rotates the cooking device 1000 in the clockwise direction, the target heating temperature may decrease by 10° C.

Moreover, when the user selects a custom icon 2643 and designates particular temperatures, the target heating temperature may increase or decrease among the temperatures designated by the user. For example, the user may select the custom icon 2643 and select 40° C., 70° C., 80° C., and 100° C. In this case, as the user rotates the cooking device 1000 in the counterclockwise direction, the target heating temperature may sequentially increase among 40° C., 70° C., 80° C., and 100° C., and as the user rotates the cooking device 1000 in the clockwise direction, the target heating temperature may sequentially decrease among 40° C., 70° C., 80° C., and 100° C.

According to an embodiment of the disclosure, the user may activate (ON) the warming function of the cooking device 1000 through the fifth field 2650. Also, the user may set the target warming temperature and the warming time in the fifth field 2650. For example, by moving the position of the control button on a first slide bar 2651, the user may set the target warming temperature to 70° C. By moving the position of the control button on a second slide bar 2652, the user may set the warming time to 4 hours. According to an embodiment of the disclosure, when the user does not separately designate the target warming temperature, the target warming temperature may be set as a default temperature.

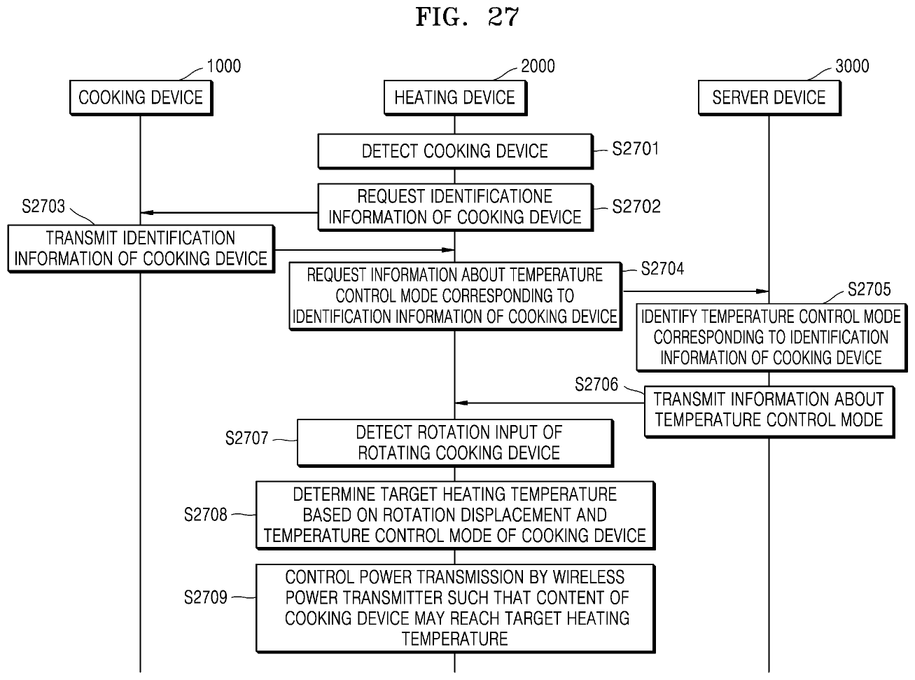

According to an embodiment of the disclosure, the server device 3000 may obtain information about the temperature control mode set by the user through the display device 4000. Also, the server device 3000 may store information about matching the identification information of the cooking device 1000 and the temperature control mode set by the user in the memory. Thereafter, the server device 3000 may receive a request for information about the temperature control mode corresponding to the identification information of the cooking device 1000 from the heating device 2000 and transmit the information about the temperature control mode to the heating device 2000. Hereinafter, an operation in which the heating device 2000 receives information about the temperature control mode of the cooking device 1000 from the server device 3000 will be described in detail with reference to FIG. 27.

FIG. 27 is a flowchart for describing a method in which a heating device obtains information about a temperature control mode of a cooking device from a server device, according to an embodiment of the disclosure.

In operation S2701, the heating device 2000 according to an embodiment of the disclosure may detect the cooking device 1000 placed on the top plate.

For example, the heating device 2000 may detect that the cooking device 1000 is placed on the top plate, by using the current sensor located adjacent to the working coil 2120. Also, the heating device 2000 may detect that the cooking device 1000 is placed on the top plate, by recognizing the NFC tag included in the cooking device 1000.

In operation S2702, when detecting that the cooking device 1000 is placed on the top plate, the heating device 2000 according to an embodiment of the disclosure may request the identification information of the cooking device 1000 from the cooking device 1000. For example, the heating device 2000 may establish a short-range wireless communication channel with the cooking device 1000. Also, the heating device 2000 may request the identification information of the cooking device 1000 through a short-range wireless communication channel (e.g., an NFC communication channel or a Bluetooth communication channel).

In operation S2703, in response to the request, the cooking device 1000 may transmit the identification information of the cooking device 1000 to the heating device 2000 through a short-range wireless communication channel (e.g., a NFC communication channel or a Bluetooth communication channel).

In operation S2704, the heating device 2000 may request information about the temperature control mode corresponding to the identification information of the cooking device 1000 from the server device 3000. For example, when receiving the identification information of the cooking device 1000 from the cooking device 1000, the heating device 2000 may transmit the identification information of the cooking device 1000 to the server device 3000 and request information about the temperature control mode of the cooking device 1000 from the server device 3000.

In operation S2705, the server device 3000 may identify the temperature control mode corresponding to the identification information of the cooking device 1000. According to an embodiment of the disclosure, a temperature control mode DB including information about mapping at least one temperature control mode and identification information of at least one cooking device may be constructed in the server device 3000. In this case, the server device 3000 may retrieve the temperature control mode corresponding to the identification information of the cooking device 1000 from the temperature control mode DB based on the identification information of the cooking device 1000.

In operation S2706, the server device 3000 may transmit information about the temperature control mode corresponding to the identification information of the cooking device 1000 to the heating device 2000. The information about the temperature control mode corresponding to the identification information of the cooking device 1000 may include at least one of the default temperature, the control mode, or whether the warming function is set; however, the disclosure is not limited thereto.

In operation S2707, the heating device 2000 may detect a rotation input of rotating the cooking device 1000.

For example, when the user rotates the cooking device 1000 placed on the top plate, the heating device 2000 may detect a rotation input by using the rotation detecting sensor 2410 and obtain a rotation displacement according to the rotation input. The rotation displacement may include at least one of whether a rotation has occurred, a rotation direction, a rotation speed, or a rotation angle. The rotation detecting sensor 2410 may include at least one of the Hall sensor 2411, the geomagnetic sensor 2412, the touch sensor 2413, the gyroscope sensor, or the image sensor 2414. Moreover, when the rotation detecting sensor 1011 (see 1000-2 of FIG. 10) is attached to the cooking device 1000, the heating device 2000 may obtain information about the rotation displacement according to the rotation input from the rotation detecting sensor 1011 of the cooking device 1000.

When the cooking device 1000 is the heater type cooking device 1000b, the heating device 2000 may obtain a rotation displacement according to the rotation input based on at least one of a capacitance variation of the working coil 2120 or a capacitance variation of the receiving coil 1003.

In operation S2708, the heating device 2000 may determine the target heating temperature based on the rotation displacement according to the rotation input and the temperature control mode of the cooking device 1000.

According to an embodiment of the disclosure, the heating device 2000 may identify the default temperature of the cooking device 1000 based on the temperature control mode of the cooking device 1000. For example, when the default temperature is defined as 40° C. in the temperature control mode of the first cooking device, the heating device 2000 may identify the default temperature of the first cooking device as 40° C. According to an embodiment of the disclosure, the heating device 2000 may increase/decrease the target heating temperature according to the rotation input based on the default temperature.

According to an embodiment of the disclosure, the heating device 2000 may determine the target heating temperature based on the rotation direction of the rotation input. According to an embodiment of the disclosure, the heating device 2000 may gradually increase or decrease the target heating temperature based on the rotation direction and the rotation displacement (e.g., the rotation angle) of the rotation input. According to an embodiment of the disclosure, the heating device 2000 may determine the target heating temperature based on the rotation direction and the rotation speed of the rotation input.

According to an embodiment of the disclosure, when the user rotates the cooking device 1000 in the counterclockwise direction (the right direction) and then rotates the same in the clockwise direction (the left direction) at a first time, the heating device 2000 may increase the target heating temperature (e.g., 40° C.->50° C.->60° C.) and then decrease the target heating temperature (e.g., 60° C.->50° C.->40° C.) from the first time. According to an embodiment of the disclosure, the heating device 2000 may determine a target heating temperature among a plurality of preset temperatures. For example, when the plurality of temperatures are defined as 40° C., 70° C., 80° C., and 100° C. in the temperature control mode of the third cooking device, the heating device 2000 may determine the target heating temperature of the third cooking device among 40° C., 70° C., 80° C., and 100° C.

In operation S2709, the heating device 2000 may control the power transmission by the wireless power transmitter 2100 such that the content of the cooking device 1000 may reach the target heating temperature.

According to an embodiment of the disclosure, when the target heating temperature of the cooking device 1000 is determined according to a rotation input of rotating the cooking device 1000 by the user, the heating device 2000 may start the power transmission by the wireless power transmitter 2100 in order to heat the content of the cooking device 1000. For example, the heating device 2000 may control the inverter circuit 2113 to apply an AC current to the working coil 2120. In this case, a magnetic field (magnetic force line) may be generated at the working coil 2120, and an eddy current or an induced current may be formed at the cooking device 1000 as the magnetic field (magnetic force line) passes through the bottom of the cooking device 1000 or the receiving coil 1003 of the cooking device 1000. In this case, the content of the cooking device 1000 may start to be heated.

According to an embodiment of the disclosure, the heating device 2000 may receive the temperature information of the content from the cooking device 1000 through short-range wireless communication (e.g., NFC, Bluetooth, or WiFi direct). The temperature information of the content may include information about the current temperature of the content detected by the temperature sensor of the cooking device 1000.

According to an embodiment of the disclosure, the heating device 2000 may determine whether the temperature of the content of the cooking device 1000 has reached the target heating temperature or is higher than or equal to the target heating temperature, based on the temperature information of the content received from the cooking device 1000. The heating device 2000 may stop the power transmission by the wireless power transmitter 2100 when the temperature of the content of the cooking device 1000 is identified as being higher than or equal to the target heating temperature. For example, the heating device 2000 may control the inverter circuit 2113 to stop the supply of the driving current to the working coil 2120.

Moreover, according to another embodiment of the disclosure, the server device 3000 may control the output (power transmission) of the heating device 2000. For example, the server device 3000 may receive, from the heating device 2000, information about the target heating temperature determined based on the rotation displacement according to the rotation input and the temperature control mode of the cooking device 1000. Also, the server device 3000 may receive the temperature information of the content from the cooking device 1000. In this case, the server device 3000 may control the output (power transmission) of the heating device 2000 such that the temperature of the content of the cooking device 1000 may reach the target heating temperature. For example, when information about the target heating temperature is received, the server device 3000 may transmit a control command to start power transmission to the heating device 2000. In this case, the heating device 2000 may generate a magnetic field in the working coil 2120 by controlling the inverter circuit 2113 such that a current may be applied to the working coil 2120. Also, the server device 3000 may transmit a control command to stop power transmission to the heating device 2000 when the temperature of the content of the cooking device 1000 reaches the target heating temperature or is higher than or equal to the target heating temperature. In this case, the heating device 2000 may control the inverter circuit 2113 such that a current may not be supplied to the working coil 2120.

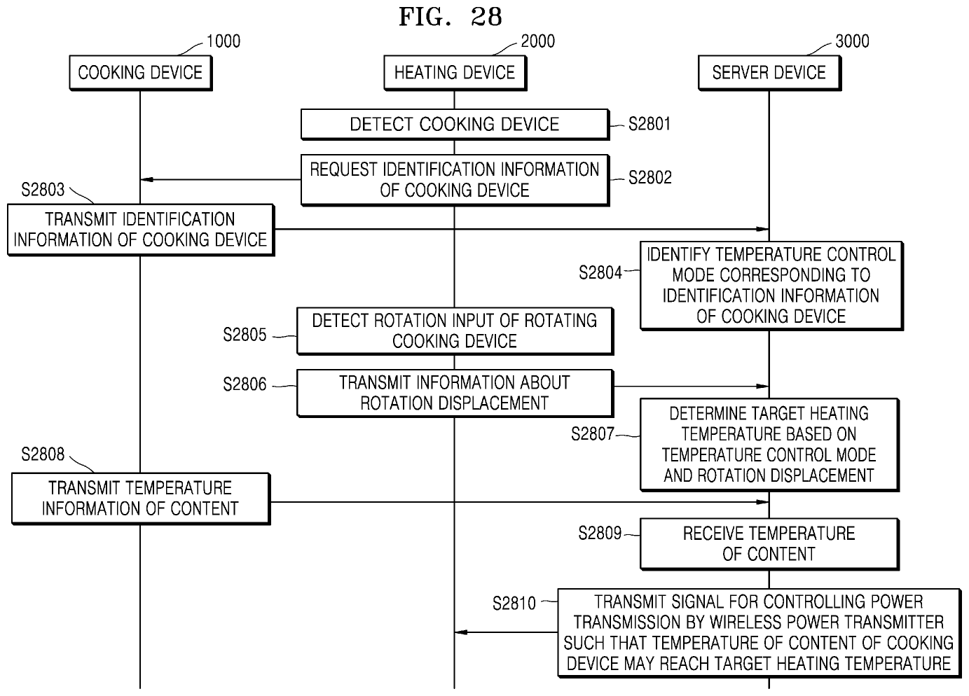

According to another embodiment of the disclosure, the server device 3000 may determine the target heating temperature and control the output (power transmission) of the heating device 2000 such that the temperature of the content of the cooking device 1000 may reach the target heating temperature. An operation in which the server device 3000 determines the target heating temperature will be described with reference to FIG. 28.

FIG. 28 is a diagram for describing a method in which a server device controls power transmission by a heating device, according to an embodiment of the disclosure.

In operation S2801, the heating device 2000 may detect the cooking device 1000 placed on the top plate. According to an embodiment of the disclosure, when the user puts the cooking device 1000 on the top plate, the heating device 2000 may detect the cooking device 1000 by using the current sensor or NFC communication. For example, the heating device 2000 may detect that the cooking device 1000 is placed on the top plate, by using the current sensor located adjacent to the working coil 2120. Also, the heating device 2000 may detect that the cooking device 1000 is placed on the top plate, by recognizing the NFC tag included in the cooking device 1000.

In operation S2802, when detecting that the cooking device 1000 is placed on the top plate, the heating device 2000 may request the identification information of the cooking device 1000 from the cooking device 1000. In operation S2803, the cooking device 1000 may transmit the identification information of the cooking device 1000 to the heating device 2000 in response to the request. In this case, the heating device 2000 may receive identification information of the cooking device 1000 from the cooking device 1000 and transmit the identification information of the cooking device 1000 to the server device 3000.

According to another embodiment of the disclosure, the cooking device 1000 may directly transmit the identification information of the cooking device 1000 to the server device 3000 without passing through the heating device 2000. For example, when the heating device 2000 requests the cooking device 1000 to upload the identification information of the cooking device 1000 to the server device 3000, the cooking device 1000 may directly transmit the identification information of the cooking device 1000 to the server device 3000.

In operation S2804, the server device 3000 may identify the temperature control mode corresponding to the identification information of the cooking device 1000.

According to an embodiment of the disclosure, a temperature control mode DB including information about mapping at least one temperature control mode and identification information of at least one cooking device may be constructed in the server device 3000. In this case, the server device 3000 may retrieve the temperature control mode corresponding to the identification information of the cooking device 1000 from the temperature control mode DB based on the identification information of the cooking device 1000.

In operation S2805, the heating device 2000 may detect a rotation input of rotating the cooking device 1000.

For example, when the user rotates the cooking device 1000 placed on the top plate, the heating device 2000 may detect a rotation input by using the rotation detecting sensor 2410 and obtain a rotation displacement according to the rotation input. Moreover, when the rotation detecting sensor 1011 (see 1000-2 of FIG. 10) is attached to the cooking device 1000, the heating device 2000 may obtain information about the rotation displacement according to the rotation input from the rotation detecting sensor 1011 of the cooking device 1000.

When the cooking device 1000 is the heater type cooking device 1000b, the heating device 2000 may obtain a rotation displacement according to the rotation input based on at least one of a capacitance variation of the working coil 2120 or a capacitance variation of the receiving coil 1003.

In operation S2806, the heating device 2000 may transmit information about the rotation displacement according to the rotation input to the server device 3000.

According to another embodiment of the disclosure, when the rotation detecting sensor 1011 is arranged in the cooking device 1000, the cooking device 1000 may obtain a rotation displacement according to the rotation input through the rotation detecting sensor 1011 and transmit information about the rotation displacement to the server device 3000.

In operation S2807, the server device 3000 may determine the target heating temperature based on the temperature control mode and the rotation displacement.

According to an embodiment of the disclosure, the server device 3000 may identify the default temperature of the cooking device 1000 based on the temperature control mode of the cooking device 1000. For example, when the default temperature is defined as 40° C. in the temperature control mode of the first cooking device, the server device 3000 may identify the default temperature of the first cooking device as 40° C. According to an embodiment of the disclosure, the server device 3000 may increase/decrease the target heating temperature according to the rotation displacement based on the default temperature.

According to an embodiment of the disclosure, the server device 3000 may determine the target heating temperature based on the rotation direction of the rotation input. According to an embodiment of the disclosure, the server device 3000 may gradually increase or decrease the target heating temperature based on the rotation direction and the rotation displacement (e.g., the rotation angle) of the rotation input. According to an embodiment of the disclosure, the server device 3000 may determine the target heating temperature based on the rotation direction and the rotation speed of the rotation input.

According to an embodiment of the disclosure, when the user rotates the cooking device 1000 in the counterclockwise direction (the right direction) and then rotates the same in the clockwise direction (the left direction) at a first time, the server device 3000 may increase the target heating temperature (e.g., 40° C.->50° C.->60° C.) and then decrease the target heating temperature (e.g., 60° C.->50° C.->40° C.) from the first time.

According to an embodiment of the disclosure, the server device 3000 may determine a target heating temperature among a plurality of preset temperatures. For example, when the plurality of temperatures are defined as 40° C., 70° C., 80° C., and 100° C. in the temperature control mode of the third cooking device, the server device 3000 may determine the target heating temperature of the third cooking device among 40° C., 70° C., 80° C., and 100° C.

In operations S2808 and S2809, the server device 3000 may receive the temperature information of the content from the cooking device 1000. For example, when the target heating temperature is determined, the server device 3000 may request the cooking device 1000 to periodically transmit the temperature information of the content of the cooking device 1000. In this case, the cooking device 1000 may transmit the temperature information of the content to the server device 3000 at certain periods.

According to an embodiment of the disclosure, the cooking device 1000 may transmit the temperature information of the content only while there is a change in the temperature of the content. For example, when the temperature of the content is maintained at the same temperature for a certain time (e.g., 3 minutes) or more, the cooking device 1000 may no longer transmit the temperature information of the content to the server device 3000.

Moreover, according to an embodiment of the disclosure, the cooking device 1000 may transmit the temperature information of the content to the heating device 2000, and the heating device 2000 may transmit the temperature information of the content of the cooking device 1000 to the server device 3000.

In operation S2810, the server device 3000 may transmit a signal for controlling the power transmission by the wireless power transmitter 2100 such that temperature of the content of the cooking device 1000 may reach the target heating temperature.

For example, when the target heating temperature is determined, the server device 3000 may transmit a control command to start power transmission to the heating device 2000. In this case, the heating device 2000 may generate a magnetic field in the working coil 2120 by controlling the inverter circuit 2113 such that a current may be applied to the working coil 2120. Also, the server device 3000 may transmit a control command to stop power transmission to the heating device 2000 when the temperature of the content of the cooking device 1000 reaches the target heating temperature or is higher than or equal to the target heating temperature. In this case, the heating device 2000 may control the inverter circuit 2113 such that a current may not be supplied to the working coil 2120.

According to another embodiment of the disclosure, the order of operations of FIG. 28 may be changed, and some operations thereof may be omitted.

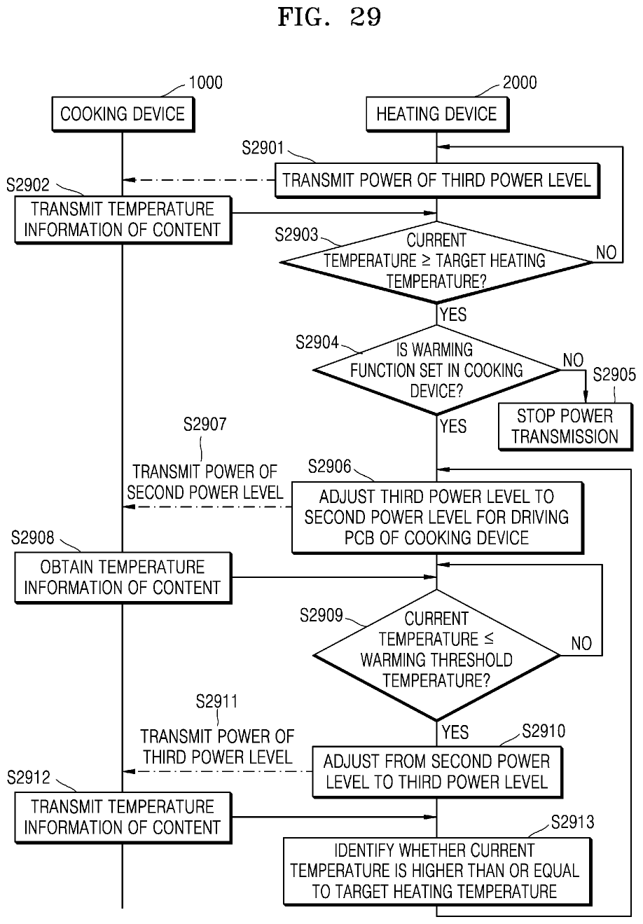

Moreover, according to an embodiment of the disclosure, the cooking device 1000 may provide a warming function. An operation in which the cooking device 1000 provides a warming function will be described in detail with reference to FIGS. 29 to 31.

FIG. 29 is a flowchart for describing a method in which a heating device controls power transmission when a warming function is set in a cooking device, according to an embodiment of the disclosure.

In operation S2901, when the target heating temperature of the cooking device 1000 is determined, the heating device 2000 may transmit power of the third power level to the cooking device 1000. The power of the third power level may be power of a certain level such that the content of the cooking device 1000 may be heated. For example, when the user determines the target heating temperature by rotating the cooking device 1000, the heating device 2000 may start power transmission to the cooking device 1000 such that the temperature of the content of the cooking device 1000 may reach the target heating temperature. In this case, the heating device 2000 may control the inverter circuit 2113 such that an AC current of a level corresponding to the third power level may be applied to the working coil 2120.

In operation S2902, the cooking device 1000 may obtain temperature information of the content.

The cooking device 1000 according to an embodiment of the disclosure may obtain the temperature information of the content by monitoring the temperature of the content by using the temperature sensor. For example, when heating is started (when power is received from the heating device 2000), the cooking device 1000 may monitor the temperature of the content. According to an embodiment of the disclosure, the cooking device 1000 may monitor the temperature of the content at certain periods. When the content is heated by receiving power from the heating device 2000, the temperature of the content may gradually increase.

The cooking device 1000 may transmit the temperature information of the content of the cooking device 1000 to the heating device 2000 by using short-range wireless communication (e.g., Bluetooth, NFC, or WiFi Direct). According to an embodiment of the disclosure, the cooking device 1000 may transmit the temperature information of the content to the heating device 2000 at certain periods.

In operation S2903, the heating device 2000 may determine whether the current temperature of the content has reached the target heating temperature or is higher than or equal to the target heating temperature. For example, the heating device 2000 may receive temperature information of the content from the cooking device 1000 and determine whether the current temperature of the content is higher than or equal to the target heating temperature, based on the temperature information of the content. When the current temperature of the content does not reach the target heating temperature, the heating device 2000 may maintain the third power level and continue to monitor the current temperature of the content.

In operation S2904, when the current temperature of the content is higher than or equal to the target heating temperature, the heating device 2000 may identify whether a warming function is set in the cooking device 1000. For example, when whether to use the warming function is defined in information about the temperature control mode of the cooking device 1000, the heating device 2000 may identify whether the warming function of the cooking device 1000 is used, based on the information about the temperature control mode of the cooking device 1000.

In operation S2905, the heating device 2000 may stop the power transmission by the wireless power transmitter 2100 when the warming function is not set in the cooking device 1000. For example, the heating device 2000 may control the inverter circuit 2113 to stop the supply of a current to the working coil 2120.

In operation S2906, when the current temperature of the content is higher than or equal to the target heating temperature, the heating device 2000 may adjust the power level from the third power level to the second power level. The second power level may be a fine power level for driving the PCB 1005 of the cooking device 1000.

In operation S2907, the heating device 2000 may transmit power of the second power level. Because the power of the second power level is fine power, the heating of the content of the cooking device 1000 may be stopped. However, because power may be supplied to the PCB 1005 through the pickup coil 1001, the cooking device 1000 may obtain temperature information of the content by using the temperature sensor arranged at the PCB 1005. For example, the cooking device 1000 may obtain temperature information of the content by using the temperature sensor while power of the second power level is supplied. Because the heating of the content of the cooking device 1000 is stopped while the power of the second power level is supplied, the temperature of the content may gradually decrease.

In operation S2908, the cooking device 1000 may transmit the temperature information of the content to the heating device 2000. For example, because power may be supplied to the PCB 1005 through the pickup coil 1001, the cooking device 1000 may drive the communication interface 1030 arranged at the PCB 1005 and transmit the temperature information of the content to the heating device 2000 through the communication interface 1030. The cooking device 1000 may transmit the temperature information of the content to the heating device 2000 through short-range wireless communication (e.g., NFC, Bluetooth, or WiFi Direct).

In operation S2909, based on the temperature information of the content, the heating device 2000 may compare the current temperature of the content with a warming threshold temperature. The warming threshold temperature may be a reference temperature for restarting the heating of the content. The warming threshold temperature may be lower than the target heating temperature by a predetermined temperature (e.g., 3° C., 5° C., or 10° C.). For example, in the case where the predetermined temperature is 5° C., when the target heating temperature is 70° C., the warming threshold temperature may be 65° C. lower by 5° C. than the target heating temperature, and when the target heating temperature is 100° C., the warming threshold temperature may be 95° C.

The heating device 2000 may continue to monitor the temperature of the content when the current temperature of the content is not lower than the warming threshold temperature.

In operation S2910, when the current temperature of the content is lower than the warming threshold temperature, the heating device 2000 may adjust the power level from the second power level to the third power level. For example, when the temperature of the content is lower than the warming threshold temperature due to cooling of the content, the heating device 2000 may adjust the power level to the third power level in order to reheat the content.

In operation S2911, the heating device 2000 may transmit power of the third power level. For example, the heating device 2000 may control the inverter circuit 2113 such that an AC current of a level corresponding to the third power level may be applied to the working coil 2120. Because the power of the third power level is power of a level capable of heating the content of the cooking device 1000, the heating device 2000 may transmit power of the third power level such that the temperature of the content of the cooking device 1000 may again reach the target heating temperature.

In operation S2912, the cooking device 1000 may transmit the temperature information of the content to the heating device 2000. When the cooking device 1000 receives power of the third power level, because the content of the cooking device 1000 starts to be reheated, the temperature of the content may increase again.

In operation S2913, based on the temperature information of the content received from the cooking device 1000, the heating device 2000 may identify that the current temperature of the content has again reached the target heating temperature (e.g., the current temperature is higher than or equal to the target heating temperature). In this case, the heating device 2000 may return to operation S2906. For example, when the current temperature of the content is again higher than or equal to the target heating temperature, the heating device 2000 may readjust the power level from the third power level to the second power level and monitor whether the current temperature of the content is lower than the warming threshold temperature. Then, when the current temperature of the content is lower than the warming threshold temperature, the heating device 2000 may readjust the power level from the second power level to the third power level such that the content may be reheated.

According to an embodiment of the disclosure, when a warming function is set in the cooking device 1000, the heating device 2000 may control the power level such that the temperature of the content may be maintained within a predetermined temperature range.

Moreover, according to an embodiment of the disclosure, the cooking device 1000 may include a battery. When the cooking device 1000 includes a battery, the cooking device 1000 may provide a warming function by using the power of the battery. A method in which the cooking device 1000 provides a warming function by using the power of the battery will be described with reference to FIG. 30.

FIG. 30 is a flowchart for describing a method in which a cooking device requests power transmission from a heating device to provide a warming function, according to an embodiment of the disclosure.

In operation S3001, when the target heating temperature of the cooking device 1000 is determined, the heating device 2000 starts power transmission (output) by the wireless power transmitter 2100 in order to heat the content of the cooking device 1000.

In operation S3002, when power is supplied from the heating device 2000, the cooking device 1000 may transmit the temperature information of the content to the heating device 2000. For example, the cooking device 1000 may obtain temperature information of the content by using the temperature sensor while power is supplied from the heating device 2000. Also, the cooking device 1000 may transmit the temperature information of the content to the heating device 2000 by using short-range wireless communication.

In operation S3003, based on the temperature information of the content received from the cooking device 1000, the heating device 2000 may determine whether the current temperature of the content has reached the target heating temperature or is higher than or equal to the target heating temperature. When the current temperature of the content does not reach the target heating temperature, the heating device 2000 may maintain the power transmission (output) by the wireless power transmitter 2100 and monitor the temperature of the content.

In operation S3004, the heating device 2000 may stop the power transmission by the wireless power transmitter 2100 when the current temperature of the content is higher than or equal to the target heating temperature. For example, the heating device 2000 may control the inverter circuit 2113 such that a current may not be supplied to the working coil 2120.

Because operations S3001 to S3004 correspond to operations S2110 to S2160 of FIG. 22, redundant descriptions thereof will be omitted.

In operation S3005, when the power transmission from the heating device 2000 is stopped, the cooking device 1000 may identify whether a warming function is set in the cooking device 1000. For example, when information related to the setting of the warming function is stored in the memory of the cooking device 1000, the cooking device 1000 may identify whether the warming function is set, based on the information stored in the memory.

According to an embodiment of the disclosure, the user may activate the warming function by using the user interface included in the cooking device 1000. For example, the user may set the warming function by turning on or off a warming button arranged at the cooking device 1000. In this case, the cooking device 1000 may identify whether a warming function is set in the cooking device 1000, based on a user input.

According to an embodiment of the disclosure, when a warming function is not set in the cooking device 1000, the cooking device 1000 may stop an operation of monitoring the temperature of the content.

In operation S3006, when a warming function is set in the cooking device 1000, the cooking device 1000 may operate in a warming mode by using the power of the battery. For example, because the power supply from the heating device 2000 is stopped, the cooking device 1000 may operate in the warming mode by driving the PCB 1005 by using the power of the battery.

The battery may store power and supply power to the cooking device 1000. The battery may be a rechargeable secondary battery and may be charged by receiving power from a charger. The battery may be connected to the charger through a charge interface. The battery may receive power from the charger through the charge interface. For example, the battery may include at least one of a nickel-cadmium battery, a nickel-hydrogen battery, a lithium ion battery, or a lithium ion polymer battery; however, the disclosure is not limited thereto. The charge interface may be connected to the charger to receive power from the charger. The charge interface may include at least one charge terminal. The charge interface may be connected to the charger through the charge terminal to receive power. Also, the charge interface may include a charge circuit for converting power supplied from the charger and charging the battery with power.

In operation S3007, the cooking device 1000 may monitor the temperature of the content by using the temperature sensor arranged at the PCB 1005. Because the heating of the content of the cooking device 1000 is stopped, the temperature of the content may gradually decrease.

In operation S3008, the cooking device 1000 may determine whether the current temperature of the content has reached the warming threshold temperature or is lower than the warming threshold temperature. The warming threshold temperature may be a reference temperature for restarting the heating of the content. The warming threshold temperature may be lower than the target heating temperature by a predetermined temperature (e.g., 3° C., 5° C., or 10° C.). The cooking device 1000 may continue to monitor the temperature of the content when the current temperature of the content is not lower than the warming threshold temperature.

In operation S3009, when the current temperature of the content is lower than the warming threshold temperature, the cooking device 1000 may request power transmission from the heating device 2000. In this case, the heating device 2000 may restart power transmission, and the content of the cooking device 1000 may start to be heated. When the temperature of the content of the cooking device 1000 is again higher than or equal to the target heating temperature, the heating device 2000 may stop the power transmission and the cooking device 1000 may operate in the warm mode while monitoring the temperature of the content by using the power of the battery.

Thus, according to an embodiment of the disclosure, the cooking device 1000 may maintain the temperature of the content within a predetermined range by using the power of the battery as auxiliary power for temperature monitoring and power transmission request.

FIG. 31 is a diagram for describing an operation of providing a notification related to a warming function when a cooking device is detached from a heating device, according to an embodiment of the disclosure.

According to an embodiment of the disclosure, when the temperature of the content of the cooking device 1000 reaches the target heating temperature, the user may use the content of the cooking device 1000 and place the cooking device 1000 outside the heating device 2000. For example, in order to drink tea, the user may place the cooking device 1000 (e.g., a kettle) containing water on the heating device 2000 and set the target heating temperature to 80° C. by rotating the cooking device 1000. Thereafter, the water in the cooking device 1000 may be boiled to 80° C. by the power transmission (magnetic field generation) of the heating device 2000. When the water in the cooking device 1000 is boiled to 80° C., the power transmission of the heating device 2000 may be stopped. In this case, the heating device 2000 or the cooking device 1000 may output a notification message indicating that the temperature of the water has reached the target heating temperature (80° C.). The user may make tea by pouring the water in the cooking device 1000 into a cup. Also, the user may place the cooking device 1000 outside the heating device 2000 without placing the cooking device 1000 back on the top plate of the heating device 2000.

When the cooking device 1000 deviates from the cooking zone of the heating device 2000, the cooking device 1000 may not receive power even when the heating device 2000 transmits power. Thus, the cooking device 1000 may not directly provide a warming function. Thus, in this case, the cooking device 1000 may monitor the temperature of the content by using the power of the battery, and the cooking device 1000 may output a notification message 3100 through the display device 4000 (e.g., the user's mobile terminal) when the temperature of the content is lower than a threshold temperature. The display device 4000 may be a terminal registered in the server device 3000 with the same account as the cooking device 1000 and the heating device 2000.

According to an embodiment of the disclosure, the display device 4000 may receive a notification message output request from the cooking device 1000 through short-range wireless communication (e.g., NFC, Bluetooth, or WiFi direct) and output the notification message 3100. For example, the notification message 3100 may include identification information (e.g., Kettle) of the cooking device 1000, current temperature information of the content (e.g., Current water temperature: 60° C.), and notification content (Water is cooling down. Reheat the water by putting the kettle on the induction stove); however, the disclosure is not limited thereto.

According to another embodiment of the disclosure, the display device 4000 may receive a notification message output request from the server device 3000 or the heating device 2000. For example, the cooking device 1000 may transmit a notification message output request to the server device 3000 or the heating device 2000, and the server device 3000 or the heating device 2000 may transmit the notification message output request to the display device 4000.

When the user checks the notification message 3100 and wants to maintain the temperature of the content within a predetermined range from the target heating temperature, the user may put the cooking device 1000 back on the cooking zone of the heating device 2000.

FIG. 32 is a diagram for describing an operation in which a heating device interworks with a home appliance, according to an embodiment of the disclosure.

The cooking system 100 according to an embodiment of the disclosure may further include a home appliance 3200 in addition to the cooking device 1000, the heating device 2000, the server device 3000, and the display device 4000. Because the cooking system 100 including the cooking device 1000, the heating device 2000, and the server device 300 has been described above with reference to FIG. 25, the home appliance 3200 will be described here.

According to an embodiment of the disclosure, the home appliance 3200 may include a communication interface for communicating with an external device. The home appliance 3200 may communicate with the cooking device 1000, the heating device 2000, or the server device 3000 through the communication interface.

The home appliance 3200 may include various devices located indoors. For example, the home appliance 3200 may include a refrigerator, an oven, a washing machine, a TV, a cleaning robot, a dishwasher, or a microwave oven; however, the disclosure is not limited thereto. In FIG. 32, a case where the home appliance 3200 is a refrigerator will be described as an example.

The home appliance 3200 may be connected to the server device 3000 and may display information provided by the server device 3000. For example, the home appliance 3200 may transmit/receive information to/from the server device 3000 through a particular application (e.g., a home appliance management application) installed in the home appliance 3200. According to an embodiment of the disclosure, the home appliance 3200 may be one of display devices 4000.

The home appliance 3200 may be a device connected with the same account information as the cooking device 1000 and the heating device 2000. The home appliance 3200 may be directly connected to the cooking device 1000 and the heating device 2000 through a short-range wireless communication channel or may be indirectly connected to the cooking device 1000 and the heating device 2000 through the server device 3000.

According to an embodiment of the disclosure, the home appliance 3200 may be a hub device on a home network. The home appliance 3200 may be a device having a better computing resource or processing speed than the cooking device 1000 or the heating device 2000. Thus, according to an embodiment of the disclosure, the home appliance 3200 may control the output (power transmission) of the heating device 2000.

For example, the home appliance 3200 may receive, from the heating device 2000, information about the target heating temperature determined based on the rotation displacement according to the rotation input and the temperature control mode of the cooking device 1000. Also, the home appliance 3200 may receive the temperature information of the content from the cooking device 1000. In this case, the home appliance 3200 may control the output (power transmission) of the heating device 2000 such that the temperature of the content of the cooking device 1000 may reach the target heating temperature. For example, when information about the target heating temperature is received, the home appliance 3200 may transmit a control command to start power transmission to the heating device 2000. In this case, the heating device 2000 may generate a magnetic field in the working coil 2120 by controlling the inverter circuit 2113 such that a current may be applied to the working coil 2120. Also, the home appliance 3200 may transmit a control command to stop power transmission to the heating device 2000 when the temperature of the content of the cooking device 1000 reaches the target heating temperature or is higher than or equal to the target heating temperature. In this case, the heating device 2000 may control the inverter circuit 2113 such that a current may not be supplied to the working coil 2120.

According to an embodiment of the disclosure, the home appliance 3200 may determine the target heating temperature of the cooking device 1000 and control the output (power transmission) of the heating device 2000 such that the temperature of the content of the cooking device 1000 may reach the target heating temperature. For example, in FIG. 28, the home appliance 3200 may perform the operation of the server device 3000.

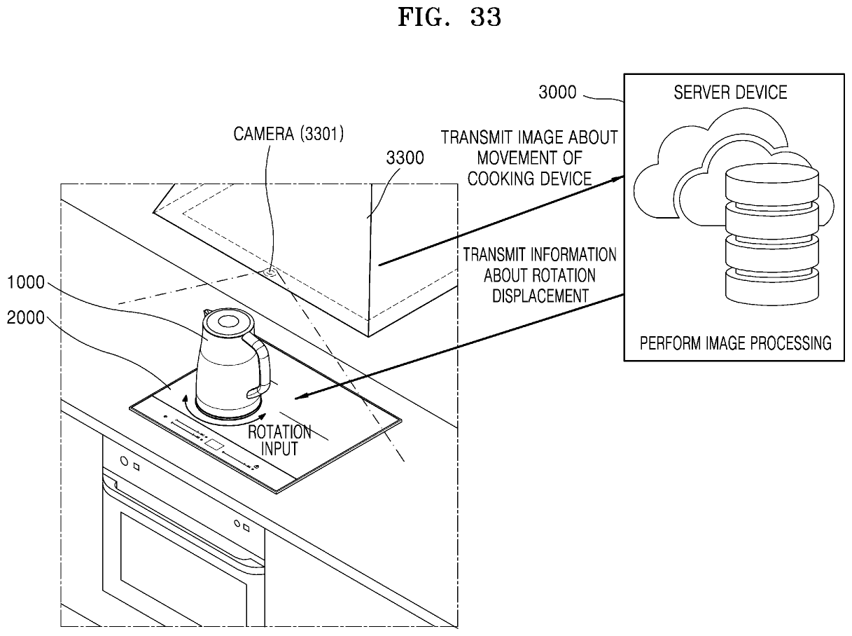

Moreover, according to an embodiment of the disclosure, the cooking device 1000 or the heating device 2000 may interwork with various IoT-based home appliances. Hereinafter, an example in which the heating device 2000 interworks with a smart home (or IoT) system will be described with reference to FIG. 33.

FIG. 33 is a diagram for describing an operation of detecting a rotation input to a cooking device by using at least one camera arranged in a kitchen, according to an embodiment of the disclosure.

According to an embodiment of the disclosure, the smart home (or IoT) system may include at least one camera. The at least one camera may obtain a surrounding image and may upload the surrounding image to the server device 3000. The at least one camera may be located in various places such as a living room, a kitchen wall, a hood system, an illumination system, a refrigerator, and a shelf. In FIG. 33, a case where a camera 3301 is attached to a hood system 3300 will be described as an example.

According to an embodiment of the disclosure, the camera 3301 may be attached to the lower end of the hood system 3300 to obtain an image around the heating device 2000. When the user puts the cooking device 1000 on the heating device 2000 and rotates the cooking device 1000, the camera 3301 may obtain an image about the movement of the cooking device 1000. Also, the camera 3301 may transmit an image about the movement of the cooking device 1000 to the server device 3000. In this case, when the camera 3301 is capable of directly communicating with the server device 3000, the camera 3301 may directly transmit the image to the server device 3000. Also, when the camera 3301 is included in the hood system 3300, the hood system 3300 may obtain an image about the movement of the cooking device 1000 through the camera 3301 and may transmit the image about the movement of the cooking device 1000 to the server device 3000.

The server device 3000 may analyze the image about the movement of the cooking device 1000 received from the camera 3301 or the hood system 3300. For example, by performing image processing, the server device 3000 may obtain information about a rotation displacement according to a rotation input to the cooking device 1000. For example, the server device 3000 may obtain information such as whether the user rotates the cooking device 1000, a rotation direction, a rotation speed, and/or a rotation angle. The server device 3000 may transmit the image processing result to the heating device 2000 or the cooking device 1000. For example, the server device 3000 may transmit information about the rotation displacement according to the rotation input to the heating device 2000 or the cooking device 1000.

The heating device 2000 or the cooking device 1000 may determine a target heating temperature of the cooking device 1000 based on the information about the rotation displacement. Also, the heating device 2000 may start power transmission by the wireless power transmitter 2100 such that the temperature of the content of the cooking device 1000 may reach the target heating temperature.

The method according to an embodiment of the disclosure may be embodied in the form of program commands executable through various computer means, which may be recorded on a computer-readable recording medium. The computer-readable recording medium may include program commands, data files, and data structures either alone or in combination. The program commands recorded on the computer-readable recording medium may be those that are especially designed and configured for the disclosure, or may be those that are known and available to those of ordinary skill in computer software. Examples of the computer-readable recording medium include magnetic media such as hard disks, floppy disks, and magnetic tapes, optical media such as CD-ROMs and DVDs, and magneto-optical media such as floptical disks, and hardware apparatuses such as ROMs, RAMs, and flash memories particularly configured to store and execute program commands. Examples of the program commands may include not only machine language code generated by a compiler but also high-level language code that may be executed by a computer by using an interpreter or the like.

Some embodiments of the disclosure may also be implemented in the form of computer-readable recording mediums including instructions executable by computers, such as program modules executed by computers. The computer-readable recording mediums may be any available mediums accessible by computers and may include both volatile and non-volatile mediums and detachable and non-detachable mediums. Also, the computer-readable recording mediums may include computer storage mediums and communication mediums. The computer storage mediums may include both volatile and non-volatile and detachable and non-detachable mediums implemented by any method or technology for storage of information such as computer-readable instructions, data structures, program modules, or other data. For example, the communication mediums may include any information transmission medium and may include other transmission mechanisms or other data of modulated data signals such as computer-readable instructions, data structures, program modules, or carriers. Also, some embodiments of the disclosure may be implemented as computer programs or computer program products including instructions executable by computers, such as computer programs executed by computers.

The machine-readable storage medium may be provided in the form of a non-transitory storage medium. Here, the term “non-transitory storage medium” may mean that the storage medium is a tangible device and does not include signals (e.g., electromagnetic waves), and may mean that data may be semipermanently or temporarily stored in the storage medium. For example, the “non-transitory storage medium” may include a buffer in which data is temporarily stored.

Also, the method according to an embodiment of the disclosure may be included and provided in a computer program product. The computer program product may be traded as a product between a seller and a buyer. The computer program product may be distributed in the form of a machine-readable storage medium (e.g., a compact disc read only memory (CD-ROM)) or may be distributed (e.g., downloaded or uploaded) online through an application store or directly between two user devices. In the case of online distribution, at least a portion of the computer program product (e.g., a downloadable app) may be at least temporarily stored or temporarily generated in a storage medium readable by a machine, such as a manufacturer's server, a server of an application store, or a memory of a relay server.

Although embodiments of the disclosure have been described above in detail, the scope of the disclosure is not limited thereto and various modifications and improvements made by those of ordinary skill in the art by using the basic concept of the disclosure defined in the following claims are also included in the scope of the disclosure.

1. A heating device comprising:
a top plate on which a cooking device is to be placed;
a communication interface configured to obtain identification information of the cooking device while the cooking device is placed on the top plate of the heating device;
a wireless power transmitter including a working coil arranged to form a magnetic field to heat the cooking device while the cooking device is placed on the top plate of the heating device; and
at least one processor configured to
identify a temperature control mode of the cooking device based on the identification information of the cooking device,
when detecting rotation of the cooking device, obtain a target heating temperature based on a rotation displacement of the cooking device on the top plate of the heating device and the temperature control mode of the cooking device, and
control power transmission by the wireless power transmitter such that a content of the cooking device reaches the target heating temperature.

2. The heating device of claim 1, wherein the at least one processor is configured to receive the identification information of the cooking device from the cooking device through short-range wireless communication based on detecting that the cooking device is placed on the top plate.

3. The heating device of claim 1, wherein the at least one processor is configured to obtain the rotation displacement by a rotation detecting sensor included in the heating device or the cooking device.

4. The heating device of claim 1, wherein the at least one processor is configured to obtain the rotation displacement based on at least one of an impedance variation of the working coil or an impedance variation of the receiving coil, when a receiving coil of the cooking device to which the magnetic field formed by the working coil is applied.

5. The heating device of claim 1, wherein the at least one processor is configured to identify a default temperature of the cooking device, based on the temperature control mode of the cooking device.

6. The heating device of claim 5, wherein the at least one processor is configured to determine a first temperature being higher than the default temperature as the target heating temperature when the rotation input is a first rotation input in a first direction and determine a second temperature being lower than the default temperature as the target heating temperature when the rotation input is a second rotation input in a second direction,
wherein the first direction and the second direction are different from each other.

7. The heating device of claim 6, wherein the first direction is a counterclockwise direction, and the second direction is a clockwise direction.

8. The heating device of claim 6, wherein the at least one processor is configured to increase the target heating temperature from the default temperature at preset temperature intervals as a rotation displacement according to the first rotation input increases and decrease the target heating temperature from the default temperature at preset temperature intervals as a rotation displacement according to the second rotation input increases.

9. The heating device of claim 1, wherein the at least one processor is configured to determine whether the temperature of the content of the cooking device has reached the target heating temperature, based on receiving temperature information of the content of the cooking device from the cooking device through the communication interface.

10. The heating device of claim 1, further comprising an output interface configured to output at least one of the target heating temperature, a current temperature of the content of the cooking device, or information representing a temperature change situation of the content of the cooking device.

11. The heating device of claim 1, wherein the at least one processor is configured to, when operating in a low-noise mode, control the wireless power transmitter to transmit power at a preset power level corresponding to the low-noise mode.

12. An operating method of a heating device including a wireless power transmitter including a working coil arranged to form a magnetic field and a top plate on which a cooking device is to be placed, the operating method comprising:
obtaining identification information of the cooking device while the cooking device is placed on the top plate of the heating device;
identifying a temperature control mode of the cooking device based on the identification information of the cooking device;
when detecting a rotation of the cooking device, obtaining a target heating temperature based on a rotation displacement of the cooking device on the top plate of the heating device and the temperature control mode of the cooking device; and
controlling power transmission by the wireless power transmitter such that a content of the cooking device reaches the target heating temperature.

13. The operating method of claim 12, wherein the obtaining of the identification information of the cooking device comprises receiving the identification information of the cooking device from the cooking device through short-range wireless communication based on detecting that the cooking device is on the top plate.

14. The operating method of claim 12, wherein the obtaining of the target heating temperature comprises obtaining the rotation displacement by using a rotation detecting sensor included in the heating device or the cooking device.

15. The operating method of claim 12, wherein the obtaining of the target heating temperature comprises obtaining the rotation displacement based on at least one of an impedance variation of the working coil or an impedance variation of the receiving coil, when a receiving coil of the cooking device to which the magnetic field formed by the working coil is applied.

16. The operating method of claim 12, wherein the identifying of the temperature control mode of the cooking device comprises identifying a default temperature of the cooking device, based on the temperature control mode of the cooking device.

17. The operating method of claim 16, wherein the obtaining of the target heating temperature comprises:
determining a first temperature being higher than the default temperature as the target heating temperature when the rotation input is a first rotation input in a first direction and
determining a second temperature being lower than the default temperature as the target heating temperature when the rotation input is a second rotation input in a second direction,
wherein the first direction and the second direction are different from each other.

18. The operating method of claim 12, wherein the controlling of the power transmission comprises:
receiving temperature information of the content of the cooking device from the cooking device through the communication interface; and
determine whether the temperature of the content of the cooking device has reached the target heating temperature, based on the temperature information of the content of the cooking device.

19. The operating method of claim 12, further comprising outputting at least one of the target heating temperature, a current temperature of the content of the cooking device, or information representing a temperature change situation of the content of the cooking device.

20. The operating method of claim 12, wherein the controlling of the power transmission comprises, when the heating device is operating in a low-noise mode, controlling the wireless power transmitter to transmit power at a preset power level corresponding to the low-noise mode.
